(19) United States
(12) Patent Application Publication
(10) Pub. No.: US 2006/0211045 A1
(43) Pub. Date: Sep. 21, 2006

(54) Fluorescently tagged ligands

(76) Inventors: Michael George, Nottingham (GB); Stephen John Hill, Nottingham (GB); Barrie Kellam, Nottingham (GB); Richard John Middleton, Nottingham (GB)

Correspondence Address: JACOBSON HOLMAN PLLC, 400 SEVENTH STREET N.W., SUITE 600, WASHINGTON, DC, 20004, US

(21) Appl. No.: 10/551,475

(22) PCT Filed: Mar. 31, 2004
(86) PCT No.: PCT/GB04/01418

§ 371 Date: Sep. 30, 2005

(30) Foreign Application Priority Data
Apr. 2, 2003 (GB) 0307559.5
Apr. 28, 2003 (US) 60465807

(51) Int. Cl. C40B 40/04; C40B 40/10

(52) U.S. Cl. 435/7.1

(57) ABSTRACT

Library comprising a plurality of tagged non-peptide ligands of formula I
(LigJ_{L})ₘL(J_{T}Tag)ₘ(J_{T}L(J_{L}Lig)ₘ)ₚ including and salts thereof
comprising one or a plurality of same or different ligand moieties Lig each linked to a one or a plurality of same or different tag moieties Tag via same or different linker moieties L and same or different linking site or linking functionality J_{T} and J_{L} wherein Lig comprises a GPCR ligand, an inhibitor of an intracellular enzyme or a substrate or inhibitor of a drug transporter;
L is a single bond or is any linking moiety selected from a heteroatom such as N, O, S, P, branched or straight chain saturated or unsaturated, optionally heteroatom containing, C₁₋₆₀₀ hydrocarbyl and combinations thereof, which may be monomeric, oligomeric having oligomeric repeat of 2 to 30 or polymeric having polymeric repeat in excess of 30 up to 300; Tag is any known or novel tagging substrate; m are each independently selected from a whole number integer from 1 to 3; p is 0 to 3
   characterised in that linking is at same or different linking sites in compounds comprising different Lig, J_{L}, L J_{T} and/or -Tag and is at different linking sites in compounds comprising same Lig, J_{L}, L J_{T} and/or -Tag; process for the preparation thereof; process for the preparation of a library compound of formula I or a precursor of formula IV; method for selecting a compound of formula I from a library thereof; compound of formula I associated with information relating to its pharmacological properties; a novel compound of formula I or precursor of formula IV; uses thereof; methods for binding or inhibition therewith; use of a fluorescent target therewith; a modified cell surface GPCR and cells expressing the same; and a kit comprising a compound of formula I and a target therefor.

This is a nationalization of PCT/GB04/001418 filed Mar. 31, 2004 and published in English.

The present invention relates to a library of tagged non-peptide ligands comprising one or a plurality of ligand moieties each linked to one or a plurality of different tag moieties; a process for the preparation thereof, a method for the rational design of a library and selection from the library of a tagged ligand; a kit comprising reactive non-peptide ligand(s) and reactive tagging substrate(s) for the preparation of the library of tagged non-peptide ligands; tagged non-peptide ligands associated with information on their pharmacology; novel tagged ligands; novel ligand precursors and processes for the preparation thereof; the use of known and novel tagged ligands and libraries of tagged ligands in studying receptor binding such as G-protein coupled receptor (GPCR) binding or intracellular enzyme inhibition such as cyclic nucleotide phosphodiesterase inhibition and binding of drugs to drug transporters (eg nucleoside transporters or ATP binding cassette transporters); more specifically studying these interactions in cell populations or single cells such as acutely dispersed cells using techniques such as Confocal Microscopy and Fluorescence Activated Sorting and Fluorescence Correlation Microscopy.

The adenosine-A₁ receptor (A₁-AR) is a GPCR which is found in a variety of tissues including brain, heart, adipose tissue and muscle, and has been implicated in the pathophysiology of a number of conditions (Ralevic, V. and Burnstock, J (1998) Pharmacol. Rev. 50, 415).

Currently the study of A₁-AR pharmacology can only be performed well in cells which can be grown in large numbers using for example techniques such as radioligand binding. Autoradiography enables single cell studies but does not allow direct reading of binding and can take up to 4-6 weeks to develop the film to obtain results of binding. To overcome this problem, a very few fluorescent ligands have been adapted for use in visualising receptors and obtaining quantitative receptor-ligand binding data in single cells, using confocal microscopy (CSLM), confocal plate readers, fluorescence polarisation plate readers, and fluorescence correlation spectroscopy (FCS). Confocal microscopy allows visualisation of a section through a cell, concentration of fluorophore at the cell edges indicates membrane receptor binding. FCS analyses the diffusion characteristics of fluorescent species, fast-diffusing free ligand can be distinguished from slowly-diffusing receptor-bound ligand and quantified simultaneously when the volume is localised to the cell membrane.

McGrath et al TiPS November 1996 (Vol 17) 393-399 reviews the possibilities for using fluorescent ligands in place of more traditional radioactive ligands in the study of cell receptors to report the amount of ligand-receptor complex indicating the number of receptors, using confocal spectroscopy and fluorescence activated cell sorting (FACS). He states that many attempts have been made at conjugating fluorescent molecules to receptor ligands in the hope of identifying their binding sites, aimed mainly at localisation of the receptors rather than studying their properties. Some compounds are reported that fluoresce when bound to a receptor but which give low background noise in the aqueous phase. A reported objective was to produce a fluorescent drug which would remain fluorescent when bound to the receptor and would remain bound when unbound drug was washed away. Therefore there was a need for very high receptor binding affinity. Reviewed work includes fluorescent ligand binding to nicotinic receptors, beta adrenoceptors, opioid GPCR type receptors, histamine, neurotensin and alpha-adrenoceptors. The publication also reviews benefits of confocal microscopy. Efforts made to study the pharmacological properties of the ligands are reported in only a few of the above cases.

However very few efforts to visualise receptors or classes of receptors have been shown to work. Pharmacological properties are usually to some extent affected by linking of a fluorophore to any receptor binding ligand, and include change in binding affinity, and in activation or otherwise of receptor, ie agonist or antagonist properties. It is important that the pharmacology of the fluorescent ligand is known in any studies in order to quantify the binding results observed.

In fact the synthesis of non-peptide fluorescent ligands for GPCRs presents serious problems. The few commercial non peptide fluorescent ligands for cell surface receptors that have been synthesised include histamine-BODIPY™ FL and (pictured below) CGP12177-BODIPY™ TMR (Molecular Probes):

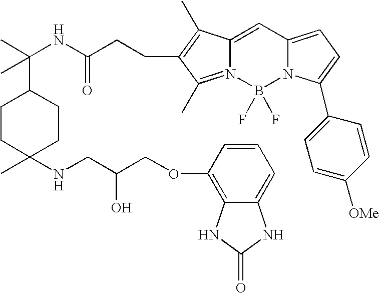

The BODIPY™ (BDI) fluorophores were initially designed for attaching to proteins which present a much more uniform prospect for attaching: kits are available comprising a fluorophore and a set of reagents for universally attaching to most proteins. These give non specific attachments to any reactive site on the protein of interest and usually there is no need to know the nature or location of the attachment. However these proteins are larger molecules than the non-peptide ligands, including drugs such as XAC (xanthine amine congener) etc envisaged in the present invention. The ligand binding site for the many GPCR receptors is also usually deep within the transmembrane regions of the receptor and thus the challenge is to attach to the fluorophore in such a way as to retain pharmacological activity. None of these BDI fluorophores are concerned with the specific design of fluorescent agonists/antagonists with defined properties at GPCR's but rather with the fluorophore as an “add-on” probe.

In summary therefore the availability of fluorescent ligands and in particular non-peptide fluorescent ligands suitable for FCS and CM binding studies is virtually non-existent. The preparation of such compounds is far from routine and few efforts have been made to establish pharmacology. McGrath above only looked at a few of the receptor types studied.

There is moreover no unified approach in much of the prior art. Individual research has addressed fluorescent ligand systems which are limited to specific drug classes and or to the use of specific fluorophores. Such systems are limiting in both the information which can be obtained and in the number of systems which can be investigated.

Accordingly there is a need for novel selective fluorescent ligands for binding at desired receptors giving reliable and effective receptor visualisation and receptor selectivity with established pharmacology in terms of both affinity and agonist and antagonist properties.

We have now applied a multidisciplinary approach to fluorescent ligand design to provide a library of rationally designed fluorescently tagged ligands and a process for preparation thereof that may be used in a method for selection of a fluorescently tagged ligand which is selective to a desired GPCR, having required defined pharmacological characteristics.

The library is obtained from preferably non-peptide ligand precursors comprising chemical functionality for linking to any fluorophore to provide known or novel fluorescent ligands with linking at a desired site enabling selection of a fluorescent ligand providing retention of receptor binding capability and linking in manner not to interfere with receptor binding capability, or to modify binding capability in known manner. The linker precursors may also provide improved properties such as water solubility, on linking to a fluorescent moiety or any other desired non-hydrophilic probe.

In the broadest aspect of the invention there is provided a library comprising a plurality of tagged non-peptide ligands of formula I
(LigJ_{L})ₘL(J_{T}Tag)ₘ(J_{T}L(J_{L}Lig)ₘ)ₚ
including salts thereof
comprising one or a plurality of same or different ligand moieties Lig each linked to a one or a plurality of same or different tag moieties Tag via same or different linker moieties L and same or different linking site or linking functionality J_{T} and J_{L} wherein Lig comprises a GPCR ligand, an inhibitor of an intracellular enzyme or a substrate or inhibitor of a drug transporter;
L is a single bond or is any linking moiety selected from a heteroatom such as N, O, S, P, branched or straight chain saturated or unsaturated, optionally heteroatom containing, C₁₋₆₀₀ hydrocarbyl and combinations thereof, which may be monomeric, oligomeric having oligomeric repeat of 2 to 30 or polymeric having polymeric repeat in excess of 30 up to 300;
Tag is any known or novel tagging substrate;
m are each independently selected from a whole number integer from 1 to 3;
p is 0 to 3
   characterised in that linking is at same or different linking sites in compounds comprising different Lig, J_{L}, L J_{T} and/or -Tag and is at different linking sites in compounds comprising same Lig, J_{L}, L J_{T} and/or -Tag.

Preferably the library does not comprise as Lig NECA, as Tag dansylamide or NBD, as each J a single bond and as L a methylene chain of C₃₋₁₂.

The innovation of the present invention relates to the design of specifically tagged ligands or “drugs” eg fluorescent ligands or “drugs” with known or selectable pharmacological properties. A key to this success is that each tag or fluorophore has a specific influence on the pharmacology of the resulting product, and it is incorrect to assume that the compound will retain the properties of the precursor drug. Preferably the library is constructed by the rational design of library members representing modifications in linking sites and ligand moieties, which can be used as a basis for selection of a tagged or fluorescent ligand retaining the properties of the precursor ligand. Preferably the library comprises a plurality of defined and well characterized tagged ligands, having verified properties corresponding to those of the non-tagged ligand.

A GPCR ligand may be selected from any compound which is effective as an agonist or antagonist for an adenosine receptor, a beta-adrenoceptor, a muscarinic receptor, a histamine receptor, an opiate receptor, a cannabinoid receptor, a chemokine receptor, an alpha-adrenoceptor, a GABA receptor, a prostanoid receptor, a 5-HT (serotonin) receptor, an excitatory aminoacid receptor (e.g. glutamate), a dopamine receptor, a protease-activating receptor, a neurokinin receptor, an angiotensin receptor, an oxytocin receptor, a leukotriene receptor, a nucleotide receptor (purines and pyrimidines), a calcium-sensing receptor, a thyroid-stimulating hormone receptor, a neurotensin receptor, a vasopressin receptor, an olfactory receptor, a nucleobase receptor (e.g. adenosine), a lysophosphatidic acid receptor, a sphingolipid receptor, a tyramine receptor (trace amines), a free-fatty acid receptor and a cyclic nucleotide receptor or the like, preferably for a GPCR receptor for example a) an adenosine receptor antagonist b) an adenosine receptor agonist c) a beta-adrenoceptor agonist and d) a beta-adrenoceptor antagonist. Preferably a ligand is a non-peptide ligand.

An inhibitor of intracellular enzymes is preferably e) an inhibitor of an intracellular enzyme such as an inhibitor of cyclic nucleotide phosphodiesterases; or a derivative or analogue thereof.

A substrate of a drug transporter is any drug that is transported into or out of the cell via the transporter. An inhibitor of a drug transporter is any compound which binds to the transporter and prevents a substrate being transported. Thus, a tagged inhibitor can be used to bind to the transporter and localise it. A tagged substrate of the invention could be used to follow transport into or out of the cell and to test whether inhibitor drugs can prevent the transport of the tagged substrate. A substrate or inhibitor is preferably selected from a substrate or inhibitor of any equilibrium based drug transporters or ATP driven pumps such as a catecholamine transporter, a nucleoside transporter, an ATP-binding cassette transporter, a cyclic nucleotide transporter or the like.

Preferably the library provides tagged ligands which are suited for surface cell receptor binding or for intracellular binding, or for penetrating or exiting live cells. Accordingly the library represents the rational design of compounds which are predicted to have retained pharmacology and properties suitable for specific binding applications.

Each Tag may be independently selected from any entity which is known in the art of tagging molecules to form a marker or reporter group for detecting molecules and which may be used in analytical studies relating to the ligand, particularly for visualisation, and includes but is not limited to fluorophore tags as known in the art. An additional Tag may be present and may perform a function in situ, eg may be any laser activated Tag which is activated to have a local or targetted therapeutic or destructive effect. This allows in a first stage visualising the compound of formula I by means of a visualisation Tag, in a second stage activation of laser activated Tag, and optionally in a third stage visualising the compound of formula I or fragments thereof. For example a laser activated Tag may comprise malachite green which may be activated for targetted protein destruction.

In a particular advantage, in the case that Tag is a chemical entity which might be anticipated to inhibit receptor ligand binding or to inhibit intracellular enzyme or drug transporter inhibition in or by a compound of formula I such inhibition is negated or dispelled by the presence of group L and/or of each J or by the chosen site of linking in one or more library members.

Preferably one or more of each -Tag in one or more or each library compound is an entity -Fl and comprises any known or novel fluorophore, whereby the library comprises compounds of which one or more or all of which are of formula I′
(LigJ_{L})ₘL(J_{T}Fl)ₘ(J_{T}L(J_{L}Lig)ₘ)ₚ

Preferably each compound of formula I or I′ comprises one of a plurality of fluorophores and/or tags providing a library of differently fluorescently tagged ligands comprising one or a number of different fluorophores (preferably of different chemical composition, spectral characteristics etc); and/or providing a library of differently tagged ligands including at least one fluorescently tagged ligand; alternatively each compound of formula I or I′ comprises one of a plurality of precursor ligands linked each to one or a plurality of different tags providing a library of same or differently tagged ligands of plural ligand type; alternatively each compound of formula I comprises one of a plurality of linkers linking a precursor ligand and at least one Tag at the same or different linking site; alternatively each compound of formula I comprises the same linker linking a precursor ligand and at least one Tag at different linking sites providing a library of differently linked tagged ligands of different conformation or anticipated-pharmacology and binding.

In each case the library of the invention provides for the selection of a tagged ligand of desired binding affinity inhibition or transport at a desired receptor, intracellular enzyme or at or by a drug transporter with desired pharmacology, visualisation, mechanism or the like.

More preferably a library comprises a plurality of compounds of one or more of formula II to III″:
(LigJ_{L})ₘLJ_{T}TagJ_{T}L(J_{L}Lig)ₘ II
where each m is as hereinbefore defined and is preferably 1 or 2, more preferably 1
(LigJ_{L})ₘL(J_{T}Tag)ₘ III
where m in each is as hereinbefore defined and is preferably 1 and/or 2, more preferably 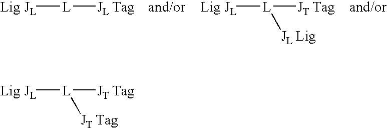
wherein each J_{L} and J_{T} comprises J as hereinbefore defined and may be same or different and may derive from functionality originally present in Lig or L and Tag or L or a combination thereof, characterised in that linking is at same or different linking sites in compounds comprising different Lig, J_{L}, L, J_{T} and/or Tag, and is at different linking sites in the case of any two or more compounds comprising identical Lig, J_{L}, L, J_{T} and/or Tag.

In one preferred embodiment the invention comprises a library of compounds of formula I as hereinbefore defined wherein Lig, J_{L}, L, J_{T} and Tag are the same in all compounds, and wherein the compounds differ by site of linking thereof.

In a further preferred embodiment the invention comprises a library of compounds of formula I or I′ as hereinbefore defined wherein Lig and J_{L} are the same in all compounds and L and J_{T} are the same or similar in all compounds and Tag is different in some or all compounds.

In a further preferred embodiment the invention comprises a library of compounds of formula I or I′ as hereinbefore defined wherein Lig- and -Tag are the same in all compounds and -L- is different in all compounds.

The library may comprise from 3 to 250 tagged ligands. Preferably the library comprises from 1 to 10 families comprising 3 to 25 tagged ligands each family comprising a ligand moiety of a common ligand type and from 3 to 25 different tag moiety types at least one of which is a fluorescent tag, more preferably each of which is a different fluorescent tag; or the library comprises from 5 to 250 fluorescently tagged ligands of different ligand type and different fluorophore type.

A library providing fluorescent ligands comprising different Fl is useful to enable studying binding, inhibition or transport with different colour fluorescence for example to distinguish from same colour native fluorescence or to distinguish plural types of binding site, enzyme, transporter or the like.

It is known that ligands modified ie by linking to a fluorophore typically undergo a change in binding affinity, inhibition or transport and suitably the library of the invention comprises characterisation of the pharmacology of each compound including binding affinity or inhibition or transport for certain GPCRs, intracellular enzymes or drug transporters. Preferably the library includes information for each tagged ligand comprised in the library, relating to the pharmacology for binding to or inhibition of a GPCR receptor or to inhibition of an intracellular enzyme such as cyclic nucleotide phosphodiesterases, or inhibition of or transport by a drug transporter including designation as agonist, antagonist, substrate or inhibitor and measure of affinity or inhibition etc, enabling quantification of results.

In the prior art methods of preparing ligands the linking sites have in many cases been non-specific or unknown, as in the case of Molecular Probes ligands, or at best have been specific or known but not predetermined, designed or rationalised for a desired effect. Preferably in the library of the invention tagged ligands comprise fluorophores linked at any of a number of linking sites at which ligand receptor binding, inhibition or transport is maintained to a greater extent or is modified or inhibited to a lesser extent. Preferably the library comprises tagged ligands designed from reaction of reactive precursor ligand(s) and reactive fluorophores having reactive site chemical functionality and suited for reaction with associated reagents, for site specific reaction and linking, wherein the design is the result of extensive investigation of all or many of the possible linking sites and the resulting pharmacological characteristics and selection of one or more linking combinations which provide favorable binding, inhibition or transport characteristics.

Preferably Lig is selected from

a) xanthine like structures including XAC, theophylline, caffeine, theobromine, dyphilline, enprofylline and the like; or fused biaryl structures including papaverine, dihydroquinilones such as cilostamide, dipyridamole, vinpocetine and the like; and analogues thereof;

b) adenosine like structures including ADAC, NECA and analogues thereof;

c) ethanolamine like structures including Salmeterol, salbutamol, terbutaline, quinprenaline, labetalol, sotalol, bambuterol, fenoterol, reprotolol, tulobuterol, clenbuterol and analogues thereof;

d) oxypropanolamine like structures including CGP12177, propranolol, practolol, acebutalol, betaxolol, ICI 118551, alprenolol, celiprolol (celectol), metoprolol (betaloc), CGP20712A, atenolol, bisoprolol, misaprolol, carvedilol, bucindolol, esmolol, nadolol, nebivolol, oxprenolol, xamoterol, pindolol, timolol and analogues thereof;

e) xanthine like structures including XAC, theophylline, caffeine, theobromine, dyphilline, enprofylline, sildenafil, EHNA (erythro-9-(2-hydroxyl-3-nonyl)adenine), zaprinast and the like; or spiro bicyclic structures including bypyridines such as amrinone, imidazolines such as CI930, dihydropyridazinones such as indolan, rolipram, SB207499, and the like; or fused biaryl structures including papaverine, dihydroquinilones such as cilostamide, dipyridamole, vinpocetine and the like and analogues thereof.

Linker L may perform a number of functions including preventing loss of affinity of a ligand when modified to comprise a fluorescent moiety, by distancing the fluorophore moiety from the ligand structure, in cases that modifying by direct linking of Lig and Fl would interfere with ligand binding, inhibition or transport in which case a linker L may be designed as a short, medium or long chain structure as appropriate.

A library compound of formula I or I′ may optionally comprise functionality J as hereinbefore defined derived from its synthesis by the reaction of one or more reactive group(s) of a linker precursor or its components, providing a linker moiety, with a reactive group of one or more ligand precursors providing a ligand moiety and reaction of one or more other reactive group(s) of the linker precursor with a reactive group of one or more tag precursors such as a fluorescent tag precursor providing a tag moiety.

In a particular advantage of the present invention linker L and/or linking site or functionality J facilitates linking of fluorescent moiety and ligand, in cases that groups of respective moieties are not reactive, or that stereochemistry or other effects would inhibit linking, or that reaction of existing reactive groups in commercially available precursor ligands and fluorophores would require the inclusion of protecting groups for functionalities present therein, in which case a linker is usually derived from a short, medium or long chain structure. In a further advantage linker -L- may be derived from a tri-, tetra-, penta- or hexa-functional precursor, linking 3 or more ligands Lig and tags Fl, enabling modified or more complex binding, inhibition or transport and associated pharmacology, for example binding to a plurality of receptor sites to explore receptor dimerisation such as homo or heterodimerisation. In a further advantage of the invention linker L may confer properties facilitating crossing the cell membrane, hydrophobicity, hydrophilicity and the like as required, in which case a linker is usually any functionalised structure.

Preferably L is selected from a saturated or unsaturated single or double bond, —O—, —S—, amine, COO—, amide, —NN— hydrazine; and saturated or unsaturated, substituted or unsubstituted C₁₋₆₀₀, preferably C₁₋₃₀₀, more preferably C₁₋₁₀₀ branched or straight chain aliphatic, aromatic, alicyclic and combinations thereof, any of which may comprise one or more heteroatoms selected from N, O, S, P, wherein optional substituents are selected from any C₁₋₂₀ aliphatic, aromatic or alicyclic substituents any of which may comprise one or more heteroatoms as hereinbefore defined, hydroxy, thiol, halo, amine, hydrazine, oxo, cyano, carbonyl and the like.

More preferably L is selected from a single bond, —O—, —S—, amino; and branched or straight chain C₁₋₅₀ alkyl, alkenyl, alkynyl, alkoxy, amino, cycloalkyl, heterocyclic, aryl, heteroaryl, and combinations thereof such as aralkyl, aralkylamino, aralkylamido and the like, optionally comprising one or more heteroatoms wherein heteroatoms are as hereinbefore defined, optionally substituted as hereinbefore defined wherein substituents are selected from C₁₋₁₂ aliphatic, aromatic or alicyclic substituents as defined, hydroxy, thiol, halo, amine, oxo, carbonyl, and the like.

J_{L} and J_{T} may comprise functionality derived from a reactive group or site for linking to fluorophore and/or to ligand selected from a saturated or unsaturated single or double bond, —O—, —S—, amino, amido, hydrazine, carbonyl, oxo, alkyl, alkenyl, alkynyl, alkoxy, thioxy, and the like.

In the case that L comprises a single or double bond, J_{L} and J_{T} if present may comprise functionality derived from a reactive group or site for linking linker and fluorophore derived from the fluorescent moiety and/or the ligand moiety.

Preferably the moiety J_{Lm} L J_{Tm} comprises a mono, di, tri, tetra, penta or hexa amino, alkylthio, alkoxy, carboxylic acid, and combinations thereof more preferably a mono, di or tri aminoalkylthio, amino alkoxy, alkoxy carboxylic acid, alkoxy amine and the like. Preferably J_{Lm} L J_{Tm} is selected from mono, di or tri amino menthane, amino ethane, thio ethane, ethane, amino acyl, from polypeptide, or from mono or polyether derivatives thereof eg diamine or dithio such as mono or polyethylene glycol di or tri amine or thio.

Preferably a linker moiety J_{Lm} L J_{Tm} as hereinbefore defined comprises a single or double bond or a single atom or group as hereinbefore defined or comprises a mono-, di-, tri- or tetrafunctional linear or branched or cyclic substituted or unsubstituted hydrocarbyl of formula -L.I—
J[A]q_{L}R_{L}[A′q_{L′}J′]ₘ₋₁A″q_{L″}J″
wherein each of J to J″ is a linking site or functionality as hereinbefore defined independently selected from a single bond, methylene, alkyne, alkene, NR, O, NRCO, S, CO, NCO, CHHal, P and the like wherein R is H or C₁₋₈ alkyl or cycloalkyl or forms part of a cyclic ring with N, Hal is any halogen selected from chlorine, iodine, bromine; and is present in any rational location in a group A to A″; each of A to A″ is a group selected from —O—, —C(═O)—, C₁₋₁₂ alkoxy, alkoyl, cycloalkyl, heterocyclic, alkyl, alkenyl, aryl, arylamide, arylamine, amino, thioalkyl, heteroaryl as hereinbefore defined and combinations thereof and the like, optionally substituted by groups selected independently from C₁₋₃ alkyl, C₁₋₅ alkoxy and the like;
each of q_{L} to q_{L}″ are independently-selected from 0 or 1 or indicates an oligomeric repeat and is from 2 to 30, or indicates a polymeric repeat unit and is from 31 up to 300.
R_{L} is a C, N or S atom or is a CR_{L′}, NR_{L′}, alkyl, cycloalkyl, heterocyclic, aryl heteroaryl, amine or thio moiety and provides for branching when p is 1 or 2; wherein R_{L′} is H or C₁₋₃ alkyl; and
p is as hereinbefore defined and is 0, 1 or 2.

Preferably each J, J′ and J″ independently is a single or double bond, NR_{L}, —O or —S or —C(O) or —NRC(O) or —C(O)NR, as hereinbefore defined
A is alkoxy preferably CH₂CH₂O (PEG) and oligomers thereof or is aralkylamine aralkylamide, aralkyloxy, or is alkyl, preferably (CH₂)₁₋₁₂
R_{L} is a C₁₋₅ alkyl chain comprising or containing a single or double branching C atom when p is 1 or 2;
p is 0, 1 or 2;
A′ and A″ are each selected from C₁₋₈ alkyl, amine, phenylamine, phenylamide; and
q_{L} is 0, 1, 2 to 30 or 31 to 300, and q_{L′} and q_{L″} are 0 or 1

More preferably J_{Lm} L J_{Tm} is a single bond or is of formula
JAq_{L}R_{L}J″
wherein each of J and J″ is amine or —O—, A is CH₂CH₂O, q_{L} is 1-30 or 31 to 300 and R_{L} is CH₂CH₂
or of formula
JAq_{L}R_{L}(A′J′)J″
wherein each of J, J′ and J″ independently is amine, —O or a single bond, q_{L} is 1, 2 or 3-30 or 31 to 300 and A is CH₂CH₂O or HNCH₂CO or q_{L} is 1 and A is C(O) or (CH₂)₁₋₈ or q_{L} is 0, R_{L} is CH or CH₂CH, q_{L′} is 0 or q_{L}′ is 1 and A′ is CH₂ and q_{L″} is 0 preferably
O(CH₂CH₂O)q_{L}CH₂CH₂NH, O(CH₂CH₂O)q_{L}CH₂CH(CH₂NH)NH,
OCH(CH₂NH)NH, —CH(CH₂NH)NH, —C(O)NH—, —(CH₂)₁₋₈—, (—HNCH₂CO—)₁₋₃ (=-gly₁₋₃-)- or the like.

More preferably each compound of formula I or I′ as hereinbefore defined comprises a moiety Lig and L as hereinbelow defined:

Wherein:

Lig.aₘ is suitably of the formula, in either of the following forms given, including any of its possible linking configurations or sites: 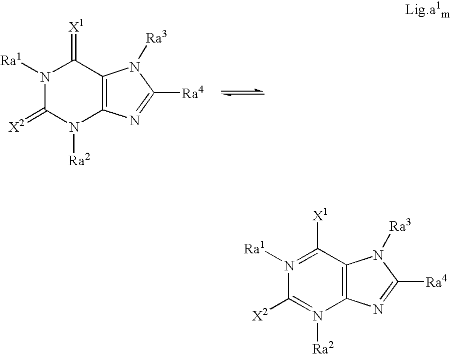
Wherein any or each of Ra¹ to Ra⁴, X¹ and X² may comprise a linking site or functionality J as hereinbefore defined
   X¹ and X² are each independently selected from H, O, OR.a, NR.a, NHR.a;
   X¹ and X² are each preferably O;
   each of R.a, R.a¹, R.a² and R.a³ independently is selected from H or C₁₋₄ linear or branched alkyl, preferably H, methyl, ethyl, n-propyl, isopropyl, n-butyl, t-butyl or isobutyl optionally mono or multi hydroxy or halo substituted, such as CH₂OH, CH₂F or CH₂CHOHCH₂OH;
   R.a⁴ is selected from a heteroatom O, S or substituted or unsubstituted amine or saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo, cyano, and the like;
preferably R.a⁴ is selected from optionally substituted aryl, cycloalkyl, alkyl, ketone, (di)amine, (di)amide, more preferably optionally substituted alkoxy, cycloalkyl, amine, amide, carboxylic acid or optionally o-, m- or p-substituted phenyl wherein substituents include aryl, alkyl, cycloalkyl, heteroaryl or heteroalkyl, amine, amide, carboxyl, carbonyl etc, for example substituents include, or R.a⁴ comprises, cyclohexyl, cyclopentyl, ethoxy, (CH₂)₂PhPh, CH₂Ph, CONH(CH₂)nCONH, CH₂CONH(CH₂)₂NH, CH₂PhNHCOCH₂, CH₂CH₂OCOCH₂, succinimidyl ester, NHCOCH₂, CH₂(CH₃)NCOCH₂, H₂N(CH₂)₂NHCOCH₂, H₂N(CH₂)₈NHCOCH₂, H₂NNHCOCH₂, CH₂CONH(CH₂)₂NHCOCH₂, HOPhCH₂N(CH₂CH₃.HOAc)(CH₂)₂NHCOCH₂, heterocyclic-(CH₂)₄CONH(CH₂)₂NHCOCH₂, heterocyclic-NHCON(heterocyclic)COCH₂ and the like;
   or Lig.a is of the formula Lig.a²- 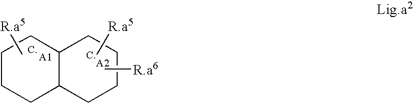
wherein any or each of Ra⁵ to Ra⁶, or a cyclic C or heteroatom may comprise a linking site or functionality J as hereinbefore defined
each of C._{A1} and C._{A2} is independently selected from C₅₋₆ aryl, heteroaryl, cycloalkyl and heterocyclic, more preferably from phenyl, or aryl containing 1 or 2 ring heteroatoms, or heterocyclic containing 1 ring heteroatom and/or 1 ring —C═C— group;
Each of up to seven R.a⁵ is a substituent of a ring carbon or a ring heteroatom and:
   is independently selected from H, halo, hydroxy, thiol, amine, COOH, hydrazine, cyano, saturated or unsaturated, substituted or unsubstituted C₁₋₂₀ branched or straight chain aliphatic, aromatic, alicyclic and combinations thereof, any of which may comprise one or more heteroatoms selected from N, O, S, P, and wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo, cyano, and the like, such as ═O, OCH₃, CH₂Ph(OCH₃)₂, O(CH₂)₃CON(CH₃)c.hex, N(CH₂CH₂OH)₂, c.hex, COOCH₂CH₃, CH₂CH₃;
or any two or more of R.a⁵ form a one, two or three ring fused cyclic structure, preferably comprising a fused 3 ring aryl, 5-heterocyclic, 6-heterocyclic structure having 4 ring atoms common with the fused bicyclic Lig.a² structure;
and R.a⁶ is a moiety as defined for R.a⁵ above;
   and L.a is as hereinbefore defined for L or J_{L} L J_{T} and is suitably of formula L.I or subformulae as hereinbefore defined, more preferably is selected from a single bond, amino acid or amide such as a peptide or polypeptide for example gly or gly₃, alkyl of formula —(CH₂)ₙ where n is 3 to 8, preferably 3, 4 or 6, optionally including one or more heteroatoms or unsaturated groups, such as —O— or —S— or —CH═CH— and the like:
   Lig.b is suitably of the formula Lig.b including any of its possible linking configurations or sites: 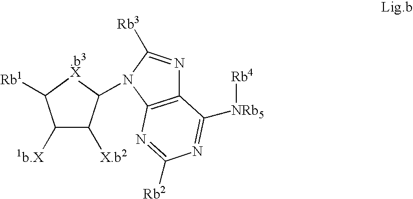
wherein any or each of Rb¹ to Rb⁵ or Xb¹ to Xb³ may comprise a linking site or functionality J as hereinbefore defined
   ring substituents X.b¹ and X.b² are independently-selected from hydrocarbon such as alkyl or SRₓ, NR_{X.2} and ORₓ wherein (each) Rₓ is selected from H, C₁₋₅alkyl, alkenyl;
   ring heteroatom X.b³ is selected from —S—, —O— and —H₂—;
   Rb¹ is selected from saturated or unsaturated, substituted or unsubstituted C₁₋₄ aliphatic, or C₁₋₃ alicyclic optionally including one or more heteroatoms N, O, S, P, wherein substituent(s) are selected from one or more cycloalkyl, heterocyclic, hydroxy, oxo, halo, amine; preferably R.b¹ comprises a carbonyl substituted by H, alkyl or a linear or cyclic primary, secondary or tertiary amine, substituted C₁₋₃ alkyl, cycloalkyl or amide, more preferably cyclopropyl, or CONHC₁₋₃alkyl such as CONHEt or CH₂OH
   and each of R.b² and R.b³ is selected from H, halo, hydroxy, thiol, amine, COOH, CHO, hydrazine, cyano or saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo, cyano, and the like, preferably from H, halo or hydroxy, preferably H or Cl;
   Rb⁴ is H;
   Rb⁵ is H or alkyl
L.b may comprise a linking site or functionality J as hereinbefore defined; and
   is as hereinbefore defined for L or its subformulae, more preferably is saturated and unsaturated substituted or unsubstituted C₁₋₁₂ aliphatic or C₁₋₂₄ aromatic as defined for L preferably including one or more heteroatorms O, S or N, cyclic or heterocyclic groups, more preferably is of formula L.I or its subformulae as hereinbefore defined, most preferably is (CH₂)m wherein m is 2 to 12, preferably 3, 4, 6 or 8, or is (Ph—CH₂CONH)₂(CH₂)₂;
      Lig.c is suitably a non-peptide of the formula Lig.c including any of its possible linking configurations or sites: 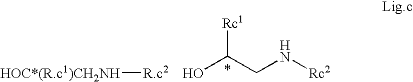
Where any or each of Rc¹ to Rc² or OH, or a chain C or N may comprise a linking site or functionality J as hereinbefore defined
   * indicates an optically active centre and
Wherein R.c¹ is C₆₋₁₄ aryl optionally including one or more heteroatoms selected from H, O, optionally substituted by OH, Hal eg Cl, NH₂, NHC₁₋₃alkyl; sulphonamide, oxoamine (—CONH₂) and the like, more preferably mono, di or tri substituted phenyl or quinoline wherein substituents include OH, Cl or NH₂, more preferably m-CH₂OH, p-OH phenyl, m-,p-dihydroxy phenol or m-,m-dihydroxyphenol, m-,m-diCl, p-NH₂ phenol, p-OH, m-CONH₂ phenol or 5-OH, 8-quinoline and the like, such as 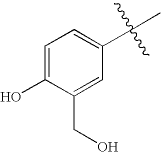
   R.c² is selected from saturated or unsaturated, substituted or unsubstituted C₁₋₂₀, preferably Cl₁₋₁₂, branched or straight chain aliphatic, aromatic, alicyclic and combinations thereof, any of which may comprise one or more heteroatoms selected from N, O, S, P; wherein optional substituents are selected from any optionally substituted C₁₋₁₂ aliphatic, aromatic or alicyclic substituents any of which may comprise one or more heteroatoms as hereinbefore defined, hydroxy, thiol, halo, amine, hydrazine, oxo, cyano, and the like and combinations thereof;
Preferably R.c² is selected from C₁₋₆ branched or straight chain aliphatic, C₆₋₁₀ araliphatic optionally substituted by OH and optionally including heteroatoms selected from N,O, preferably including an ether O, such as selected from —(CH₂)₆OCH((CH₂)₃Ph), CHCH₃(CH₂)₂Ph, CHCH₃CH₂PhOH, C(CH₃)₂CH₂ or from the structures: 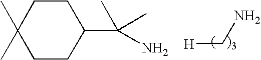
L.c may be present as R.c² or may comprise a linking site or functionality J as hereinbefore defined, and is as hereinbefore defined for L and is suitably of formula L.I or its subformulae as hereinbefore defined, more preferably is selected from C₁₋₁₂ alkyl, amide etc;
   Lig.d is suitably a non-peptide of the formula Lig.d including any of its possible linking configurations or sites:
   Lig.d R.d¹ OCH₂C*HOHCH₂NH—R.d² 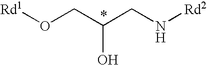
where any or each of Rd¹ to Rd² or OH, a chain C or N may comprise a linking site or functionality J as hereinbefore defined
*indicates an optically active centre
Wherein R.d¹ is saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo, cyano, and the like;
Preferably R.d¹ is substituted or unsubstituted C₁₋₂₄ aralkyl or heteroaralkyl, including single ring and fused ring systems with (hetero)aryl or cycloalkyl rings, wherein optional substituents include C₁₋₆ alkyl, alkoxy, ether, carbonyl, alkenyl, amine, amide each optionally carbonyl, amide, halo or OH subtitited, or halo such as chloro or OH, preferably R.d¹ is unsubstituted or substituted alkyl, alkenyl, halo, amine, amide, carbonyl, ketone, ether substituted phenyl or naphthyl, illustrated as follows, most preferably mono-, di-, tri- or tetra substituted mono or polycyclic fused aryl or cycloaryl or heterocycloaryl such as phenyl, carbazole or structures shown below or spiro ring systems, most preferably mono-, di-, tri- or tetra alkoxyalkyl, alkoxyalkoxyalkyl or CF₃ substituted phenyl or unsubstituted or monosubstituted naphthalene or 5,6 ring systems most preferably of the structures: 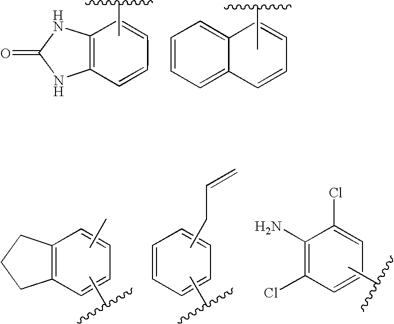
R.d² is substituted or unsubstituted amine, saturated or unsaturated, substituted or unsubstituted Cl₁₋₁₂ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo, cyano, and the like, more preferably amine, C₁₋₆ branched or straight chain alkyl optionally including ether O, and optionally substituted by C₆₋₁₀ aryl, for example i.pr, i.bu, or of the formula: 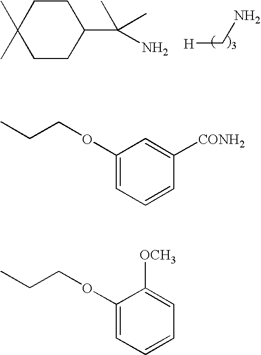
L.d may be present as R.c² or may comprise a linking site or functionality J as hereinbefore defined and is as hereinbefore defined for L and its subformulae and is suitably of formula L.I and its subformulae as hereinbefore defined, more preferably is a single bond or is as hereinbefore defined for L.a;
   Lig.e comprises a cell permeant moiety or is associated with a cell permeant L or Fl moiety and is suitably of the formula, in either of the following forms given including any of its possible linking configurations or sites: 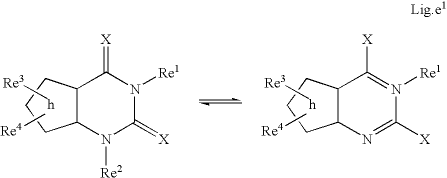
wherein any or each of Re¹ to Re⁴, X and a ring C or N may comprise a linking site or functionality J as hereinbefore defined
h is selected from 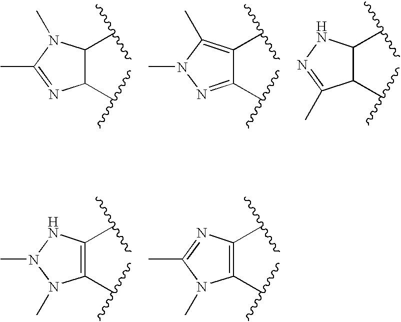
   each optionally substituted by R.e³-R.e⁴ wherein R.e¹-R.e⁴ are as R.a¹-R.a⁴ defined above or in which R.e³ is C₅₋₉linear or branched alkyl, optionally mono or multi hydroxy or halo substituted or is aryl optionally substituted by alkoxy, sulfonyl and the like 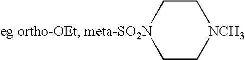
   each X is independently selected from H, O, —OR.e², N, HN, NR.e⁵, HR.e⁶, and aryl optionally substituted by ether; or X is aryl optionally alkyl or alkoxy substituted such as Ph-ortho-OCH₂CH₂CH₃;
and where R.e⁵ is as defined above for R.e¹ above or forms a fused cyclic ring together with the adjacent ring N atom; preferably 1 or 2 fused 5 membered cyclic rings,
and R.e⁶ is as defined above for R.e¹ above or is selected from optionally substituted phenyl wherein optional substituents include ether such as o-ethoxy or o-propoxy, alkyl, OH and the like, sulphonyl, carbonyl and the like substituted by heterocyclic, or cyclic C₅₋₈ alkyl such as methyl, piperazinyl, sulphonyl and the like;
   or Lig.e is of the formula Lig.e² 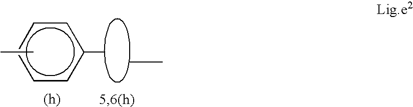
Wherein any or each free ring atom or their substituents may comprise a linking site or functionality J as hereinbefore defined
each spiro ring optionally comprises zero or one or more heteroatoms h which are preferably N, more preferably 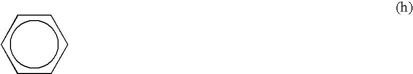
   comprises zero or 1 N heteroatom and 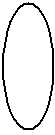
   5,6(h) comprises
   zero, 1 or 2 N heteroatoms and is unsaturated or comprises one or two —C═C— or —C═N— groups;
   and wherein each ring is optionally substituted by one or more oxo, CO, COOH, C₁₋₆ alkyl or linear or cyclic alkoxy such as methoxy, ethoxy or cyclopentyloxy optionally substituted by one or more oxo, CO, COOH, CN, or C₁₋₆ alicyclic or amine groups, amine or one or more spiro or fused heterocycles;
      or Lig.e is of the formula Lig.e³ 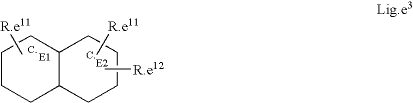
Wherein any or each of Re¹¹ to R¹², or a ring C or heteroatom or ring substituent may comprise a linking site or functionality J as hereinbefore defined
   each of C._{E1} and C._{E2} is independently selected from C₅₋₆ aryl, heteroaryl, cyloalkyl and heterocyclic, more preferably from phenyl, or aryl containing 1 or 2 ring heteroatoms, or heterocyclic containing 1 ring heteroatom and/or 1 ring —C═C— group;
Each of up to seven R.e¹¹ is a substituent of a ring carbon or a ring heteroatom and:
   is independently selected from saturated or unsaturated, substituted or unsubstituted C₁₋₂₀ branched or straight chain aliphatic, aromatic, alicyclic and combinations thereof, any of which may comprise one or more heteroatoms selected from N, O, S, P, and wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo, cyano, and the like, such as ═O, OCH₃, CH₂Ph(OCH₃)₂, O(CH₂)₃CON(CH₃)c.hex, N(CH₂CH₂OH)₂, c.hex, COOCH₂CH₃, CH₂CH₃;
or any two or more of R.e¹¹ form a one, two or three ring fused cyclic structure, preferably comprising a fused 3 ring aryl, 5-heterocyclic, 6-heterocyclic structure having 4 ring atoms common with the fused bicyclic Lig.e³ structure;
and R.e¹² is a moiety as defined for R.e¹¹ above;

Preferably Lig.e is of the formula Lig.e¹ as hereinbefore defined in particular where R.e² and R.e³ are respectively propyl and butyl;
L.e may comprise a linking site or functionality J as hereinbefore defined and is suitably as hereinbefore defined for L.a.

Linking sites J as hereinbefore defined are suitably of any nature and location, ie any sites, which do not inhibit binding, inhibition or transport. Receptor binding is complex, and may require a specific binding site to be available and/or require a specific fluorescent ligand conformation.

The fluorescent ligands of the library of the invention may be characterised by different linking sites linking ligand and fluorescent moiety as hereinbefore defined. From a comprehensive knowledge of the binding, inhibition or transport behaviour and the specific target sites, which remain unchanged in the fluorescent ligands of the invention, we have been able to determine a method for selecting suitable linking sites for desired retention of binding, inhibition or transport and pharmacological properties. Preferably the compounds of formula I or I′ include compounds representing all operative linking configurations exposing possible binding, inhibition or transport site options.

Fl may include any red, green, near ir, blue or the like absorbing dyes and other classes of dyes. Suitably Fl is selected from dyes in particular including fluorescein, fluorescein derivatives including FITC, and fluorescein-like molecules such as Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dyomics (DY dyes and ATTO dyes) and fluorescent derivatives thereof, the Alexafluor dyes and derivatives, BDI dyes including the comercially available Bodipy™ dyes, erythosin, eosin, pyrenes, anthracenes, acridines, fluorescent phycobiliproteins and their conjugates and fluoresceinated microbeads, Rhodamine and fluorescent derivatives thereof including Rhodamine Green™ including the tetramethylrhodamines, X-rhodamines and Texas Red derivatives, and Rhodol Green™, coupled to amine groups using the isocyanate, succinimidyl ester or dichlorotriazinyl-reactive groups and other red, blue or green absorbing fluorescent dyes in particular red absorbing dyes as reviewed in Buschmann V et al, Bioconjugate Chemistry (2002), ASAP article.

More preferably Fl is selected from fluorescein derivatives and fluorescein-like molecules such as Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dionics (DY dyes and ATTO dyes) and fluorescent derivatives thereof, the Alexafluor dyes and derivatives, BDI dyes including the commercially available Bodipy™ dyes, erythosin, eosin, FITC, pyrenes, anthracenes, acridines, fluorescent phycobiliproteins and their conjugates and fluoresceinated microbeads, Rhodamine derivatives thereof including Rhodamine Green™ including the tetramethylrhodamines, X-rhodamines and Texas Red derivatives, and Rhodol Green™.

More preferably Fl comprises fluorescein, Texas Red™, Cy5.5 or Cy5 or analogues thereof, BODIPY™ 630/650 and analogues thereof, DY-630, DY-640, DY-650 or DY-655 or analogues thereof, ATTO 655 or ATTO 680 or analogues thereof, EvoBlue 30 or analogues thereof, Alexa 647 or analogues thereof.

Suitably Fl is derived from any of the above commercially available fluorophores, comprising or modified to comprise a reactive group facilitating linking to a ligand by a moiety J as hereinbefore defined. Preferably Fl comprises any of the above commercially available fluorophores modified to form a derivative or group of derivatives suitable for visualising ligand binding, inhibition or transport in a library as hereinbefore defined comprising J_{T}-t-Fl wherein J_{T} is as hereinbefore defined and comprises functionality derived from linking to a precursor ligand as hereinbefore defined and may optionally comprise a linking group -t- which is a proximal unsaturated or aryl moiety, comprising a medial short, medium or long chain alkynyl or cycloalkyl moiety and comprising a moiety derived from linking via a reactive group as hereinbefore defined such as carboxyl, sulphonate or as a heteroatom such as O or S or methylene derived from linking at an alkylhalide such as methylbromide, haloacetamide, sulphonate ester or the like electrophilic group.

For example Fl may include a substituent -t- which performs a fluorescence modifying function, for example is a heteroaryl or alkenyl such as mono-, di- or tri-enyl group which shifts the fluorescence of the compound to the red part of the spectrum and raises the absorption max value, or performs a linking function.

Preferred BODIPY™ (4,4-difluoro-4-bora-3a,4a-diaz-s-indacene) fluorophores include those which span the visible spectrum and include those listed in U.S. Pat. No. 4,774,339; U.S. Pat. No. 5,187,288; U.S. Pat. No. 5,248,782; U.S. Pat. No. 5,274,113; U.S. Pat. No. 5,433,896; U.S. Pat. No. 5,451,663. A preferred member of this group is selected from any heteroaryl substituted BODIPY™ dyes as described in the above patents the contents of which are incorporated herein by reference. Suitably J_{T}-t-Fl comprising a BODIPY™ structure is characterised by a dipyrrometheneboron difluoride core, optionally modified by one or two fused rings, optionally substituted by one or several substituents such as alkyl, alkoxy, aryl, heterocyclic and the like, wherein one substituent -t- is adapted for linking as hereinbefore defined to a ligand precursor as hereinbefore defined, the substituent -t-optionally comprising a proximal unsaturated or aryl moiety, comprising a medial short, medium or long chain alkynyl or cycloalkyl moiety and comprising a moiety derived from linking via a reactive group as hereinbefore defined such as carboxyl, sulphonate or as a heteroatom such as O or S or methylene derived from linking at an alkylhalide such as methylbromide, haloacetamide, sulphonate ester or the like electrophilic group.

Fl may include a substituent -t- as hereinbefore defined which is heteroaryl or alkenyl such as mono-, di- or tri-enyl group which shifts the fluorescence of the compound to the red part of the spectrum and raises the absorption max value as in U.S. Pat. No. 5,187,288; or may include alkenyl substituent linked to one or more of an aryl, carbonyl or like group, preferably linked to a fatty acid sidechain comprising (CH—₂)nCO₂H where n=5-22 as in U.S. Pat. No. 5,330,854, more preferably linked via an aryloxymethylene to a and carbonyl; or may include an aryl alkenyl aryl group as in U.S. Pat. No. 6,005,113.

More preferably -Fl is of the formula -Fl¹:

Fl¹ dipyrrometheneborondifluoride analogues including any of its possible linking configurations or sites: 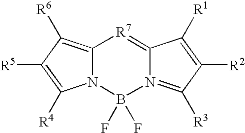
Wherein any or each of R¹ to R⁷, or a ring atom may comprise a linking site or functionality J as hereinbefore defined

R7 is N or C—R8;

Substituents R¹, R², R³, R⁴, R⁵, R⁶ and R⁸ which may be the same or different are H, halogen, nitro, sulfo, cyano, alkyl, perfluoroalkyl, alkoxy, alkenyl, alkynyl, cycloalkyl, arylalkyl, or acyl wherein the alkyl portions of each contain fewer than 20 carbons; or substituted or unsubstituted aryl or heteroaryl; preferably at least four of R¹ to R⁸ are non-hydrogen, alternatively adjacent substituents R1 and R2 taken in combination and adjacent substituents R5 and R6 taken in combination form fused 6-membered (hetero) aromatic rings
or 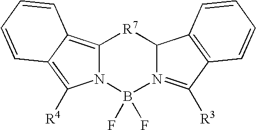
including any of its possible linking configurations or sites:
wherein any or each of R³, R⁴ or R⁷, or a ring atom may comprise a linking site or functionality J as hereinbefore defined
   each fused ring is optionally and independently substituted by H, halogen, nitro, sulfo, cyano, alkyl, perfluoroalkyl, alkoxy, alkenyl, alkynyl, cycloalkyl, alkylthio, alkylamido, amino, (mono or dialkyl)amino (wherein the alkyl portions of each contain fewer than 20 carbons), or substituted or unsubstituted aryl, heteroaryl, arylamido, heteroarylamido, aryloxy, heteroaryloxy, arylamino or heteroarylamino; or 1 to 2 additional fused benzo or heteroaromatic rings that are optionally substituted or unsubstituted.

Preferably any or all of R^{2,3} to R^{4,5} is heteroaryl, more preferably a single ring single heteroatom such as such as pyrrole, thiophene, furan or single ring di heteroatom structure such as oxazole, isoxazole, oxadiazole, imidazole, or multi ring such as benzoxazole, benzothiazole, benzimidazole, or multi ring one heteroatom structure such as benzofuran, indole, preferably thienyl.

More preferably Fl is selected from the BODIPY core structures of formulae FL.A1 or FL.A2 as shown below, in each case=indicating the attachment site of a sidechain and including any of its possible linking configurations or sites: 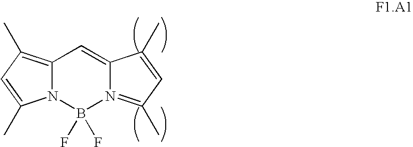
preferably comprising or derived from BODIPY TMR or BODIPY FL (4,4-difluoro-5,7dimethyl-4-bora-3a,4a-diaza-s-indacene-3-propionic acid) or BODIPY FL ethylene diamine including any of its possible linking configurations or sites: 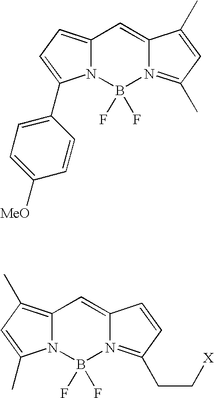
BODIPY TMR BODIPY FL ethylene diamine (X is CONH(CH₂)₂NH₂) or BODIPY FL (X is COOH)
   Or Fl.A2 including any of its possible linking configurations or sites: 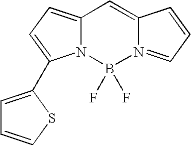
   preferably comprising or derived from BODIPY 630/650 or BODIPY 630/650 methyl bromide including any of its possible linking configurations or sites: 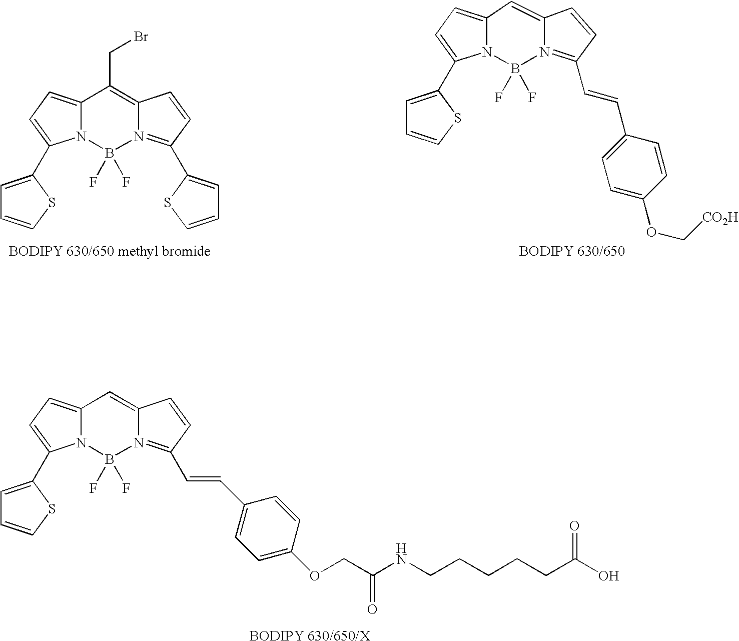
   most preferably the succinimidyl esters thereof, for example BODIPY 630/650 X-SE.

In a further aspect of the invention there is provided a process for the preparation of a library as hereinbefore defined comprising the reaction of one or each of a plurality of ligand precursors and tag precursors comprising linker moieties or ligand, tag and linker precursors wherein linking may be at same or different reactive sites in different compounds as hereinbefore defined.

Preferably the process is a combinatorial process. Preferably the process comprises the reaction of one or more ligand precursors of formula IV and/or IV′
(LigJ_{L})ₘ-L-Y_{Ln} IV
LigY_{Lign} IV′
comprising one or more or different reactive groups Y_{L} or Y_{Lig} forming a linking functionality J, J_{L} or J_{T} as hereinbefore defined
with one or more of a plurality of analytical tagging substrates of formula V and/or V′
Y_{Tm}Tag V
Y_{Tm}L(J_{T}Tag)ₘ V′
comprising one or more or different reactive groups Y_{T} forming a linking functionality J or J_{T} as hereinbefore defined
and optionally one or more linking species VI or VI′ or VI″
Y_{Lm}LY_{Lm} VI
wherein Lig, J, L, J_{T} and Tag and each m is independently as hereinbefore defined wherein the or each compound of formula IV or IV′ is capable of reaction with the or each compound of formula V or V′, optionally via the or each species VI or VI′ or VI″ to form a plurality of compounds of formula I as hereinbefore defined.

Preferably in some or each compound of formula V or V′, Tag is Fl as hereinbefore defined, whereby the process is a process for preparing a library comprising a plurality of compounds of which one or more or all of which are of formula I′ as hereinbefore defined.

Suitably reactive groups Y_{Lig}, Y_{L}, Y_{T} have suitable reactive group functionalities for linking, as hereinbefore defined, for example by substitution or by addition or addition—elimination reaction. Substitution reaction is suitably selected from reaction of electrophilic and nucleophilic reactive sites as hereinbefore defined such as:

| | Nucleophilic | Resulting covalent | leaving |
|---|---|---|---|
| Electrophilic Y | Y | Linkage, J | groups |
| Carboxylic acid | alcohol | ester | —OH, —H |
| Carboxylic acid | amine | carboxamide | —OH, —H |
| Carboxylic acid | hydrazine | hydrazide | —OH, —H |
| Alkyl halide | alcohol | ether | —Hal, —H |
| Alkyl halide | thiol | thioether | —Hal, —H |
| Alkyl halide | amine | alkylamine | —Hal, —H |
| Alkyl halide | COOH | ester | —Hal, —H |
| Haloacetamides | thiols | thioethers | —Hal, —H |
| Sulphonate esters | amines | alkyl amines | RSO₃—, —H |
| Sulphonate esters | alcohols | ethers | RSO₃—, —H |
| Sulphonate esters | thiols | thioethers | RSO₃—, —H |
| Sulphonyl halides | amines | sulphonamides | —Hal, —H |
| Sulphonyl halides | alcohols | sulphonate esters | —Hal, —H |
| Succinimide ester | alcohols | esters | —OSu*, —H |
| Succinimide ester | alkoxides | esters | —OSu*, H or M⁺ |
| Succinimide ester | thiols | thioesters | —OSu*, —H |
| Succinimide ester | amine | carboxamide | —OSu*, —H |
| Succinimide ester | hydrazine | hydrazide | —OSu*, —H |

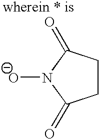

Addition reaction is suitably selected from cycloaddition or addition-elimination reaction of electrophilic and nucleophilic reactive sites in IV and V as hereinbefore defined:

| Electrophile | Nucleophile | Covalent | Leaving |
|---|---|---|---|
| Y | Y | Linkage, J | Group |
| azide | alkyne | triazole* | none |
| 2-acyl cyclic mono-/ | dinucleophile | 6,7-dihydro-1H-indazol-4(5H)-one | H₂O |
| di-ketone | eg hydrazine | 4,5,6,7-tetrahydro-1H-indazole | H₂O |
| (5 or 6 mem ring) | | 1,4,5,6-tetrahydrocyclopenta[c]pyrazole | H₂O |
| | | 5,6-dihydrocyclopenta[c]pyrazol-4(1H)-one | H₂O |

wherein * is [3 + 2] dipolar cycloaddition

Preferably a compound of formula IV or IV′ comprises no protecting group and is capable of reaction with a compound of V or V′ optionally via a compound of VI, without degradation of functionality by choice of reaction and of respective reactive sites; or a compound of formula IV or IV′ comprises one or more protecting groups which are adapted for removal under ambient conditions, for example under neutral pH, room temperature or the like. Preferably the process comprises reaction wherein reactive groups Y are selected so as to enable reaction with a fully deprotected ligand ie without the need for protecting groups or so as to enable reaction with protecting groups present which may be removed under mild conditions, for example one of Y_{Lig} or Y_{L} or Y_{T} comprises amine or alcohol or thiol and the other comprises succinimide ester.

In the case that choice of reactive groups requires protection of compounds of formula IV or IV′, a protecting group is preferably such as to allow removal under mild conditions, preferably comprises benzyloxycarbonyl and the like which are removed at ambient conditions such as room temperature or under conditions which do not prejudice functional groups such as the glycosidic group in Lig.b.

The process of the invention is characterised by a high yield of compounds of formula I or I′ as hereinbefore defined by use of chemoselectivity and is superior to known methods which prejudice yields by use of non chemoselective reactive groups or protecting groups.

Preferably the compounds of formula I or I′ are obtained by:

reacting the unprotected primary alkyl amine group a compound of formula IV as hereinbefore defined with a compound of formula V comprising a reactive succinimidyl ester group in solvent at ambient temperature without need for subsequent deprotection. In a particular advantage of the invention the method provides greater yield than with the prior art processes.

Compounds of formula IV, IV′, V′, V′ or VI may be commercially available or may be prepared by known means. A linker may be installed as an independent entity or may be constructed as part of a synthetic process as hereinbefore defined, preferably is synthesised as an additional substituent on the ligand moiety or fluorescent moiety prior to reaction thereof.

In a further aspect of the invention there is provided a process for the preparation of a compound of formula I as hereinbefore defined comprising the reaction of a compound of formula IV or IV′ and a compound of formula V or V′ and optionally additionally VI, as hereinbefore defined.

In a further aspect of the invention there is provided a process for the preparation of a compound of formula IV as hereinbefore defined comprising: obtaining where commercially available or preparing the ligand precursor Lig, by routes as known in the art, and reacting with linker precursor VI″, if required, or components thereof, and/or generating one or more reactive sites Y or Y_{Lig} or Y_{L}. Protection of IV may be required in which case reaction is followed by removing any protecting group present during the reaction, optionally replacing with a protecting group which may be removed under ambient conditions. A reactive group Y or Y_{Lig} or Y_{L} is preferably selected from groups as hereinbefore defined.

Preferably the process comprises:

a), e) ring closure of 5,6-diamino-1,3-dialkyl uracil with the appropriate substituted aldehyde under acid conditions with ferric chloride,

b) reacting Lig.b- comprising a protected inosine derivative with chlorinating agent and linking the chloro derivative with the amine group of a suitably protected amine reactive linker H-L-PL wherein PL comprises N-benzyloxycarbonyl- to form Lig.b-L-P_{L} and removing P_{L} to generate Lig.b-L.b; preferably R.b¹ comprises a OH terminating group and protected inosine comprises Acyl protecting groups or R.b¹ comprises a stable group such as amine or amide and protected inosine comprises 2,2-dimethoxypropane protecting group; preferably the protected inosine is reacted with oxidising agent and protected alkylamine which is an N-alkylcarboxamide with removal of amine protecting group to generate a reactive ligand;

c), d) reacting p-hydroxybenzaldehyde with formaldehyde under acid catalysis and protection of the resulting 4-hydroxy-3-hydroxymethylbenzaldehyde with dimethoxypropane to generate the resulting acetonide. Converting the Benzaldehyde to its corresponding epoxide and ring opening with a suitably protected linker such as Boc-L.c-H supplies Ligₘ-L-P_{L}. Finally, deprotection under acid conditions supplies Lig.cLc or Lig.dLd for coupling to an appropriate tag.

In a particular advantage of the present invention linker moiety L facilitates linking of fluorescent moiety and ligand moiety, in cases that moieties are not reactive, or that stereochemistry or other effects inhibit linking, or that reaction of existing reactive groups in commercially available compounds of formula IV or IV′ and V or V′ would require the inclusion of protecting groups for functionalities present therein, in which case a linker is usually a difunctional short, medium or long chain structure. In a further advantage of the invention linker L may confer properties facilitating crossing the cell membrane, hydrophobicity, hydrophilicity and the like as required, in which case a linker is usually any functionalised structure.

Preferably a linker precursor of formula VI as hereinbefore defined is selected from a heteroatomic species such as a species providing N, O, S, or P, or a branched or straight chain saturated or unsaturated, optionally heteroatom containing, C₁₋₆₀₀ reactive hydrocarbon and combinations thereof, which may be monomeric, oligomeric having oligomeric repeat of 2 to 30 or polymeric having polymeric repeat in excess of 30 up to 300 and comprises reactive groups or sites for linking to ligand and fluorophore selected from hydroxy, alkoxy, thiol, thioxy, amine, hydrazine, carbonyl and the like. In the case that a linker comprises a single bond, then a reactive site is usually present on the compound of formula IV′, whereby is reactive with compound of formula V or V′.

Preferably a compound of formula VI comprises three, four, five or six reactive sites, for linking 3 or more ligands and tags of formula IV or V. Preferably a linker precursor is selected from any substrate which generates or donates a moiety L as hereinbefore defined.

Suitably a linker precursor of formula VI is a short, medium or long chain, comprising rationally designed functionality and comprising reactive sites providing functionality in moiety L as hereinbefore defined. Preferably a linker precursor of formula VI is a mono, di or mixed amine, hydroxy, thiol, carboxylic acid, acid chloride, acid fluoride, acid bromide, (acid halide), isocyanate NCO, isothiocyanate NCS, halide, alkylhalide, aldehyde, epoxide, sulphonyl chloride SO₂Cl or hydrazine NHNH₂, more preferably is selected from mono, di or tri amino menthane, amino ethane, ethanethiol, hydroxy ethane, amino acid, from polypeptide, or from mono or polyether derivatives thereof eg diamine or dithiol such as mono or polyethylene glycol di or tri amine or thiol.

Preferably a linker precursor of formula VI is selected from any C₁₋₁₂ substituted or unsubstituted alkylamine, aminoacid, cycloalkyl, aryl, heteroaryl, aralkyl, and the like providing one or more reactive end groups for linking to Fl, more preferably selected from (di)amine, comprising cyclic or linear amine, more preferably diamine menthane, or diamino ethylene, amino acid or polypeptide, or from mono or polyether diamine such as polyethylene glycoldiamine, more preferably from H₂N(CH₂)₄NHCO₂CH₂Ph, H₂N(CH₂)₅NHCO₂CH₂Ph, H₂N((CH₂)₂O)₂(CH₂)₂NHCO₂CH₂Ph and H₂N(CH₂)ₙNHBoc where n is 2 to 8.

Preferably a linker precursor comprises a linear or branched or cyclic substituted or unsubstituted alkyl having one, two or three reactive sites, of formula Y_{Lm} L.I Y_{Lm} wherein L.I is as hereinbefore defined

Preferably each Y_{L} is independently selected from H, CO₂H, NH₂, O, P, S and groups providing on reaction a single bond, alkyl such as methylene, alkyne, alkene, NH, NR, O, NRCO, S, CO, NCO, CHHal, P and the like wherein Hal is any halogen selected from chlorine, iodine, bromine, or

wherein Y_{L} comprises protecting leaving groups Z_{L} such as —NHCO₂CH₂Ph, H, OH, SH, halogen, amine, aliphatic, N-alkylcarboxamide, Boc and the like;

In a further aspect of the invention there is provided a method for selecting a compound of formula I from a library as hereinbefore defined comprising the rational design of a library of compounds of formula I as hereinbefore defined using the process as hereinbefore defined, determining pharmacology for a plurality of or all compounds in the library and selecting a compound exhibiting desired pharmacology at a desired target.

Preferably the method comprises preparing a preliminary library of compounds, conducting screens to assess binding, inhibition, transport and the like, selecting compound identified in the screen as having beneficial properties, and modifying or functionalising by nature of moieties or linking location of linking on the basis of the indications from the screen to prepare an optimised library. In a particular advantage of the invention the molecular pharmacology and photochemistry from the screen feedback into the design of the library.

The linker strategy is in some cases specific for the tag to be used, whereby modifying the tag may require modifying the linker. We have surprisingly found that modifying a moiety without consequential modification of other moieties may result in an inactive compound which is for example incapable of binding.

In a further aspect of the invention there is provided a known or novel compound of formula I or I′ as hereinbefore defined wherein the compound is associated with information relating to its pharmacological properties in the form of Spectral Properties given as Excitation Max and Emission Max, Fluorescence Lifetime and Emission quantum yield and Pharmacology defined in terms of cells expressing a GPCR receptor as hereinbefore defined or expressing an intracellular enzyme such as a cyclic nucleotide phosphodiesterase, or a drug transporter as hereinbefore defined and given as the Inhibition or Antagonism of receptor binding or of receptor functionality together with a value for the Inhibition (pK_{B}) or Antagonism (pK_{I}) binding constants; and optionally together with fluorescent images of the pharmacological binding in single living cells illustrating the defined inhibition or antagonism.

Preferably the compound is associated with information relating to its pharmacological properties wherein pharmacology is defined in terms of a cell or protein wherein the cell expresses a GPCR, intracellular enzyme or drug transporter or the protein is a GPCR, intracellular enzyme or drug transporter preferably in terms of a CHO cell comprising GPCR receptors as hereinbefore defined, preferably selected from an adenosine receptor such as an A₁-, A_{2A}-, A_{2B}- and A₃-receptor, a beta-adrenoreceptor such as an β₁, β₂- and β₃-adrenoceptors or like receptor, or comprises an inhibitor of an intracellular enzyme such as cyclic nucleotide phosphodiesterases or a substrate or inhibitor of a drug transporter as hereinbefore defined; more preferably in terms of CHO-cells expressing human adenosine A₁-receptor or beta-adrenoceptor or an inhibitor of an intracellular enzyme such as an inhibitor of intracellular phosphodiesterases. The pharmacological properties are given as EC₅₀ values for agonist stimulated—or pKᵢ values for antagonism of agonist stimulated second messenger generation, or substrate Kₘ values or antagonist Kᵢ values for stimulation or inhibition of intracellular enzymes or drug transporters.

Preferably a novel compound is of the formula I or I′ as hereinbefore defined, more preferably is selected from formulae Lig.aₘ L.a-Fl.aₙ to Lig.eₘ L.eFl.eₙ as hereinbefore defined

with the proviso that:

a) when Lig is XAC ie in Lig.a when each of R.a¹ and R.a² is propyl, R.a³ is H and R.a⁴ is —Ph—OCH₂CONH(CH₂)₂NH—, and L is a single bond or L is gly and n=3 or L is NCS, Fl is not fluorescein; or

when Lig is XAC and L is a single bond or NCS, Fl is not fluorescein or NBD;
b) when Lig is adenosine Fl is not Fmoc (CA 134:204756); or

when Lig is ADAC, ie R.b¹ is CH₂OH, R.b² and R.b³ are H and L is —(Ph—CH₂CONH)₂(CH₂)₂— or L is a single bond, Fl is not fluorescein, NBD or Rhodamine; or

when Lig is NECA (incorporating the moiety —(CH₂)m) ie R.b² and R.b³ are H and L is a single bond, or is —(CH₂)m when m is 2,4,6,8 or 10 then Fl is not NBD, or when m is 3,4,6,8,10 or 12 then Fl is not dansyl; or

when Lig is N⁶-[2-(4-aminophenyl)ethyl]adenosine and L is (CH₂)₂PhNH, Fl is not FITC (CA 131:56155 (8))
d) when Lig is CGP12177 and L (R.d²) is mono amine menthane, Fl is not BODIPY® TMR; or

when Lig is CGP12177 and L is 1,1,4,4-tetramethyl butylamine, i.e C(CH₃)₂(CH₂)₂C(CH₃)₂NH-Fl is not BODIPY® FL, or when L is C(CH₃)₂(CH₂)₂C(CH₃)₂NHCSNH— then Fl is not FITC, eosin or erythosin; or when L is monoamine menthane, Fl is not FITC (CA 131:56155 (4)); or

when Lig is CGP12177 and L is a single bond, Fl is not NBD; or

when Lig is alprenolol i.e o-prop-2-enyl phenyl and L is —C(CH₃)₂— or a single bond, Fl is not NBD.

Optionally additionally

a) when Lig is XAC ie in Lig.a when each of R.a¹ and R.a² is propyl, R.a³ is H and R.a⁴ is —Ph—OCH₂CONH(CH₂)₂NH—, and L is a single bond Fl is not BODIPY™ 630/650; or

b) when Lig is ABEA, ie m is 4 and L is a single bond Fl is not BODIPY™ 630/650.

Preferably a ligand or fluorescent ligand of the invention is an agonist which maintains its binding affinity and its functional activity or is an antagonist which maintains its binding affinity on linking or when linked to fluorescent moiety Fl. Fluorescent ligands may have affinity such that they bind permanently, semi-permanently or transiently, ie may retain bound or may be washed away when unbound ligand is washed away.

Fluorescent ligands of the invention may be inherently optically active or may be functionalised, in known manner, to be optically active, and any such ligand may be present as a racemate or as one of its optically active isomers.

In a further aspect of the invention there is provided a novel reactive ligand of formula IV or IV′ as hereinbefore defined or library thereof useful for linking to any suitable tag of formula V or V′ as hereinbefore defined, with the proviso that

when Lig is Lig.a and is 1,3-dialkyl xanthine as hereinbefore defined wherein X¹ and X² are ═O, R.a³ is H, R.a¹ and R.a² are both CH₃ or both n-C₃H₇, then R.a⁴ is not 4-hydroxyphenol or PhOCH₂CO₂H; or

when R.a¹ and R.a² are both n-C₃H₇, then R.a⁴ is not PhOCH₂OCNHPhOH; PhOCH₂OCONsuccin, PhOCH₂CONH₂, PhOCH₂CONH(CH₂)₂NH₂, PhOCH₂CONH(CH₂)₈NH₂ PhOCH₂COHNNH₂, or PhOCH₂CONH(CH₂)₂N(CH₂CH₃.HOAc)CH₂PhOH; or

when Lig is CGP 12177 then L is not —C(CH₃)₂(CH₂)₂C(CH₃)₂NH₂ (CA 121:103486; or

when Lig is aden, L is not —(CH₂)₂S(CH₂)₂NH₂ (CA 125:218348; or L is not (CH₂)₆NH₂ or CH₂CONH(CH₂)₆NH₂ (CA 134:2043); or L is not (CH₂)₂NH₂ or (CH₂)₂O(CH₂)₂O(CH₂)₂NH₂ (CA 135:25706); or L is not (CH₂)nNH₂ where n is 2-12 (CA 108:715);

or when Lig is alprenolol L is not (CH₂)₈NH₂ or when Lig is propranolol L is not (CH₂)₄NH₂ (CA 124:8848)

or when Lig is alprenolol L is not CH₂C(CH₃)₂NH₂ (CA 108:215827)

or when Lig is ICI 118551 L is not (CH₂)₂NH₂ or when Lig is propranolol L is not (CH₂)₂NH₂ (CA 98:4564)

Preferably a novel ligand-linker comprising a compound of formula IV wherein components are as hereinbefore defined and a reactive group Y_{Lig} is as hereinbefore defined, preferably of formula Lig L.I or Lig.LI′ as hereinbefore defined.

In a further aspect of the invention there is provided a novel fluorophore linker of formula V or V′ as hereinbefore defined or library thereof.

In a further aspect of the invention there is provided a kit comprising ligand precursors, linker precursors and tag precursors of formulae IV, IV′, V, V′ and/or VI as hereinbefore defined for preparing a library of compounds of formula I as hereinbefore defined.

In a further aspect of the invention there is provided the use of a fluorescent ligand of formula I or I′ as hereinbefore defined or library thereof for visualising receptors or receptor binding, assessing pharmacological properties of the fluorescent ligand, in high throughput screening of novel chemical entities that bind to the target receptor, in inhibiting an intracellular enzyme or inhibiting a drug transporter or a substrate of a drug transporter, in studying drug transport or drugs suitable for transport, in distinguishing healthy or diseased tissue and the like. Preferably the use comprises using any fluorescence detection technique more preferably confocal microscopy or fluorescence correlation spectroscopy. Preferably the use allows to calculate ligand affinity constants and concentration of sub-populations of a receptor type, intracellular enzyme or drug transporter as hereinbefore defined.

In a further aspect of the invention there is provided a method for receptor binding or inhibition, intracellular enzyme inhibition or drug transport or inhibition and visualisation comprising contacting a fluorescent ligand as hereinbefore defined with a sample in manner to facilitate binding or inhibition thereof or transport thereby, and detecting changes in fluorescence or location thereof.

A sample may comprise cell material, selected from cells, cell extracts, cell homogenates, purified or reconstituted proteins, recombinant proteins or synthesised proteins and the like, and includes a target for the compound of formula I. Samples comprising cell material may be derived from plants, animals, fungi, protists, bacteria, archae or cell lines derived from such organisms. Animal or plant cells used to prepare the sample may be healthy or disfunctional and are optionally used in the diagnosis of a disease such as leukaemia or cancer; In a preferred embodiment of the invention the sample comprises mammalian cells, extracts and homogenates thereof.

Preferably a sample comprises live cell material, more preferably including individual cells or sub cell compartments, most preferably comprising GPCRs, intracellular enzymes or drug transporters in living cells, membrane containing these proteins, solubilised receptors, enzymes or drug transporters or GPCR arrays. Cell material may be obtained in known manner by culturing cells or by expressing proteins in cells.

In a preferred embodiment the cell material is a cell expressing a GPCR, enzyme or drug transporter. GPCR's are possibly the single most important class of targets for current and prospective drug therapies.

More preferably the sample comprises GPCR receptors selected from adenosine A₁-, A_{2A}-, A_{2B}- and A₃-receptors, β₁, β₂- and β₃-adrenoceptors, or comprises inhibitors of intracellular enzymes such as cyclic nucleotide phosphodiesterases, most preferably CHO-cells expressing human adenosine A₁-receptor or beta-adrenoceptor or an inhibitor of an intracellular enzyme such as an inhibitor of intracellular phosphodiesterases.

Cell material may be tagged prior to contact with the fluorescent ligand, for example by tagging with GFP, for example GFP tagged GPCR's, GFP tagged intracellular enzymes and GFP tagged drug transporters, or a native receptor, intracellular enzyme or a drug transporter to which a fluorescent antibody has been targetted, to allow visualising of the cell receptors, enzymes or transporters, and overlay with the fluorescent ligands.

Receptors may be provided in membrane samples or in acutely dispersed cell samples, for example endogenous receptors such as A₁-AR in acutely dispersed cells. The adenosine receptor binding site is located deep within the pocket of the receptor, whereby a fluorescent ligand with linker is a preferred fluorescent (ant)agonist. Whilst there is considerable freedom in modifying the ligand and retaining antagonist binding activity, it is harder to retain agonist activating activity, ie activating the receptors functions on binding.

The method for drug transport of a substrate of a drug transporter would be to follow the uptake of the compound of formula I into the cell cytosol (if the transporter moves the drug into cells) OR after loading the cells with substrate to follow the dissappearance of the compound of formula I from the cells and its appearance in the extracellular medium (if the transporter moves the drug out of the cells—for example in the case that the transporter is an ATP-driven pump). Preferably the method comprises monitoring transport of a drug into a cell via an equilibrium transporter that moves the compound into the cell—then applying an inhibitor of this first equilibrium transporter, and monitoring the export of the drug from the cells via an ATP-driven pump transporter.

The method of inhibition of a drug transporter may be monitored by detecting binding to the transporter on the cell surface.

Preferably the method including detecting a change in fluorescence includes detecting a change in the intensity, excitation or emission wavelength distribution of fluorescence (single and multi photon), fluorescence lifetime, fluorescence polarisation or a combination thereof or the like. The optical response is detected by known means such as cameras, film, laser-scanning devices, fluorometers, photodiodes, quantum counters, microplate, microscopes, fluorescent microscopes such as epifluorescence or confocal, cytometers, readers and the like, preferably CSLM, confocal plate readers, fluorescence polarisation plate readers or FCS. Where the sample is examined using a flow cytometer, examination of the sample optionally includes sorting components of the sample according to their fluorescence response.

A method for binding or inhibition or detection according to the invention may be in vitro or in vivo.

In a particular advantage of the invention the novel fluorescent ligands are suitable for use in combination with FCS enabling the study of ligand-receptor binding at the single molecule level. Because of the nature of the events being monitored FCS is ideal for the study of thermodynamic and kinetic features of molecular interactions in solution. Another particular advantage of the invention is that the FCS approach can be adapted to monitor ligand-receptor binding at the single molecule level using photon counting fluorescence intensity measurements. This removes any requirement for the molecules to be moving within the confocal volume.

With ligands showing low background fluorescence it is not necessary to remove unbound ligand by washing before performing either confocal microscopy or FCS. It is therefore possible to measure fluorescence with time, in both time and concentration dependent manner.

Confocal microscopy (CSLM) allows visualisation of a section through a cell showing concentration of fluorophore at the cell edges indicating membrane receptor binding. Visualisation is of a particular plane of focus such that a “slice” through an individual cell may be observed, as known in the art. Different coloured channels may be selected to visualise different fluorophore types.

FCS is a non-invasive technique which analyses the diffusion characteristics of fluorescent species through a very small excitation volume (<10¹⁵ l) by statistically analysing the pattern of their photon emissions. Thus fast-diffusing free ligand can be distinguished from slowly-diffusing receptor-bound ligand and quantified simultaneously when the volume is localised to the cell membrane. Preferably the method incorporating FCS comprises measuring fluctuations in fluorescence intensity in a confocal volume of <10⁻¹⁵ l. Statistical analysis of these fluctuations gives information about the speed of diffusion (i.e. mass) and concentration of the fluorescent molecules present. Thus free ligand (fast diffusing) and bound ligand (slow diffusing) can be quantified simultaneously on a single cell.

FCS (fluorescence correlation spectroscopy) correlates fluctuations in fluorescence emission of particles to parameters such as particle mass and concentration for the study of molecular interactions in solution. FCS essentially monitors spontaneous fluorescence intensity fluctuations of fluorescently tagged molecules in a microscopic detection volume (10⁻¹⁵ l) through analysis by a tightly focused laser beam.

These fluctuations provide information on the rate of diffusion or diffusion time of a particle which is directly dependent on the mass of the given molecule. When small and therefore rapidly diffusing molecules pass through the path of the laser they produce rapidly fluctuating fluorescence intensity patterns, whereas when larger molecules pass through the beam they produce bursts of fluorescence that are more sustained. Consequently the increase in the mass of a biomolecule, eg as a result of ligand binding, is detected as an increase in the diffusion time of the resultant biomolecule.

Fluorescence microscopy may be used to localise receptors at single cell or sub cellular level with sensitivity and speed. In this way high affinity tagged ligands could help to elucidate molecular characteristics of GPCR receptor subtypes, such as adenosine and the like receptors, their regional distribution and cellular localisation.

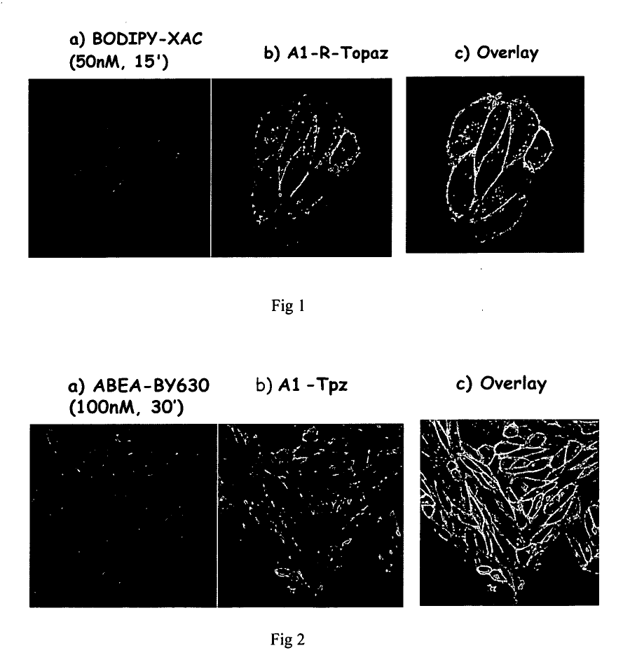

In a further aspect of the invention there is provided the use of a fluorescent target for the fluorescent ligand, for example, a Green Fluorescent Protein-tagged receptor, intracellular enzyme or drug transporter. In this case the spectral characteristics of the fluorescent ligand are chosen to allow separate detection of the location of both the fluorescent ligand and the fluorescent receptor, intracellular enzyme or drug transporter. Cross-correlation fluorescence correlation spectroscopy or fluorescence intensity measurements will then allow the quantitative analysis of ligand-receptor, ligand-enzyme, ligand-drug transporter or drug transport interactions in a single measurement. This is distinct from prior art methods involving GFP-protein translocation assays and assays involving fluorescence energy transfer (FRET). FIG. 1 exemplifies this approach.

In a further aspect of the invention there is provided a cell surface GPCR modified on its N-terminus or a naturally occurring domain to express a short epitope tag for a commercially available antibody (e.g. myc, haemaglutinin, FLAG). This is then expressed in CHO cells and a fluorescent antibody to the tag sequence is used in living cells to provide two-colour analysis of fluorescent ligand-receptor interactions as described for GFP-tagged proteins above.

In a further aspect of the invention there is provided CHO cells expressing a cell surface GPCR modified as claimed in Claim 37 for use with a fluorescent antibody to the tag sequence is used in living cells to provide two-colour analysis of fluorescent ligand-receptor interactions as described for GFP-tagged proteins above.

In a further aspect of the invention there is provided a kit comprising a compound of formula I or I′ as hereinbefore defined and a target therefore provided as a cell line, membrane derived from such a cell line or protein solubilised from that cell line. The cell derived material may be provided in one of three forms: (1) from cells expressing a green fluorescent protein tagged receptor, intracellular enzyme or drug transporter; (2) from cells expressing an epitope tag for a commercially available fluorescent antibody or (3) a wild-type protein for which a specific fluorescent antibody is also provided.

In an alternative embodiment there is provided a kit comprising a compound of formula I or I′ as hereinbefore defined and a fluorescent antibody to a native protein which can be used in native (non-recombinant) cells.

In each case, the spectral characteristics of the compound of formula I or I′ and fluorescent antibody or green fluorescent protein are selected to allow optimum two-colour cross-correlation fluorescence correlation spectroscopy (single or multiphoton).

The invention is now illustrated in non-limiting manner with reference to the following figures and examples and accompanying synthesis schemes.

In the Figures:

FIG. 1 shows images taken from confocal microscopy imaging of a) fluorescence derived from XAC BY-630 binding to receptors on the surface of CHO cells observed at the red channel, b) fluorescence derived from green fluorescent protein fused to the C terminus of the human adenosine A₁-receptor, expressed by CHO cells indicating receptor locations observed via the green channel and c) overlaid images from a) and b) showing overlap of fluorescence and therefore confirming ligand binding is specific to receptors.

In the Schemes:

Scheme 1 shows synthesis routes for the synthesis of an adenosine receptor antagonist Lig-L-Fl_{L}

Schemes 2 and 3 show synthesis routes for the synthesis of two adenosine receptor agonists Lig-L-Fl_{L} including the synthesis of ligand precursor Lig-L-Z_{L} from linker precursor Z_{L}′-L-Z_{L}

Scheme 4 shows synthesis routes for the synthesis of two beta adrenoceptor agonists Lig-L-Fl_{L} including the synthesis of ligand precursor Lig-L-Z_{L} from linker precursor Z_{L}′-L-Z_{L}

### EXAMPLES A-C

The following compounds are synthesised or modelled and binding affinity studied:

### Example A1/B1/C1 Adenosine Receptors Antagonists

XAC-BODIPY 630/650 (1)

### Example A2/B2 Adenosine Receptor Agonists

Adenosine-BODIPY 630/650 (2)

NECA-BODIPY 630/650 (3) (ABEA-BODIPY 630)

APEA-BODIPY 630/650 (3a)

ABIPEA-BODIPY 630/650 (3b)

### Example A3/B3 Beta-Adrenoreceptor Agonists

Salmeterol-BODIPY 630/650 (4)

Clenbuterol-BODIPY 630/650 (9)

### Example A4/B4 Beta-Adrenoreceptor Antagonists

CGP12177-BODIPY 630/650 (5)

Propranolol-BODIPY 630/650 (6)

ICI118551-BODIPY 630/650 (7)

Alprenolol-BODIPY 630/650(8)

### Example A5/B5 Inhibitors of Cyclic Nucleotide Phosphodiesterases

XAC-BODIPY 630/650 (1)

Materials and Methods

The ¹H NMR spectra were acquired on a Bruker AM 250 (250 MHz) spectrometer, in CDCl₃ or DMSO-d₆. Chemical shifts (δ) are recorded in ppm with reference to the residual solvent signal/TMS. Coupling constants (J) are recorded in hertz, and signal multiplicities are described by s (singlet), d (doublet), dd (doublet of doublets), t (triplet), m (multiplet), br (broad). Where given, assignments are made based on homonuclear correlation spectroscopy (COSY-45) and, where available, are in full agreement with literature values (Jacobsen K A et al., J. Med. Chem. (1985), 28, 1341-6).

(Analytical RP-HPLC was performed on a Waters Millenium LC system with 996 PDA eluent detection, using a Vydac C⁸ column (150 mm×4.6 mm) at a flow rate of 1.0 mL.min⁻¹. The mobile phases used were: Solvent A, water, (degassed by helium bubble); Solvent B, acetonitrile, (degassed by sonication)).

A. Synthesis

### Example A1

### Synthesis of Adenosine Based Fluorescent A₁ Receptor Antagonists

1. XAC-BY630 (1)

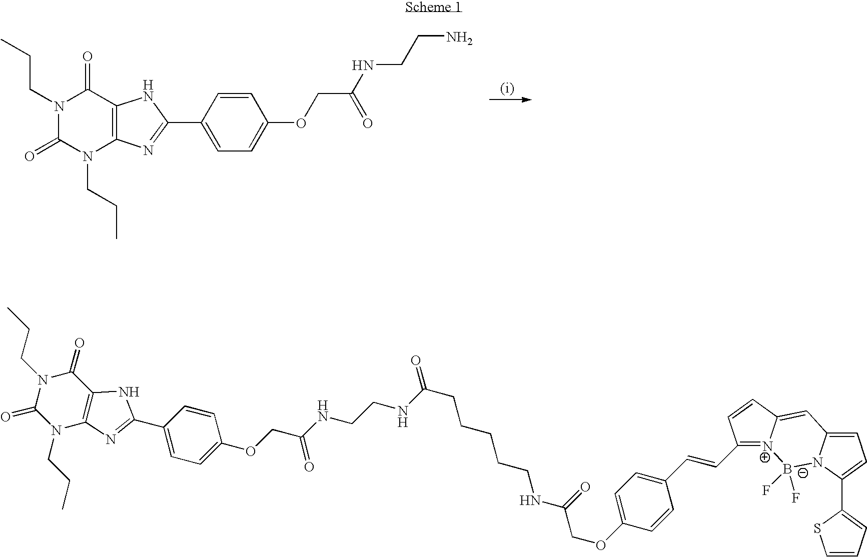

Reagents and conditions: (i) BODIPY 630/650-X-SE, DMF 2 h, RT, (72%).

XAC-BODIPY 630/650 was synthesised by reacting the primary alkyl amine group of XAC with BODIPY®-630/650-X-succinimidyl ester (Molecular Probes). XAC and BY630 were stirred in N,N-dimethylformamide for 2 h at room temperature and the product purified by HPLC. XAC and analogues were synthesised by the method of Jacobsen et al J. Med. Chem 1985, 28, 1334-1340.

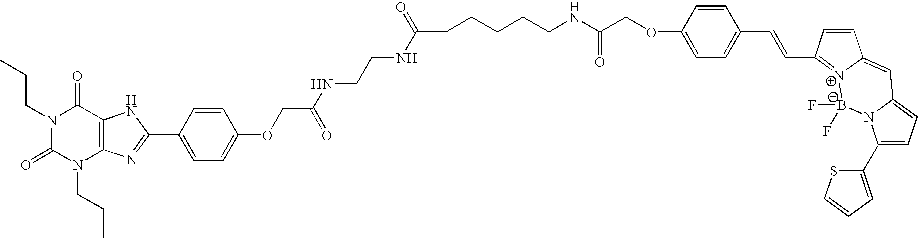

TOF ES+ found 974.3998 (C₅₀H₅₅BF₂N₉O₇S requires 974.4006)

Rₜ 12.5 min (35-100% v/v B, 30 min)

δ_{H} 0.87, 0.90 (6H, overlapping t, J 9.3, N¹—, N³—CH₂CH₂CH₃), 1.14-1.25 (2H, m, C²⁴H₂), 1.36-1.62 (6H, m, C²³H₂, C²⁵H₂, N^{1/3}—CH₂CH₂CH₃), 1.68-1.78 (2H, m, N^{1/3}—CH₂CH₂CH₃), 2.04 (2H, t, J 7.3, C²²H₂), 3.04-3.19 (6H, m, C¹⁸H₂, C¹⁹H₂, C²⁶H₂), 3.86 (2H, t, J 7.4, N^{1/3}—CH₂CH₂CH₃), 4.01 (2H, t, J 7.1, N^{1/3}—CH₂CH₂CH₃), 4.52, 4.53 (4H, 2×s, C¹⁵H₂, C²⁹H₂), 6.95 (1H, d, J 4.2), 7.05-7.10 (4H, m), 7.27-7.30 (3H, m), 7.35-7.40 (2H, m), 7.41 (1H, br s), 7.54-7.65 (3H, m), 7.70 (1H, s), 7.77 (1H, s), 7.80-7.92 (2H, s), 8.01-8.23 (4H, m) (2×C¹¹H, 2×C¹²H, 2×C³²H, 2×C³³H, C³⁵H, C³⁶H, C³⁸H, C³⁹H, C⁴¹H, C⁴³H, C⁴⁴H, C⁴⁷H, C⁴⁸H, C⁴⁹H, N⁹H, N¹⁷H, N²⁰H, N²⁷H)

### Example A2

### Synthesis of Adenosine Based Fluorescent Agonists at the Human A₁-Adenosine Receptor (A₁-AR) Receptor Based on 5′-N-ethylcarboxamidoadenosine (NECA) with Maintained Functional Activity

Compounds 2, 3, 3a and 3b were synthesised by reaction of suitably protected inosine derivatives, specifically with a chlorinating agent allowing introduction of a protected linker. Removal of protecting groups preceded conjugation of a fluorescent agent via the linking group.

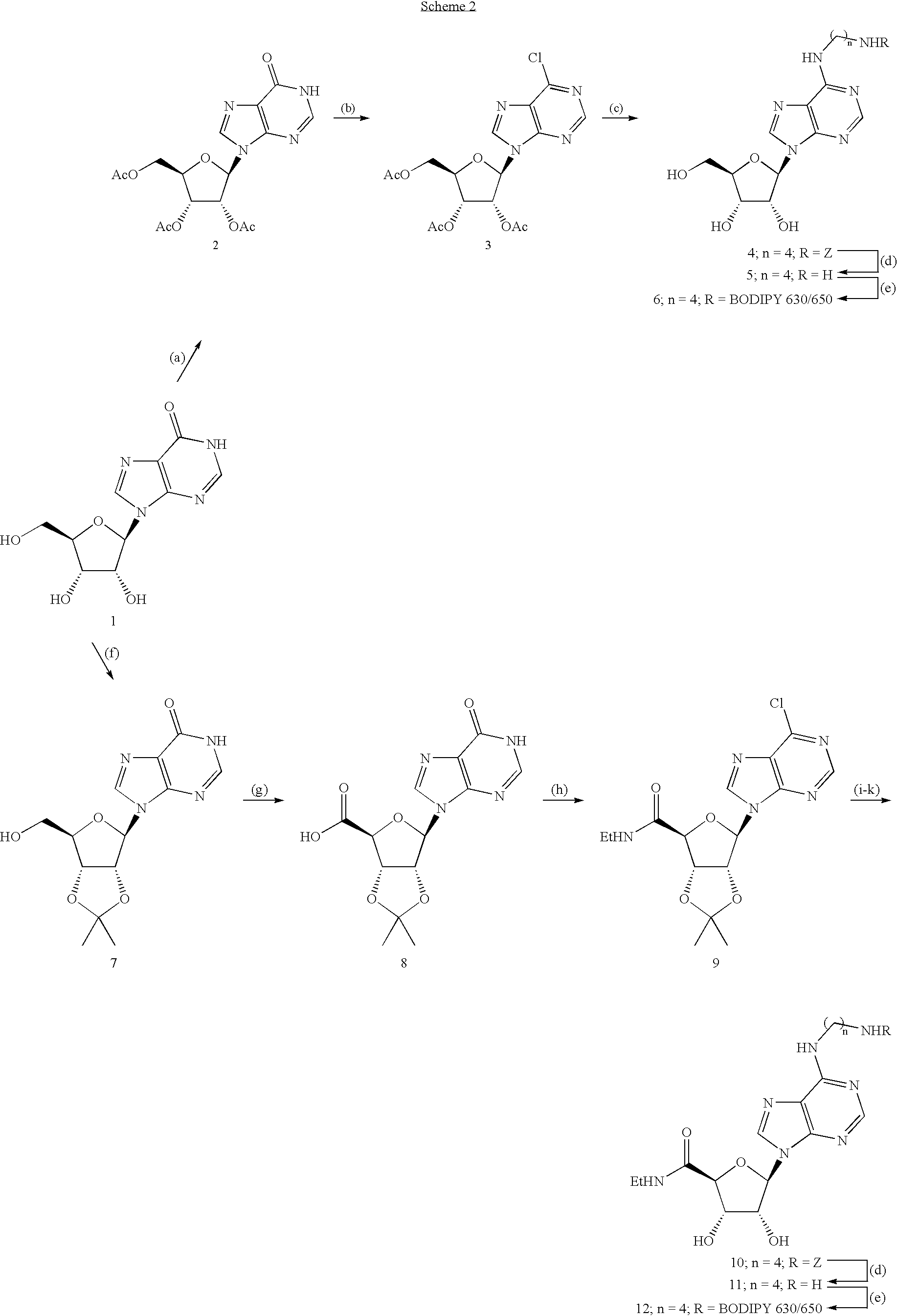

Reagents and conditions: (a) Ac₂O, pyridine, 40° C., 1 h, 97%. (b) POCl₃, N,N-dimethylaniline, reflux, 5 min, 85%. (c) (i) H₂N(CH₂)₄NHR, DIEA, EtOH, reflux, 18 h, (ii) sat. NH₃/MeOH, 0° C., 2 h. 66%. (d) H₂, Pd/C, MeOH:H₂O:AcOH (7:2:1), r.t., 2 h, 80% (e) BODIPY 630/650-SE, DMF, r.t., 3 h, 63%

1. Adenosine-C⁴-BODIPY 630/650 (ABA-BY630) (2)

ABA-BY630 was synthesised using the method and reagents and conditions described in Scheme 2 a-e in which R is COCH₂Ph.

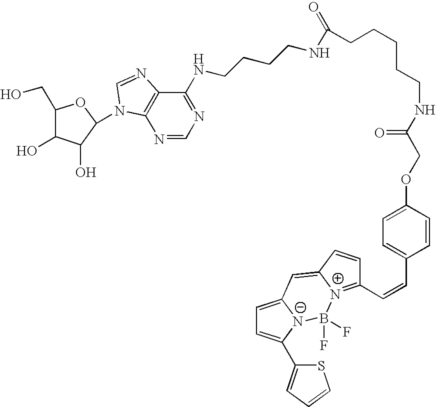

ES+ found 885.4 (C₄₃H₄₈BF₂N₉O₇S requires 885.4)

R^{t} 22.5 m in (5-100% v/v B., 30 m in)

2. NECA-C⁴-BODIPY 630/650 (ABEA-BY630) (3).

N⁶-aminobutyl-5′-deoxy-5′-oxo-5′-ethylaminoadenosine (ABEA) was synthesised from commercially available reagents in 6 steps. The primary amine group of ABEA was acylated with the fluorophore BODIPY®6301650-X-succinimydyl ester (BY-630, Molecular Probes) to afford BY630-ABEA, which was purified by RP-HPLC (Scheme 3).

The synthesis is shown in Scheme 3, with use of linker precursor of formula H₂N(CH₂)₄HNCOOCH₂Ph:

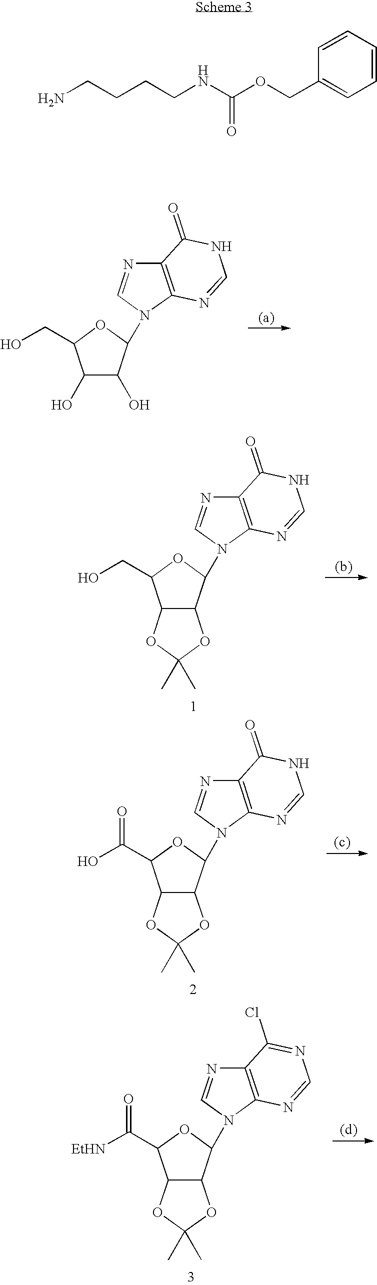

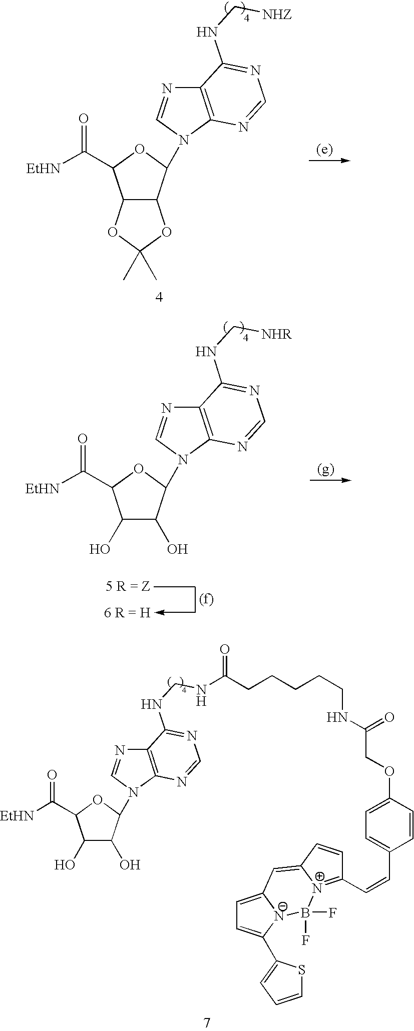

Reagents and Conditions: (a) 2,2-Dimethoxypropane, TsOH, acetone, r.t., 18 h. (b) TEMPO, BAIB, MeCN:H₂O (1:1), r.t., 4 h. (c) (i) SOCl₂, DMF, CHCl₃, reflux, 6 h. (ii) EtNH₂, CHCl₃, 5° C., 30 min. (d) H₂N(CH₂)₄NHZ, DIEA, EtOH, reflux, 18 h. (e) 0.1 M HCl_{(aq)}, 50° C., 4 h. (f) H₂, Pd/C, MeOH:H₂O:AcOH (9:0.9:0.1), r.t., 3 h. (g) BODIPY 630/650-X-SE, DMF, r.t., 4 h.

Synthesis of Linker Modified Ligand, Compound of Formula IV

2′,3′-Isopropylideneinosine 1: Inosine (5.36 g, 0.02 mol) and tosic acid monohydrate (3.80 g, 0.02 mol) were suspended in a mixture of 2,2-dimethoxypropane (50 cm³) and acetone (200 cm³) and stirred for 18 h. Sodium hydrogen carbonate (2.52 g, 0.02 mol) and water (40 cm³) were added and the suspension stirred for 15 min. The suspension was evaporated to constant volume and the crude product recrystallised from the residual water, yielding the acetonide 1 (3.71 g, 60%) as white needles; mp 266-268° C. (from H₂O) (lit., 266° C.); [α]²²_{D} −67.1 (c 0.59 in MeOH) (lit., [α]²⁰_{D} −66.9 (c 0.8 in MeOH)); δ_{H}(250 MHz; DMSO-d₆) 1.31 (3H, s, CH₃), 1.53 (3H, s, CH₃), 3.53 (2H, m, C^{5′}H₂), 4.22 (1H, m, C^{4′}H), 4.93 (1H, dd, J 6.1 and 2.5, C^{3′}H), 5.26 (1H, dd, J 6.1 and 2.9, C^{2′}H), 6.10 (1H, d, J 2.9, C^{1′}H), 8.10 (1H, s, adenine CH), 8.31 (1H, s, adenine CH); δ_{C}(69.2 MHz; DMSO-d₆) 25.2, 27.0 (2× acetonide), 61.4 (C^{5′}), 81.3 (C^{4′}), 83.8 (C^{3′}), 86.6 (C^{2′}), 89.6 (C^{1′}), 113.1 (4°), 124.4 (4°), 138.7 (CH), 146.1 (CH), 147.8 (4°), 156.5 (40); m/z (ES+) 309 (MH⁺), 137 (M-ribose).

2′,3′-Isopropylidene-5′-oxoinosine 2: Acetonide 1 (3.08 g, 10 mmol), TEMPO (313 mg, 2 mmol) and iodosobenzene diacetate (7.09 g, 22 mmol) were dissolved in MeCN: H₂O (1:1, 50 cm³) and stirred, with the exclusion of light, for 4 h. The solvents were carefully evaporated from the resultant suspension and the reaction residue sequentially triturated with acetone and diethyl ether to yield the acid 2 (2.67 g, 83%) as a white powder; mp 224-229° C. (from diethyl ether) (lit., 274-276° C.); (found: C, 48.55; H, 4.3; N, 17.0. C₁₃H₁₄N₄O₆ requires C, 48.45; H, 4.4; N, 17.4%); δ_{H}(250 MHz; DMSO-d₆) 1.33 (3H, s, CH₃), 1.51 (3H, s, CH₃), 4.68 (1H, d, J 1.6, C^{4′}H), 5.36-5.44 (2H, m, C^{2′}H and C^{3′}H), 6.30 (1H, s, C^{1′}H), 8.02 (1H, s, adenine CH), 8.27 (1H, s, adenine CH), 12.42 (1H, br s, NH; δ_{C}(69.2 MHz; DMSO-d₆) 25.1, 26.7 (2× acetonide), 83.9, 85.8, 90.0 (4×CH), 112.9 (4°), 124.4 (4°), 140.0 (CH), 145.8 (CH), 148.2 (4°), 156.8 (4°), 171.8 (C═O); m/z (ES+) 323 (MH+), 137 (M-ribose).

6-Chloro-6-deoxy-5′-ethylamino-2′,3′-isopropylidene-5′-oxo-5′-deoxyinosine 3: (N.B. Rigorously dry reaction conditions and under an inert atmosphere) acid 2 (967 mg, 3 mmol), was suspended in CHCl₃ (15 cm³) to which was added N,N-DMF (581 μL, 7.5 mmol) and SOCl₂ (1.09 cm³, 15 mmol). The suspension was placed in a hot oil-bath and maintained at reflux for 6 h. The resultant solution was evaporated and the yellow oil dissolved in THF (20 cm³) at 5° C. Ethylamine (2.0 M solution in THF, 3.75 cm³, 7.5 mmol) was added drop wise, stirred at 5° C. for 15 min and allowed to warm to room temperature. The solvent was evaporated, the residue dissolved in DCM (25 cm³) and washed with water (2×20 cm³) and saturated brine solution (2×20 cm³). The organic fraction was dried and evaporated to leave a yellow oil that was purified by column chromatography on silica (5% MeOH-DCM) to give the title compound 3 (525 mg, 48%) as a yellow syrup; [α]¹⁹_{D} −12.9 (c 0.50 in CHCl₃); δ_{H}(250 MHz; CDCl₃; Me₄Si) 0.78 (3H, t, J 7.3, CH₂CH₃), 1.41 (3H, s, CH₃), 1.64 (3H, s, CH₃), 2.90-3.11 (2H, m, CH₂CH₃), 4.74 (1H, d, J 1.9, C^{4′}H), 5.46 (1H, dd, J 6.2 and 2.3, C^{2′}H), 5.54 (1H, dd, J 6.2 and 1.9, C^{3′}H), 6.24 (1H, d, J 2.3, C^{1′}H), 6.28 (1H, br s, NH), 8.35 (1H, s, adenine CH), 8.68 (1H, s, adenine CH); δ_{C}(69.2 MHz; CDCl₃; Me₄Si) 14.2 (CH₂CH₃), 25.0, 26.9 (2× acetonide), 33.9 (CH₂CH₃), 82.9, 83.4, 86.7, 92.0 (4×CH), 114.6 (4°), 132.3 (4°), 144.8 (CH), 150.9 (4°), 151.9 (4°), 152.2 (CH), 168.1 (C═O); m/z (ES−) 366 ((M-H)⁻), 153 (M-ribose).

N⁶-(4-Benzyloxycarbonylaminobutyl)-5′-ethylamino-2′,3′-isopropylidene-5′-oxo-5′-deoxyadenosine 4: Chloride 3 (337 mg, 0.92 mmol) was dissolved in EtOH (10 cm³) to which was added N-benzyloxycarbonylbutan-1,4-diamine (305 mg, 1.37 mmol) and DIEA (159 μL, 0.92 mmol). The solution was placed in a hot oil-bath and maintained at reflux for 18 h. The resultant solution was evaporated and the yellow oil purified by column chromatography on silica (2.5% MeOH-DCM) to give the title compound 4 (445 mg, 88%) as a pale yellow gum; δ_{H}(250 MHz; CDCl₃; Me₄Si) 0.99 (3H, t, J 7.1, CH₂CH₃), 1.43 (3H, s, CH₃), 1.55-1.71 (7H, m, CH₃ and 2×CH₂),13.20-3.35 (2H, m, CH₂), 3.55-4.01 (4H, m, CH₂CH₃ and CH₂), 4.81 (1H, s, CH), 5.10 (3H, m, benzyl CH₂ and CH), 5.51 (1H, d, J 5.9, CH), 5.71 (1H, d, J 5.9, CH), 6.10 (1H, br s, NH), 6.16 (1H, br s, NH), 7.30-7.36 (5H, m, aromatics), 7.86 (1H, s, adenine CH), 8.22 (1H, s, adenine CH); δ_{C}(69.2 MHz; CDCl₃; Me₄Si) 13.7 (CH₂CH₃), 25.1, 26.6 (2× acetonide), 26.8, 27.0, 40.0, 40.4 (4×CH₂), 61.5 (CH₂CH₃), 66.6 (benzyl CH₂), 84.1, 84.7, 87.0, 91.6 (4×CH), 113.7 (4°), 128.1 (C), 128.5 (CH), 136.7 (4°), 139.9 (CH), 152.8 (CH), 154.9 (4°), 156.5 (CH), 169.4 (C═O); m/z (ES+) 554 (MH+), 341 (M-ribose).

N⁶-(4-Benzyloxycarbonylaminobutyl)-5′-ethylamino-5′-oxo-5′-deoxyadenosine 5: Adenosine derivative 4 (261 mg, 0.47 mmol) was dissolved in 1 M HCl_{(aq)}: 1,4-dioxane (1:1, 4 cm³), placed in a 50° C. oil-bath and stirred for 4 h. The resultant solution was adjusted to ˜pH 8 (satd. NaHCO_{3(aq)}, saturated with NaCl and extracted with EtOAc (3×5 cm³). The combined organic fractions were dried and, evaporated and the crude product purified by preparative layer chromatography (10% MeOH-DCM) to give the title compound 5 (160 mg, 66%) as a colourless oil; δ_{H}(250 MHz; DMSO-d₆) 1.08 (3H, t, J 7.2, CH₂CH₃), 1.45-1.62 (4H, m, C²H₂ and C³H₂), 2.98-3.06 (2H, m, C¹H₂), 3.17-3.26 (2H, m, CH₂CH₃), 3.37-3.53 (2H, m, C⁴H₂), 4.12-4.16 (1H, m, C^{3′}H), 4.31 (1H, d, J 1.1, C^{4′}H), 4.58-4.65 (1H, m, C^{2′}H), 4.99 (2H, s, benzyl CH₂), 5.56 (1H, d, J 6.5, C^{2′}—OH), 5.76 (1H, d, J 4.2, C^{3′}OH), 5.96 (1H, d, J 7.6, C^{1′}H), 7.25-7.34 (6H, m, aromatics and NH), 8.01 (1H, br s, carbamate NH), 8.27 (1H, s, adenine CH), 8.39 (1H, s, adenine CH), 8.94 (1H, t, J 5.6, amide NH); δ_{C}(69.2 MHz; DMSO-d₆) 14.9 (CH₂CH₃), 26.6, 27.1, 33.4, 39.5, 40.3 (5×CH₂), 65.3 (benzyl CH₂), 72.2, 73.3, 84.9, 88.0 (4×CH), 120.2 (4°), 127.9 (CH), 128.5 (CH), 137.5 (CH), 140.6 (4°), 152.6 (CH), 154.9 (4°), 156.3 (4°), 169.3 (4°); m/z (ES+) 514 (MH+).

N⁶-(4-Aminobutyl)-5′-ethylamino-5′-oxo-5′-deoxyadenosine (ABEA) 6: Adenosine derivative 5 (48 mg, 0.09 mmol) was dissolved in MeOH:H₂O:AcOH (9:0.9:0.1, 5 cm³), to which was added 10% Pd/C (10 mg). The flask was evacuated, filled with hydrogen (balloon) and stirred vigorously for 3 h. The reaction mixture was filtered through celite and the celite washed with MeOH. The combined organic filtrates were evaporated and the resultant oil evaporated again from MeCN (2×15 cm³) to give the title compound 6 (35 mg, quant.) as a colourless oil; δ_{H}(250 MHz; DMSO-d₆) 1.08 (3H, t, J 7.2, CH₂CH₃), 1.46-1.88 (6H, m, 2×CH₂ and NH₂), 2.63 (2H, t, J 6.8, CH₂), 3.16-3.29 (2H, m, CH₂CH₃), 3.40-3.52 (2H, m, CH₂), 4.10-4.15 (1H, m, C^{3′}H), 4.30 (1H, d, J 1.3, C^{4′}H), 4.53-4.62 (1H, C^{2′}H), 5.96 (1H, d, J 7.7, C^{1′}H), 8.05 (1H, br s, NH), 8.27 (1H, s, adenine CH), 8.39 (1H, s, adenine CH), 8.95 (1H, t, J 5.6, amide NH); m/z (ES+) 380 (MH+).

Synthesis of Fluorescent Ligand, Compound of Formula I

ABEA-BY630 (3): ABEA 6 (5.74 mg, 15.1 gmmol) was dissolved in N,N-DMF (1 cm³) under an inert atmosphere and with the exclusion of light. A solution of Bodipy 630/650-X-succinimidyl ester (Molecular Probes) (5.0 mg, 7.55 μmmol, 1 cm³ N,N-DMF) was added and the reaction stirred for 4 h. The solution was evaporated and the crude product purified by preparative layer chromatography (10% MeOH-DCM) to give the title compound 7 (3) (5.24 mg, 75%) as a purple powder; m/z (ES+) found 947.37 (C₄₅H₅₁BF₂N₁₀O₇SNa requires 947.36). 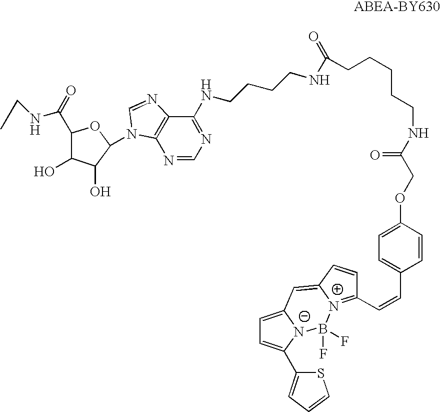
3. NECA-C⁵-BODIPY 630/650 (APEA-BY630) (3a)

This compound was synthesised using the method of Scheme 3 as described for Compound (3), with use of linker precursor of formula H₂N(CH₂)₅NHCOOCH₂Ph:

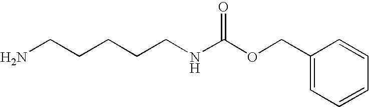

APEA-BY630 was obtained having the formula:

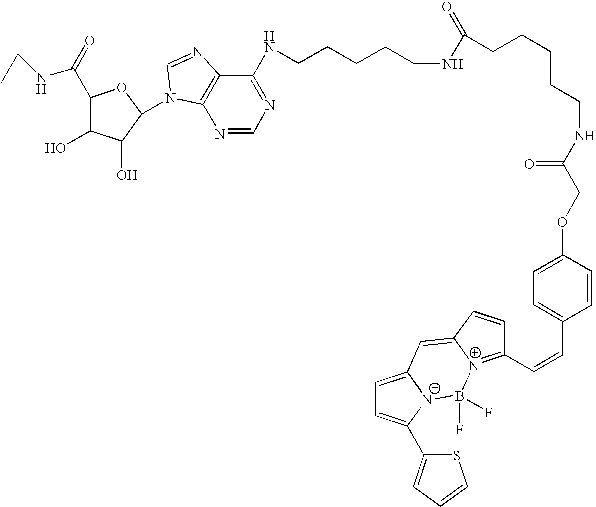

Rₜ 8.6 min (30-100% v/v B, 25 min)

4. NECA-PEG⁸-BODIPY-630/650 (ABIPEA-BY630) (3b)

This compound was synthesised using the method of Scheme 3 as described for Compound (3), wherein intermediates 1 to 3 below are analogues of structures 4 to 7 respectively shown in Scheme 3, with use of linker precursor of formula H₂N((CH₂)₂O)₂(CH₂)₂NH COOCH₂Ph:

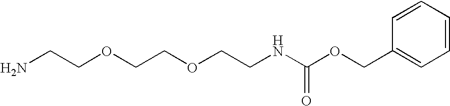

N⁶-(8-Benzyloxycarbonylamino-3,6-dioxaoctyl)-5′-ethylamino-2′,3′-isopropylidene-5′-oxo-5′-deoxyadenosine 1: δ_{H}(400 MHz; CDCl₃) 0.88 (3H, t J 7.3, Et CH₃), 1.38 (3H, s, acetonide CH₃). 1.62 (3H, s, acetonide CH₃), 3.03-3.16 (2H, m, Et CH₂), 3.40-3.93 (14H, m, 6× linker methylenes, C^{3′}H, C^{4′}H), 4.67 (1H, s, C^{2′}H), 5.11 (2H, s, benzyl CH₂), 5.32 (1H, s, C^{1′}H), 5.80 (1H, br s, carbarmate NH), 6.55 (1H, br s, C⁶—NH), 7.02 (1H, br s, amide NH), 7.28-7.37 (5H, m, aromatic CH), 7.64 (1H, br s, adenine CH), 8.29 (1H, s, adenine CH).

N⁶-(8-Benzyloxycarbonylamino-3,6-dioxaoctyl)-5′-ethylamino-5′-oxo-5′-deoxyadenosine 2:δ_{H}(400 MHz; DMSO-d₆) 1.08 (3H, t J 7.2, Et CH₃), 3.12-3.17 (2H, m, linker CH₂), 3.18-3.25 (2H, m, Et CH₂), 3.41 (2H, t J 6.0, linker CH₂), 3.49-3.54 (4H, m, 2× linker CH₂), 3.57-3.67 (4H, mr, 2× linker CH₂), 4.14 (1H, br m, C^{3′}H), 4.31 (1H, d J 1.5, C^{4′}H), 4.58-4.63 (1H, m, C^{2′}H), 5.00 (2H, s, benzyl CH₂), 5.54 (1H, d J 6.4, C^{2′}—OH), 5.74 (1H, d J 4.1, C^{3′}—OH), 5.97 (1H, d J 7.6, C^{1′}H), 7.25-7.36 (6H, m, aromatic CH and carbamate NH), 7.85 (1H, br s, C⁶—NH), 8.28 (1H, br s, adenine CH), 8.40 (1H, s, adenine CH), 8.87 (1H, t J 5.6, amide NH).

N⁶-(8-Amino-3,6-dioxaoctyl)-5′-ethylamino-5′-oxo-5′-deoxyadenosine 3: δ_{H}(400 MHz; DMSO-d₆) 1.05 (3H, t J 7.1, Et CH₃), 1.86 (2H, br s, —NH₂), 2.71-2.80 (2H, m, linker CH₂), 3.17-3.26 (2H, m, Et CH₂), 3.41-73 (10H, m, 5× linker CH₂), 4.15 (1H, br m, C^{3′}H), 4.34 (1H, s, C^{4′}H), 4.47-4.54 (1H, m, C^{2′}H), 5.95 (2H, br s, C^{2′}—OH, C^{3′}—OH), 6.01 (1H, d J 7.5, C^{1′}H), 7.92 (1H, br s, C⁶—NH), 8.31 (1H, br s, adenine CH), 8.44 (1H, s, adenine CH), 8.95 (1H, t J 5.6, amide NH).

ABIPEA-BY630 was obtained having the formula:

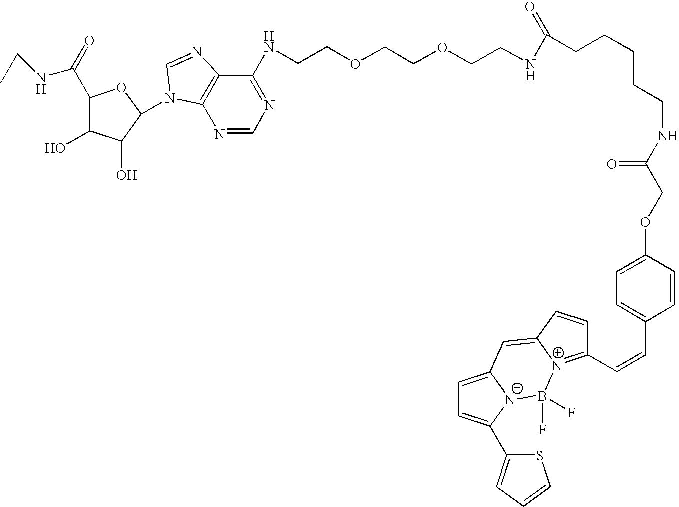

TOF ES+ found 985.3993 (C₄₇H₅₆BF₂N₁₀O₉S requires 985.4013)

Rₜ 8.3 min (35-100% v/v B, 25 min)

### Example A3

### Synthesis of β-Adrenoceptor Agonists

1. Salmeterol-BODIPY 630/650 (4) and Derivative-Salmeterol-BODIPY 630/650 (4a)

Salmeterol is linked to fluorophore via two different linking sites, in the following syntheses

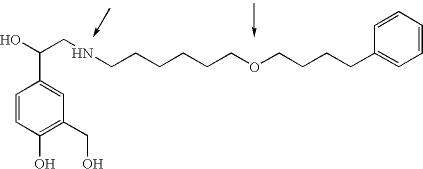

In a first approach, a linker is substituted onto the salmeterol side-chain through which the fluorophore is subsequently attached. In the second approach the native alkyl side-chain of salmeterol is replaced with a linker and fluorophore. In this case, according to the invention, retention of binding, fluorescence and activity are uncertain and must therefore be verified and information provided with the fluorescent ligand, to provide a useful compound.

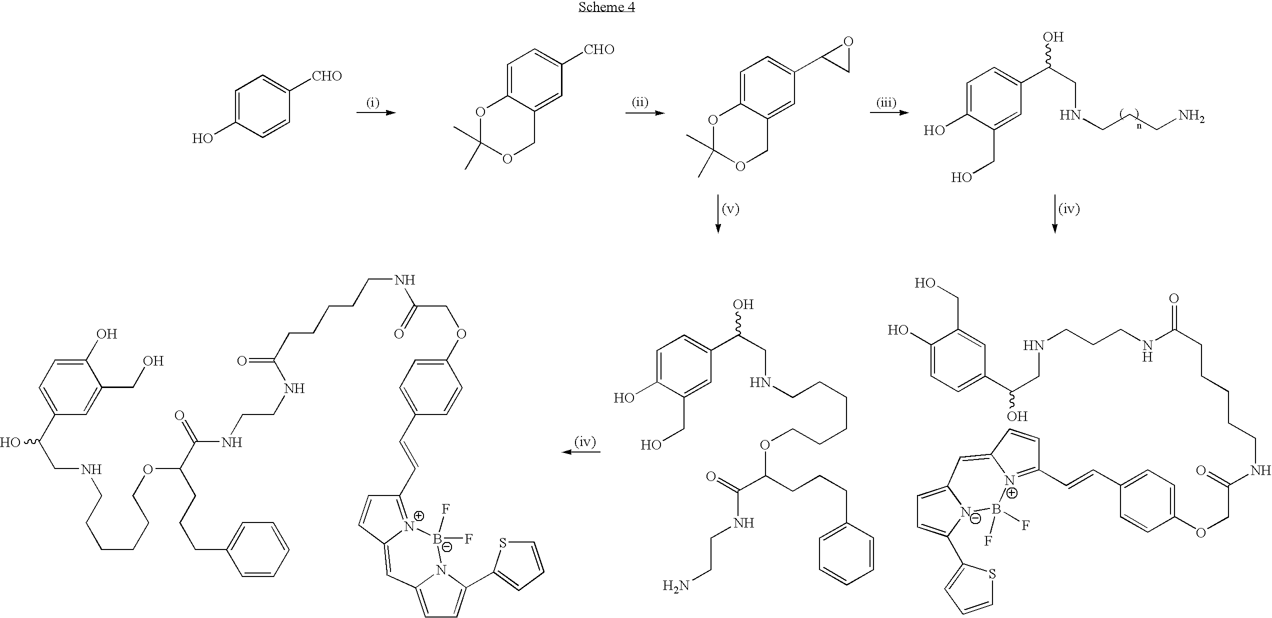

Reagents and conditions. (i) (a) HCHO, HCl_{(aq)}, dioxane, 60° C. (b) 2,2-Dimethoxypropane, TsOH. (ii) Me₃SI, NaH, THF. (iii) (a) BocNH(CH₂)ₙNH₂, EtOH, (b) HCl, Et₂O. (iv) BODIPY 630/650-X-SE, DMF, RT. (v) (a) Z_{L}′Y_{L}′-L-Y_{L}P_{L}, EtOH, (b) HCl, Et₂O, Z_{L}′Y_{L}′-L-Y_{L}P_{L} is 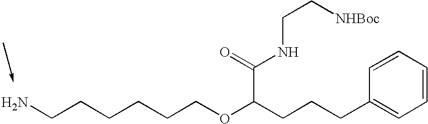
and results in compound 4a

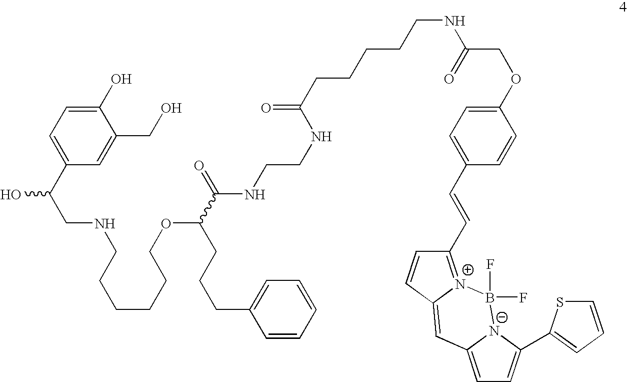

All of the following molecules rely upon the synthesis of the same two linker moieties as shown in Scheme 4 and described above, (where the hydrocarbon chain length can be easily varied, or altered chemically to e.g. an ethylene glycol structure to improve solubility).
2. Clenbuterol-BODIPY 630/650 (9)

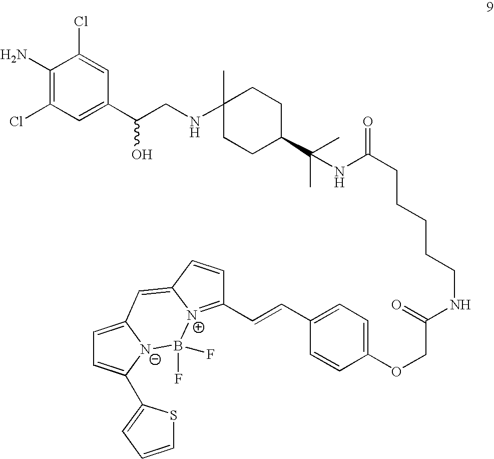

### Example A4

### Synthesis of β-Adrenoceptor Antagonists

All of the following molecules rely upon the synthesis of the same two linker moieties as shown in Scheme 4 and described in Example A3, (where the hydrocarbon chain length can be easily varied, or altered chemically to e.g. an ethylene glycol structure to improve solubility).
1. CGP 12177-BODIPY 630/650 (5) 2. Propranolol-BODIPY 630/650 (6) 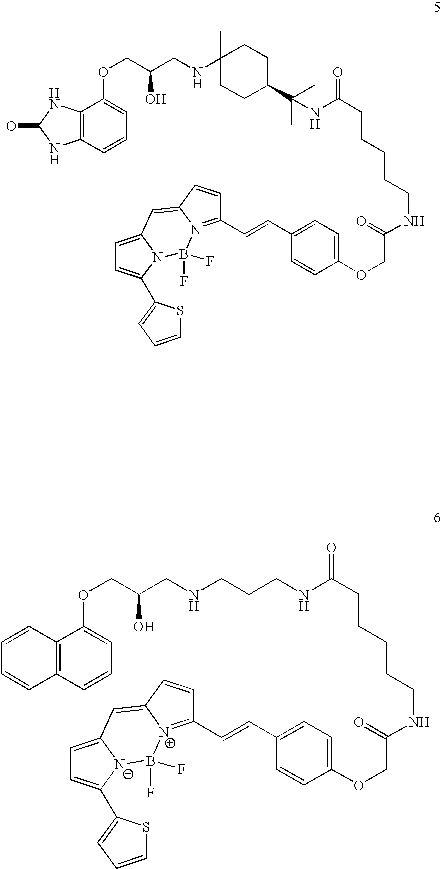
3. ICI118551-BODIPY 630/650(7) 4. Alprenolol-BODIPY 630/650(8) 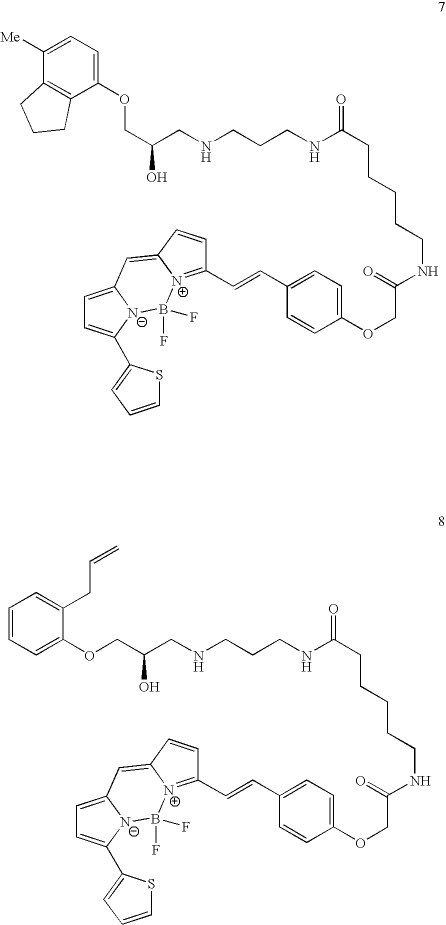
B. Pharmacology

### Example B1

### Binding of Adenosine Based Fluorescent A₁-Receptor Antagonists

1. XAC-BY630 (1)

The adenosine-A₁ receptor (A₁-AR) is a G-protein coupled receptor which is found in a variety of tissues including brain, heart, adipose tissue and muscle. By conjugating the A₁-AR antagonist xanthine amine cogener (XAC) to the fluorophore BODIPY®-630/650 (BY630), we have synthesised a fluorescent A₁-AR ligand, XAC-BY630, to allow visualisation of this receptor in living cells.

[³H]DPCPX binding alongside cyclic AMP and inositol phosphate accumulation assays were performed on CHO-A1 cells expressing the human A1-receptor. Images were acquired using a Zeiss LSM510 confocal microscope using CHO-A1 cells grown to 50% confluency on 8-well Labtek™ plates in Dulbecco's

Modification of Eagle's Medium:Ham's F12 containing 5% foetal calf serum and 2 mM glutamine. Cells were washed twice with HEPES-buffered saline prior to incubation at 22° C. with compounds as indicated.

Spectroscopic analysis of XAC-BY630 and BY630 itself showed that their peak excitation (630, 632 nm, respectively) and emission wavelengths (650, 653 nm) were not substantially different. [³H]DPCPX binding studies on CHO-A1 cell membranes showed that XAC-BY630 had a lower affinity, for the A₁-AR than XAC (pKᵢ=7.79±0.13 and 6.82±0.11, XAC and XAC-BY630, respectively, mean±s.e.mean, n=4). XAC-BY630 also behaved as a competitive A₁-AR antagonist at both 5′-N-ethylcarboxamidoadenosine-mediated inhibition of cAMP production (apparent pK_{B}=6.98±0.15 vs. 8.06±0.24 for XAC, n=3) and stimulation of inositol phosphate production (apparent pK_{B}=6.26±0.20 vs. 7.46±0.08 for XAC, n=4). Confocal imaging showed that XAC-BY630 bound to membrane-localised A₁-ARs in a time- and concentration-dependent manner. Binding of XAC-BY630 (25-250 nM) was detected after 5 min, and was predominantly located at the membrane after a 30 min. incubation. Membrane binding of XAC-BY630 was receptor-specific, since a 30 min pre-incubation with DPCPX (10⁻⁸-10⁻⁶M) caused a concentration-dependent inhibition of membrane binding (30 min, 50 nM).

These studies indicate that XAC-BY630 is a functional A₁-AR antagonist with moderate affinity which could be used to visualise the A₁-AR in primary tissue and cell lines.

Fluorescence Correlation Spectroscopy (FCS).

FCS is a non-invasive technique which measures fluctuations in fluorescence intensity in a confocal volume of <10⁻¹⁵ l. Statistical analysis of these fluctuations gives information about the speed of diffusion (i.e. mass) and concentration of the fluorescent molecules present. Thus free ligand (fast diffusing) and bound ligand (slow diffusing) can be quantified simultaneously on a single cell. We have used FCS to measure binding of the fluorescent ligand, xanthine amine cogener-BODIPY®630/650 (XAC-BY630) to the human adenosine A₁ receptor (A₁-AR).

CHO cells expressing either the human A₁-AR or an A₁-AR-Topaz fusion were cultured on glass-bottomed 8-well plates and prepared for live cell measurement FCS measurements were made using a Zeiss Confocor 2, fitted with an Axiocam CCD camera for x-y positioning. Cells were incubated with ligands at 22° C. for the times indicated and the confocal volume was positioned on the upper membrane. Data were collected for 2×30 s, following a 15 s pre-bleach and analysed using a multi-parameter equation using Zeiss AIM software.

Initially, the diffusion characteristics of the A₁-AR-Topaz fusion protein (A₁-AR-Tpz) were determined in CHO-A1Tpz cells. Autocorrelation analysis showed the diffusion time (τ_{D}) for the A₁-AR was 15.0±0.9 ms (mean±s.e.mean, n=84). A second component (τ_{D}=118±14 μs) was also seen, probably caused by an optical event within the fluorophore (“blinking”). FCS analysis of XAC-BY630 in buffer showed a single component diffusion (τ_{D}=60±2 μs, n=10). On the upper membrane of CHO-A1 cells incubated with XAC-BY630 (1-40 nM, 10-60 min, n=71), two further slow-diffusing species were detected in addition to free ligand. The first component had a similar diffusion time (τ_{D1}=17.4±1.1 ms; 69/71 cells) to that seen for A₁-AR-Tpz, suggesting that it is receptor-bound ligand. The second was a very slow difflusing component (τ_{D2}=345±41 ms, 61/71 cells). Following preincubation with 8-cyclopentyl-1,3-dipropyl xanthine (DPCPX) (1 μM, 30 min), t_{D2} was present in 30/31 cells, suggesting this component is non-specific binding. However, the t_{D1} component was present in only 17/31 cells. In addition, in cells exposed to 15 nM XAC-BY630 for 30 min the amount of τ_{D1} component was reduced from 51.8±14.9 to 13.6±5.4 receptors/μm² by DPCPX (n=8 and 4, respectively, Student's t-test, P<0.05), further suggesting this component is A₁-AR bound ligand.

We have used FCS to quantify binding to the A₁-AR and measure receptor diffusion in single live cells. Further development allows quantitative receptor-ligand binding of the endogenous A₁-AR in acutely dispersed cells.

These studies indicate that XAC-BY630 is a functional A₁-AR antagonist with moderate affinity which could be used to visualise and measure binding to the A₁-AR, in primary tissue and cell lines.

### Example B2

### Binding of NECA Based Fluorescent A₁ Receptor Agonists

2. BY630-ABEA (3)

Functional studies were performed in CHO-K1 cells expressing both the human A₁-AR and a c-fos-pGL3 reporter vector (CHO-A1fos cells). Cells were incubated for 24 h in serum-free DMEM/F-12 media, then stimulated with agonist for 5 h, in some cases following 30 min incubation with 8-cyclopentyl-1,3-dipropylxanthine (DPCPX). Luciferase expression was quantified using a Luclite® kit according to manufacturer's instructions. Live cell confocal imaging was carried out on CHO-A1 cells or CHO cells expressing the A₁-AR tagged on the C-terminus with a green fluorescent protein (CHO-A1Tpz).

In CHO-A1fos cells, both BY630-ABEA and the A₁-AR agonist N⁶-cyclopentyl adenosine (CPA) stimulated luciferase expression in a dose-dependent manner (pEC₅₀'s of 7.01±0.04 (n=6) and 6.76±0.18 (n=5) for CPA and BY630-ABEA, respectively, mean±s.e.mean). Stimulation was mediated by the A₁-AR receptor, since the concentration response curves were shifted to the right in a competitive manner by 10 nM DPCPX, yielding pK_{d} values of 8.72±0.03 and 9.05±0.10 vs. CPA and BY630-ABEA, respectively (n=3). A higher dose of DPCPX (100 nM), gave a pK_{d} of 8.62±0.02 for CPA stimulation, but completely blocked the response to BY630-ABEA (n=3). For receptor visualisation, CHO-A₁ cells were incubated with 100 nM BY630-ABEA for up to 60 min. Binding of ligand to the membrane was detectable after 5 min, and was substantial after 30 min (n=3). Binding was to the A₁-AR, since it was substantially reduced by preincubation with DPCPX (1 μM, 30 min). In addition, experiments in CHO-A1Tpz cells, showed co-localisation of ligand fluorescence at the membrane with that from the fluorescently tagged A₁-AR.

Results are shown in FIG. 1 which shows images taken from confocal microscopy imaging of a) fluorescence derived from ligand binding of a fluorescent ligand of the invention to CHO cells observed at the red channel, b) fluorescence derived from green fluorescent protein expressed by CHO cells indicating receptor locations observed via the green channel and c) overlaid images from a) and b) showing overlap of fluorescence and therefore confirming ligand binding is specific to receptors.

In conclusion, we have succeeded in synthesising a novel fluorescent agonist ligand for the human A₁-AR. This ligand will be useful in monitoring the localisation of the endogenous A₁-AR receptor in both acutely dispersed cells and cell lines.

C. Ligands Associated with Pharmacological Data

### Example C1

### Data Sheets for Library/Catalogue Compound Comprising Adenosine Based Fluorescent A₁-Receptor Antagonists

1. XAC-BY630 (1)

Characterisation: Fluorescent adenosine A₁-receptor antagonist.

Synthesis and analysis: see A₁ above.

Storage . . . .−20° C. (dark)

Spectral Properties:

Excitation Max 638 nm

Emission Max 655 nm

Fluorescence Lifetime 4.2 ns

Emission quantum yield 0.33

Pharmacology:

CHO-cells expressing human adenosine A₁-receptor:

Inhibition of ³H-DPCPX binding (membranes) pK_{B}=−6.82+0.11

Inhibition of ³H-DPCPX binding (whole cells) pK_{B}=−6.9

Antagonism of NECA-stimulated cAMP accumulation pK_{I}=−6.98+0.15

Antagonism of NECA-stimulated inositol phosphate accumulation pK_{I}=−6.26+0.20

Imaging:

Picture of XAC-BY630/650 binding to CHO-A1 cells and CHO-A1-GFP cells

Also pictures showing displacement of binding by non-fluorescent antagonist DPCPX.

### Example D

### Library with Different Fluorescently Tagged Ligands

D1 A library is assembled comprising 3 fluorescent ligands each ligand comprising ABIPEA fluorescently tagged with a fluorophore providing different fluorescence characteristics selected from BODIPY 630/650-X-SE, EvoBlue 30 SE, BODIPY FL ethylene diamine etc.

Fluorescently tagged ligands are obtained by the process of the invention as hereinbefore defined.

The library includes data sheets (C. above) for each ligand.

D2 An alternative library is assembled comprising 2 fluorescent ligands comprising adenosine and ABIPEA as herein before referred, each were divided into 3 samples and modified by incorporation of a linker of varying carbon chain length from C₃₋₆, whereby the compounds of formula IV comprised J_{L} is amine, L is (CH₂)₃₋₆ and Y_{L} is amine. The compounds were reacted with fluorophore providing different fluorescence characteristics selected from EvoBlue 30 SE and BODIPY 630/650 X-SE.

Fluorescently tagged ligands are obtained by the process of the invention as hereinbefore defined.

The library includes data sheets (C. above) for each ligand.

D3 An alternative library is assembled comprising 3 tagged ligands each ligand comprising. ABIPEA tagged with a selection of tags as known in the art, including one tagged with a fluorophore.

The library includes data sheets (C. above) for each ligand.

The libraries are useful for conducting binding studies as known in the art for a desired fluorescent ligand having the desired fluorophore or for a selection of fluorescent ligands or for a selection of ligands one of which comprises a desired fluorophore.

A library was then selected for screening for binding at a desired receptor and a fluorescent ligand was selected which gave optimum pharmacology for the desired receptor. Choice of the library to be screened is facilitated by the rational design of the library which provides the required analogues to generate a positive selection.

1. Library comprising a plurality of tagged ligands of formula I
(LigJ_{L})ₘL(J_{T}Tag)ₘ(J_{T}L(J_{L}Lig)ₘ)ₚ
and salts thereof wherein any optically active fluorescent ligand is present as a racemate or as one of its optically active isomers
comprising one or a plurality of same or different ligand moieties Lig each linked to one or a plurality of same or different tag moieties Tag via same or different linker moieties L and same or different linking site or linking functionality J_{T} and J_{L}
wherein Lig comprises a GPCR ligand, an inhibitor of an intracellular enzyme or a substrate or inhibitor of a drug transporter;
L is selected from a double bond, —O—, —S—, amine, COO—, amide, —NN-hydrazine; and saturated or unsaturated, substituted or unsubstituted C₁₋₆₀₀ branched or straight chain aliphatic, aromatic, alicyclic and combinations thereof, any of which may comprise one or more heteroatoms selected from N, O, S, P, wherein optional substituents are selected from any C₁₋₂₀ aliphatic, aromatic or alicyclic substituents any of which may comprise one or more heteroatoms as hereinbefore defined, hydroxy, thiol, halo, amine, hydrazine, oxo, cyano and carbonyl and combinations thereof, and L may be monomeric, oligomeric having oligomeric repeat of 2 to 30 or polymeric having polymeric repeat in excess of 30 up to 300;
Tag is any tagging substrate;
m are each independently selected from a whole number integer from 1 to 3;
p is 0 to 3
wherein one or more of each -Tag in one or more or each library compound is a fluorophore entity -Fl, whereby the library comprises compounds of which one or more or all of which are of formula I′
(LigJ_{L})ₘL(J_{T}Fl)ₘ(J_{T}L(J_{L}Lig)ₘ)ₚ
characterised in that linking is at same or different linking sites in compounds comprising different Lig, J_{L}, L J_{T} and/or -Tag and is at different linking sites in compounds comprising same Lig, J_{L}, L J_{T} and/or -Tag
with the proviso that when Lig is CGP12177 and L is 1,1,4,4-tetramethyl butylamine C(CH₃)₂(CH₂)₂C(CH₃)₂NH—, Fl is not BODIPY® FL, or when L is C(CH₃)₂(CH₂)₂—C(CH₃)₂NHCSNH— then Fl is not FITC, eosin or erythrosin.

2. Library comprising a plurality of tagged ligands of formula I
(Lig J_{L})ₘL(J_{T}Tag)ₘ(J_{T}L(J_{L}Lig)ₘ)ₚ
and salts thereof wherein any optically active fluorescent ligand is present as a racemate or as one of its optically active isomers
comprising one or a plurality of same or different ligand moieties Lig each linked to one or a plurality of same or different tag moieties Tag via same or different linker moieties L and same or different linking site or linking functionality J_{T} and J_{L}
wherein Lig comprises a GPCR ligand, an inhibitor of an intracellular enzyme or a substrate or inhibitor of a drug transporter;
L is selected from a double bond, —O—, —S—, amine, COO—, amide, —NN-hydrazine; and saturated or unsaturated, substituted or unsubstituted C₁₋₆₀₀ branched or straight chain aliphatic, aromatic, alicyclic and combinations thereof, any of which may comprise one or more heteroatoms selected from N, O, S, P, wherein optional substituents are selected from any C₁₋₂₀ aliphatic, aromatic or alicyclic substituents any of which may comprise one or more heteroatoms as hereinbefore defined, hydroxy, thiol, halo, amine, hydrazine, oxo, cyano and carbonyl and combinations thereof, and L may be monomeric, oligomeric having oligomeric repeat of 2 to 30 or polymeric having polymeric repeat in excess of 30 up to 300;
Tag is any tagging substrate;
m are each independently selected from a whole number integer from 1 to 3;
p is 0 to 3
wherein one or more of each -Tag in one or more or each library compound is a fluorophore entity -Fl, whereby the library comprises compounds of which one or more or all of which are of formula I′
(LigJ_{L})ₘL(J_{T}Fl)ₘ(J_{T}L(J_{L}Lig)ₘ)ₚ
wherein linking is at same or different linking sites in compounds comprising different Lig, J_{L}, L J_{T} and/or -Tag and is at different linking sites in compounds comprising same Lig, J_{L}, L J_{T} and/or -Tag
with the proviso that when Lig is CGP12177 and L is 1,1,4,4-tetramethyl butylamine C(CH₃)₂(CH₂)₂C(CH₃)₂NH—, Fl is not BODIPY® FL, or when L is C(CH₃)₂(CH₂)₂—C(CH₃)₂NHCSNH— then Fl is not FITC, eosin or erythrosin
characterised in that the or each Fl is selected from a red, near ir or blue absorbing dye or from BODIPY® 630/650 or BODIPY®& 630/650 X.

3. Library as claimed in claim 1 wherein each compound of formula I or I′ comprises one of a plurality of fluorophores and/or tags providing a library of differently fluorescently tagged ligands comprising one or a number of different fluorophores optionally of different chemical composition or spectral characteristics; and/or providing a library of differently tagged ligands including at least one fluorescently tagged ligand; alternatively each compound of formula I or I′ comprises one of a plurality of precursor ligands linked each to one or a plurality of different tags providing a library of same or differently tagged ligands of plural ligand type; alternatively each compound of formula I comprises one of a plurality of linkers linking a precursor ligand and at least one Tag at the same or different linking site; alternatively each compound of formula I comprises the same linker linking a precursor ligand and at least one Tag at different linking sites providing a library of differently linked tagged ligands of different conformation or anticipated pharmacology and binding.

4. Library as claimed in claim 1 comprising a plurality of compounds of one or more of formula II to III:
(LigJ_{L})ₘLJ_{T}TagJ_{T}L(J_{L}Lig)ₘ II
where each m is as hereinbefore defined and is preferably 1 or 2, more preferably 1
(LigJ_{L})ₘL(J_{T}Tag)ₘ III
wherein each m is as hereinbefore defined and is preferably 1 and/or 2, more preferably 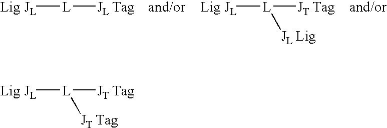
wherein each J_{L} and J_{T} comprises J as hereinbefore defined and may be same or different and may derive from functionality originally present in Lig or L and Tag or L or a combination thereof, characterised in that linking is at same or different linking sites in compounds comprising different Lig, J_{L}, J_{T} and/or Tag, and is at different linking sites in the case of any two or more compounds comprising identical Lig, J_{L}, L, J_{T} and/or Tag.

5. Library as claimed in claim 1 including information for each compound of formula I comprised in the Library, relating to the pharmacology for binding to or inhibition of a GPCR receptor or to inhibition of an intracellular cyclic nucleotide phosphodiesterase, or inhibition of or transport by a drug transporter including designation as agonist, antagonist, substrate or inhibitor and measure of affinity or inhibition, enabling quantification of results.

6. Library as claimed in claim 1 wherein a GPCR ligand is selected from any compound which is effective as an agonist or antagonist for an adenosine receptor, a beta-adrenoceptor, a muscarinic receptor, a histamine receptor, an opiate receptor, a cannabinoid receptor, a chemokine receptor, an alpha-adrenoceptor, a GABA receptor, a prostanoid receptor, a 5-HT (serotonin) receptor, an excitatory aminoacid receptor (glutamate), a dopamine receptor, a protease-activating receptor, a neurokinin receptor, an angiotensin receptor, an oxytocin receptor, a leukotriene receptor, a nucleotide receptor (purines and pyrimidines), a calcium-sensing receptor, a thyroid-stimulating hormone receptor, a neurotensin receptor, a vasopressin receptor, an olfactory receptor, a nucleobase receptor (adenosine), a lysophosphatidic acid receptor, a sphingolipid receptor, a tyramine receptor (trace amines), a free-fatty acid receptor and a cyclic nucleotide receptor; an inhibitor of intracellular enzymes is an inhibitor of cyclic nucleotide phosphodiesterases; and a substrate or inhibitor of a drug transporter is selected from a substrate or inhibitor of an equilibrium based drug transporter or ATP driven pump selected from a catecholamine transporter, a nucleoside transporter, an ATP-binding cassette transporter, a cyclic nucleotide transporter or derivatives or analogues thereof;
or wherein Lig is selected from
a) xanthine like structures including XAC, theophylline, caffeine, theobromine, dyphilline, enprofylline; or fused biaryl structures including papaverine, dihydroquinilones, cilostamide, dipyridamole or vinpocetine; and analogues thereof;
b) adenosine like structures including ADAC, NECA and analogues thereof;
c) ethanolamine like structures including salmeterol, salbutamol, terbutaline, quinprenaline, labetalol, sotalol, bambuterol, fenoterol, reprotolol, tulobuterol, clenbuterol and analogues thereof;
d) oxypropanolamine like structures including CGP12177, propranolol, practolol, acebutalol, betaxolol, ICI 118551, alprenolol, celiprolol (celectol), metoprolol (betaloc), CGP20712A, atenolol, bisoprolol, misaprolol, carvedilol, bucindolol, esmolol, nadolol, nebivolol, oxprenolol, xamoterol, pindolol, timolol and analogues thereof;
e) xanthine like structures including XAC, theophylline, caffeine, theobromine, dyphilline, enprofylline, sildenafil, EHNA (erythro-9-(2-hydroxyl-3-nonyl)adenine), zaprinast; or spiro bicyclic structures including bypyridines, amrinone; imidazolines, CI930; dihydropyridazinones, indolan, rolipram, SB207499; or fused biaryl structures including papaverine, dihydroquinilones, cilostamide, dipyridamole, vinpocetine and analogues thereof.

7. Library as claimed in claim 1 wherein J_{Lm} L J_{Tm} comprises a mono, di, tri, tetra, penta, or hexa amino, alkylthio, alkoxy, carboxylic acid, and combinations thereof including a mono, di or tri aminoalkylthio, amino alkoxy, alkoxy carboxylic acid or alkoxy amine, mono, di or tri amino menthane, amino ethane, thio ethane, ethane, amino acyl, polypeptide, or mono or polyether derivatives including diamine or dithio derivatives, mono or polyethylene glycol di or tri amine or thio;
or comprises a mono-, di-, tri- or tetra, penta or hexafunctional linear or branched or cyclic substituted or unsubstituted hydrocarbyl of formula -L.I—
J[A]q_{L}R_{L}[A′q_{L′}J′]ₚA″q_{L″}J″
wherein each of J to J″ is a linking site or functionality as hereinbefore defined independently selected from a single or double bond, methylene, alkyne, alkene, NR, O, CONR, NRCO, S, CO, NCO, CHHal and P wherein R is H or C₁₋₈ alkyl or cycloalkyl or forms part of a cyclic ring with N, Hal is any halogen selected from chlorine, iodine, bromine; and is present in any rational location in a group A to A″; each of A to A″ is a group selected from —O—, —C(═O)—, C₁₋₁₂ alkoxy, alkoyl, cycloalkyl, heterocyclic, alkyl, alkenyl, aryl, arylamide, arylamine, amino, thioalkyl, heteroaryl as hereinbefore defined and combinations thereof, optionally substituted by groups selected independently from C₁₋₃ alkyl and C₁₋₅ alkoxy;
each of q_{L} to q_{L}″ are independently-selected from 0 or 1 or indicates an oligomeric repeat and is from 2 to 30, or indicates a polymeric repeat unit and is from 31 up to 300.
R_{L} is a C, N or S atom or is a CR_{L′}, NR_{L′}, alkyl, cycloalkyl, heterocyclic, aryl heteroaryl, amine or thio moiety and provides for branching when p is 1 or 2; wherein R_{L′} is H or C₁₋₃ alkyl; and
p is as hereinbefore defined and is 0, 1 or 2.

8. Library as claimed in claim 1 wherein J_{Lm} L J_{Tm} is of formula
JAq_{L}R_{L}J″
wherein each of J and J″ is amine or —O—, A is CH₂CH₂O, q_{L} is 1-30 or 31 to 300 and R_{L} is CH₂CH₂
or of formula
JAq_{L}R_{L}(A′J′)J″
wherein each of J, J′ and J″ independently is amine, —O or a single bond, q_{L} is 1, 2 or 3-30 or 31 to 300 and A is CH₂CH₂O or HNCH₂CO or q_{L} is 1 and A is C(O) or (CH₂)₁₋₈ or q_{L} is 0, R_{L} is CH or CH₂CH, q_{L′} is 0 or q_{L}′ is 1 and A′ is CH₂ and q_{L″} is 0 preferably
O(CH₂CH₂O)q_{L}CH₂CH₂NH, O(CH₂CH₂O)q_{L}CH₂CH(CH₂NH)NH,
OCH(CH₂NH)NH, —CH(CH₂NH)NH, —C(O)NH—, —(CH₂)₁₋₈— or (—HNCH₂CO—)₁₋₃ (=-gly-₁₋₃-)-.

9. Library as claimed in claim 1 wherein each compound of formula I or I′ comprises a moiety Lig and L as hereinbelow defined:
Wherein:
any optically active fluorescent ligand is present as a racemate or as one of its optically active isomers
Lig.aₘ is suitably of the formula, in either of the following forms given, including any of its possible linking configurations or sites: 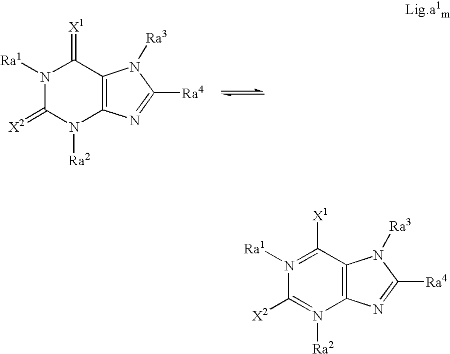
Lig.a¹ₘ
Wherein at least one or all of Ra¹ to Ra⁴, X¹ and X² comprise a linking site or functionality J as hereinbefore defined
X¹ and X² are each independently selected from H, O, OR.a, NR.a, NHR.a;
X¹ and X² are each preferably O;
each of R.a¹, R.a², R.a³ and R.a⁴ independently is selected from H or C₁₋₄ linear or branched alkyl optionally mono or multi hydroxy or halo substituted;
R.a⁴ is selected from a heteroatom O, S or substituted or unsubstituted amine or saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo and cyano; including optionally substituted aryl, cycloalkyl, alkyl, ketone, (di)amine, (di)amide, alkoxy, cycloalkyl, carboxylic acid or optionally o-, m- or p-substituted phenyl wherein substituents include aryl, alkyl, cycloalkyl, heteroaryl or heteroalkyl, amine, amide, carboxyl, carbonyl or R.a⁴ comprises cyclohexyl, cyclopentyl, ethoxy, (CH₂)₂PhPh, CH₂Ph, CONH(CH₂)nCONH, CH₂CONH(CH₂)₂NH, CH₂PhNHCOCH₂, CH₂CH₂OCOCH₂, succinimidyl ester, NHCOCH₂, CH₂(CH₃)NCOCH₂, H₂N(CH₂)₂NHCOCH₂, H₂N(CH₂)₈NHCOCH₂, H₂NNHCOCH₂, CH₂CONH(CH₂)₂NHCOCH₂, HOPhCH₂N(CH₂CH₃.HOAc)(CH₂)₂NHCOCH₂, heterocyclic-(CH₂)₄CONH(CH₂)₂NHCOCH₂ or heterocyclic-NHCON(heterocyclic)COCH₂;
or Lig.a is of the formula Lig.a²- 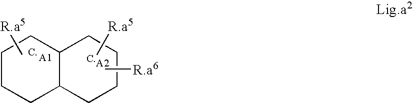
wherein at least one or all of Ra⁵ to Ra⁶, or a cyclic C or heteroatom comprise a linking site or functionality J as hereinbefore defined, each of C._{A1} and C._{A2} is independently selected from C₅₋₆ aryl, heteroaryl, cycloalkyl and heterocyclic, more preferably from phenyl, or aryl containing 1 or 2 ring heteroatoms, or heterocyclic containing 1 ring heteroatom and/or 1 ring —C═C— group;
Each of up to seven R.a⁵ is a substituent of a ring carbon or a ring heteroatom and:
is independently selected from H, halo, hydroxy, thiol, amine, COOH, hydrazine, cyano, saturated or unsaturated, substituted or unsubstituted C₁₋₂₀ branched or straight chain aliphatic, aromatic, alicyclic and combinations thereof, any of which may comprise one or more heteroatoms selected from N, O, S, P, and wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo ═O or cyano; OCH₃, CH₂Ph(OCH₃)₂, O(CH₂)₃CON(CH₃)c.hex, N(CH₂CH₂OH)₂, c.hex, COOCH₂CH₃, CH₂CH₃;
or any two or more of R.a⁵ form a one, two or three ring fused cyclic structure, a fused 3 ring aryl, 5-heterocyclic or 6-heterocyclic structure having 4 ring atoms common with the fused bicyclic Lig.a²structure;
and R.a⁶ is a moiety as defined for R.a⁵ above;
and L.a is as hereinbefore defined for L or J_{L} L J_{T} or L.I or subformulae as hereinbefore defined, or is a single bond, amino acid or amide including a peptide or polypeptide gly or gly₃, alkyl of formula —(CH₂)ₙ where n is 3 to 8, optionally including one or more heteroatoms or unsaturated groups, including —O— or —S— or —CH═CH—:
Lig.b is suitably of the formula Lig.b including any of its possible linking configurations or sites:
Lig.b 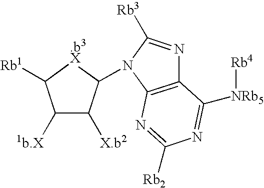
wherein at least one or all of Rb¹ to Rb⁵ or Xb¹ to Xb³ comprise a linking site or functionality J as hereinbefore defined
ring substituents X.b¹ and X.b² are independently selected from hydrocarbon including alkyl or SR_{X}, NR_{X.2} and OR_{X} wherein (each) R_{X} is selected from H, C₁₋₅alkyl, alkenyl;
ring heteroatom X.b³ is selected from —S—, —O— and —CH₂—;
Rb¹ is selected from saturated or unsaturated, substituted or unsubstituted C₁₋₄ aliphatic, or C₁₋₃ alicyclic optionally including one or more heteroatoms N, O, S, P, wherein substituent(s) are selected from one or more cycloalkyl, heterocyclic, hydroxy, oxo, halo, amine; or R.b¹ comprises a carbonyl substituted by H, alkyl or a linear or cyclic primary, secondary or tertiary amine, substituted C₁₋₃ alkyl, cycloalkyl or amide, cyclopropyl, or CONHC₁₋₃alkyl including CONHEt or CH₂OH
and each of R.b² and R.b³ is selected from H, halo, hydroxy, thiol, amine, COOH, CHO, hydrazine, cyano or saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo or cyano, preferably from H, halo or hydroxy;
Rb⁴ is H;
Rb⁵ is H or alkyl
L.b comprises a linking site or functionality J as hereinbefore defined; and is as hereinbefore defined for L or its subformulae, more preferably is saturated and unsaturated substituted or unsubstituted C₁₋₁₂ aliphatic or C₁₋₂₄ aromatic as defined for L optionally including one or more heteroatoms O, S or N, cyclic or heterocyclic groups, or is of formula L.I or its subformulae as hereinbefore defined, or is (CH₂)m wherein m is 2 to 12, or is (Ph—CH₂CONH)₂ (CH₂)₂;
Lig.c is of the formula Lig.c including any of its possible linking configurations or sites:
Lig.c 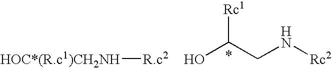
where at least one or all of Rc¹ to Rc² or OH, or a chain C or N comprise a linking site or functionality J as hereinbefore defined
* indicates an optically active centre and
wherein R.c¹ is C₆₋₁₄ aryl optionally including one or more heteroatoms selected from H, O, optionally substituted by OH, Hal, NH₂, NHC₁₋₃alkyl, sulphonamide, oxoamine or (—CONH₂), or is mono, di or tri substituted phenyl or quinoline wherein substituents include OH, Cl or NH₂, or is m-CH₂OH, p-OH phenyl, m-,p-dihydroxy phenol or m-,m-dihydroxyphenol, m-,m-diCl, p-NH₂ phenol, p-OH, m-CONH₂ phenol or 5-OH, 8-quinoline, 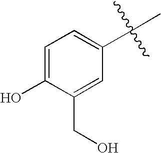
R.c² is selected from saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any optionally substituted C₁₋₁₂ aliphatic, aromatic or alicyclic substituents any of which may comprise one or more heteroatoms as hereinbefore defined, hydroxy, thiol, halo, amine, hydrazine, oxo or cyano and combinations thereof; or R.c² is selected from C₁₋₆ branched or straight chain aliphatic, C₆₋₁₀ araliphatic optionally substituted by OH and optionally including heteroatoms selected from N,O, optionally including an ether O, and is selected from —(CH₂)₆OCH((CH₂)₃Ph), CHCH₃(CH₂)₂Ph, CHCH₃CH₂PhOH, C(CH₃)₂CH₂Ph or from the structures: 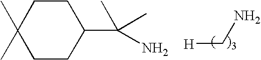
L.c is present as R.c² or comprises a linking site or functionality J as hereinbefore defined, and is as hereinbefore defined for L, formula L.I or its subformulae as hereinbefore defined, or is selected from C₁₋₁₂ alkyl, amide;
Lig.d is of the formula Lig.d including any of its possible linking configurations or sites:
Lig.d R.d¹OCH₂C*HOHCH₂NH—R.d² 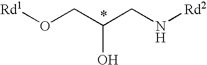
where at least one or all of Rd¹ to Rd² or OH, a chain C or N comprise a linking site or functionality J as hereinbefore defined
* indicates an optically active centre
wherein R.d¹ is saturated or unsaturated, substituted or unsubstituted C₁₋₂₀ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo or cyano; or R.d¹ is substituted or unsubstituted C₁₋₂₄ aralkyl or heteroaralkyl, including single ring and fused ring systems with (hetero)aryl or cycloalkyl rings, wherein optional substituents include C₁₋₆ alkyl, alkoxy, ether, carbonyl, alkenyl, amine, amide each optionally carbonyl, amide, halo or OH substituted, or halo or OH, amine, amide, carbonyl, ketone, ether substituted phenyl or naphthyl, mono-, di-, tri- or tetra substituted mono or polycyclic fused aryl or cycloaryl or heterocycloaryl including phenyl, carbazole or structures shown below or spiro ring systems, mono-, di-, tri- or tetra alkoxyalkyl, alkoxyalkoxyalkyl or CF₃ substituted phenyl or unsubstituted or monosubstituted naphthalene or 5,6 ring systems: 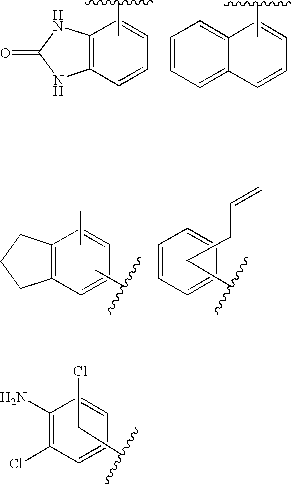
R.d² is substituted or unsubstituted amine, saturated or unsaturated, substituted or unsubstituted C₁₋₂ branched or straight chain aliphatic, aromatic, alicyclic and combinations thereof, any of which may comprise one or more heteroatoms selected from N, O, S, P; wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo or cyano, more preferably amine, C₁₋₆ branched or straight chain alkyl optionally including ether O, and optionally substituted by C₆₋₁₀ aryl, or of the formula: 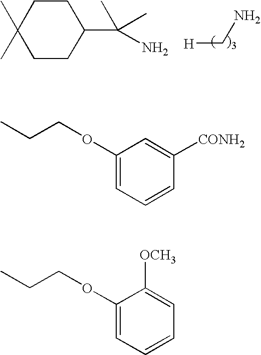
L.d may be present as R.d² or may comprise a linking site or functionality J as hereinbefore defined and is as hereinbefore defined for L and its subformulae, formula L.I and its subformulae as hereinbefore defined, or is a single bond or is as hereinbefore defined for L.a;
Lig.e comprises a cell permeant moiety or is associated with a cell permeant L or Fl moiety or is of the formula, in either of the following forms given including any of its possible linking configurations or sites: 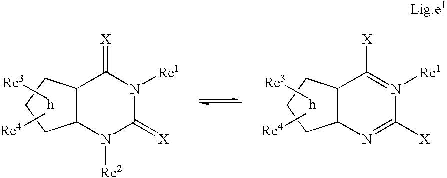
wherein at least one or all of Re¹ to Re⁴, X and a ring C or N comprise a linking site or functionality J as hereinbefore defined
h is selected from 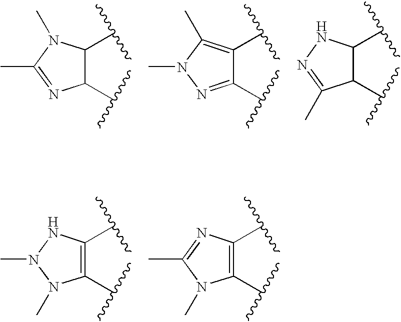
each optionally substituted by R.e³-R.e⁴ wherein R.e¹-R.e⁴ are as R.a¹-R.a⁴ defined above or in which R.e³ is C₅₋₉ linear or branched alkyl, optionally mono or multi hydroxy or halo substituted or is aryl optionally substituted by alkoxy or sulfonyl, 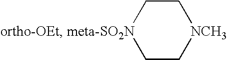
each X is independently selected from H, O, —OR.e², N, HN, NR.e⁵, HR.e⁶, and aryl optionally substituted by ether; or X is aryl optionally alkyl or alkoxy substituted or is Ph-ortho-OCH₂CH₂CH₃;
and where R.e⁵ is as defined above for R.e¹ above or forms a fused cyclic ring together with the adjacent ring N atom, or 1 or 2 fused 5 membered cyclic rings;
and R.e⁶ is as defined above for R.e¹ above or is selected from optionally substituted phenyl wherein optional substituents include ether, o-ethoxy or o-propoxy, alkyl or OH, sulphonyl or carbonyl substituted by heterocyclic, or cyclic C₅₋₈ alkyl, piperazinyl or sulphonyl;
or Lig.e is of the formula Lig.e² 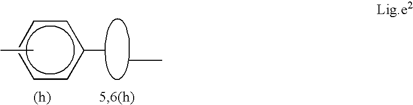
wherein at least one or all free ring atom or their substituents comprise a linking site or functionality J as hereinbefore defined
each spiro ring optionally comprises zero or one or more heteroatoms h or (h) 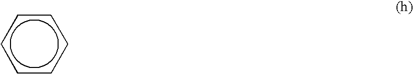
comprises zero or 1 N heteroatom and 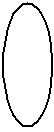
5,6(h) comprises zero, 1 or 2 N heteroatoms and is unsaturated or comprises one or two —C═C— or —C═N— groups;
and wherein each ring is optionally substituted by one or more oxo, CO, COOH, C₁₋₆ alkyl or linear or cyclic alkoxy optionally substituted by one or more oxo, CO, COOH, CN, or C₁₋₆ alicyclic or amine groups, amine or one or more spiro or fused heterocycles;
or Lig.e is of the formula Lig.e³ 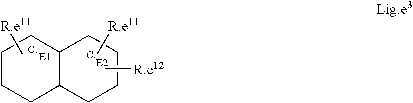
wherein at least one or all of Re¹¹ to Re¹², or a ring C or heteroatom or ring substituent comprise a linking site or functionality J as hereinbefore defined
each of C._{E1} and C._{E2} is independently selected from C₅₋₆ aryl, heteroaryl, cycloalkyl and heterocyclic, including phenyl, or aryl containing 1 or 2 ring heteroatoms, or heterocyclic containing 1 ring heteroatom and/or 1 ring —C═C— group;
each of up to seven R.e¹¹ is a substituent of a ring carbon or a ring heteroatom and:
is independently selected from saturated or unsaturated, substituted or unsubstituted C₁₋₂₀ branched or straight chain aliphatic, aromatic, alicyclic and combinations thereof, any of which may comprise one or more heteroatoms selected from N, O, S, P, and wherein optional substituents are selected from any C₁₋₁₂ aliphatic, aromatic or alicyclic substituents any of which may comprise one or more heteroatoms as hereinbefore defined, hydroxy, thiol, halo, amine, hydrazine, oxo ═O, or cyano, OCH₃, CH₂Ph(OCH₃)₂, O(CH₂)₃CON(CH₃)c.hex, N(CH₂CH₂OH)₂, c.hex, COOCH₂CH₃, CH₂CH₃;
or any two or more of R.e¹¹ form a one, two or three ring fused cyclic structure, a fused 3 ring aryl, 5-heterocyclic or 6-heterocyclic structure having 4 ring atoms common with the fused bicyclic Lig.e³ structure;
and R.e¹² is a moiety as defined for R.e¹¹ above;
L.e comprises a linking site or functionality J as hereinbefore defined and is suitably as hereinbefore defined for L.a.

10. Library as hereinbefore defined in any of claim 1 wherein Fl is selected from dyes in particular including fluorescein, fluorescein derivatives including FITC, and fluorescein-like molecules including Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dynamics (DY dyes and ATTO dyes) and fluorescent derivatives thereof, the Alexafluor dyes and derivatives, BDI dyes including the commercially available Bodipy™ dyes, erythosin, eosin, pyrenes, anthracenes, acridines, fluorescent phycobiliproteins and their conjugates and fluoresceinated microbeads, Rhodamine and fluorescent derivatives thereof including Rhodamine Green™ including the tetramethylrhodamines, X-rhodamines and Texas Red derivatives, and Rhodol Green™, coupled to amine groups using the isocyanate, succinimidyl ester or dichlorotriazinyl-reactive groups.

11. Library as claimed in claim 10 wherein Fl is of formula J_{T}-t-Fl and comprises a BODIPY™ structure characterised by a dipyrrometheneboron difluoride core, optionally modified by one or two fused rings, optionally substituted by one or several substituents selected from alkyl, alkoxy, aryl or heterocyclic, wherein one substituent -t- is adapted for linking as hereinbefore defined to a ligand precursor as hereinbefore defined, wherein the substituent -t- comprises a proximal unsaturated or aryl moiety, comprising a medial short, medium or long chain alkynyl or cycloalkyl moiety and comprising a moiety derived from linking via a reactive group as hereinbefore defined or selected from carboxyl, sulphonate or as a heteroatom O or S or methylene derived from linking at an alkylhalide including methylbromide, haloacetamide or sulphonate ester electrophilic group.

12. Library as claimed in claim 1 comprising a plurality of compounds of the formula
LigJ_{L}LJ_{T}Fl
wherein any optically active fluorescent ligand is present as a racemate or as one of its optically active isomers
wherein Fl is selected from dyes in particular including fluorescein, fluorescein derivatives including FITC, and fluorescein-like molecules including Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dyomics (DY dyes and ATTO dyes) and fluorescent derivatives thereof, the Alexafluor dyes and derivatives, BDI dyes including the commercially available Bodipy™ dyes, erythosin, eosin, pyrenes, anthracenes, acridines, fluorescent phycobiliproteins and their conjugates and fluoresceinated microbeads, Rhodamine and fluorescent derivatives thereof including Rhodamine Green™ including the tetramethylrhodamines, X-rhodamines and Texas Red derivatives, and Rhodol Green™, coupled to amine groups using the isocyanate, succinimidyl ester or dichlorotriazinyl-reactive groups,
and
wherein Lig J_{L} L J_{T} is selected from:
xanthine like structures
adenosine like structures;
ethanolamine like structures; and
oxypropanolamine like structures; wherein
linking functionality J_{T} is amine; and
wherein linker L is selected from branched and straight chain C₁₋₅₀ alkyl, C₆₋₅₀ cycloalkyl or aryl and combinations thereof optionally comprising one or more heteroatoms O and optionally substituted by C₁₋₁₂ aliphatic, or for xanthine like structures L is also selected from a single bond.

13. Process for the preparation of a library as claimed in of claim 1 which is a combinatorial process; and comprises the reaction of one or more ligand precursors of formula IV and/or IV′
(LigJ_{L})ₘ-L-Y_{Lm} IV
LigY_{Ligm} IV′
comprising one or more or different reactive groups Y_{L} or Y_{Lig} forming a linking functionality J, J_{L} or J_{T} as hereinbefore defined
with one or more of a plurality of analytical tagging substrates of formula V and/or V′
Y_{Tm}Tag V
Y_{Tm}L(J_{T}Tag)ₘ V′
comprising one or more or different reactive groups Y_{T} forming a linking functionality J or J_{T} as hereinbefore defined
and optionally one or more linking species VI or VI′ or VI″
Y_{Lm}LY_{Lm} VI
wherein Lig, J, L, J_{T} and Tag and each m is independently as hereinbefore defined wherein the or each compound of formula IV or IV′ is capable of reaction with the or each compound of formula V or V′, optionally via the or each species VI or VI′ or VI″ to form a plurality of compounds of formula I as hereinbefore defined;
wherein linking is at same or different reactive sites in different compounds as hereinbefore defined.

14. Process for the preparation of a compound of formula I as hereinbefore defined in claim 1 comprising the reaction of a compound of formula IV or IV′ and a compound of formula V or V′ and optionally additionally VI, as hereinbefore defined, by reacting the unprotected primary alkyl amine group of a compound of formula IV with a compound of formula V comprising a reactive succinimidyl ester group in solvent at ambient temperature without the need for subsequent deprotection.

15. Process for the preparation of a compound of formula IV as hereinbefore defined in claim 13 comprising: obtaining where commercially available or preparing the ligand precursor Lig, by routes as known in the art, and reacting with linker precursor VI″, if required, or components thereof, and/or generating one or more reactive sites Y or Y_{Lig} or Y_{L}, by a method selected from:
a), e) ring closure of 5,6-diamino-1,3-dialkyl uracil with the appropriate substituted aldehyde under acid conditions with ferric chloride,
b) reacting Lig.b- comprising a protected inosine derivative with chlorinating agent and linking the chloro derivative with the amine group of a suitably protected amine reactive linker H-L-P_{L} wherein P_{L} comprises N-benzyloxycarbonyl- to form Lig.b-L-P_{L} and removing P_{L} to generate Lig.b-L.b; preferably R.b¹ comprises a OH terminating group and protected inosine comprises Acyl protecting groups or R.b¹ comprises a stable group such as amine or amide and protected inosine comprises 2,2-dimethoxypropane protecting group; preferably the protected inosine is reacted with oxidising agent and protected alkylamine which is an N-alkylcarboxamide with removal of amine protecting group to generate a reactive ligand;
c), d) reacting p-hydroxybenzaldehyde with formaldehyde under acid catalysis and protection of the resulting 4-hydroxy-3-hydroxymethylbenzaldehyde with dimethoxypropane to generate the resulting acetonide, converting the Benzaldehyde to its corresponding epoxide and ring opening with a suitably protected linker such as Boc-L.c-H supplies Ligₘ-L-P_{L}, finally, deprotection under acid conditions supplies Lig.cLc or Lig.dLd for coupling to an appropriate tag.

16. Method for selecting a compound of formula I from a library as claimed in claim 1 comprising the rational design of a library of compounds of formula I as hereinbefore defined using the process for the preparation of a library as claimed in claim 1 which is a combinatorial process; and comprises the reaction of one or more ligand precursors of formula IV and/or IV′
(LigJ_{L})ₘ-L-Y_{Lm} IV
LigY_{Ligm} IV′
comprising one or more or different reactive groups Y_{L} or Y_{Lig} forming a linking functionality J, J_{L} or J_{T} as hereinbefore defined
with one or more of a plurality of analytical tagging substrates of formula V and/or V′
Y_{Tm}Tag V
Y_{Tm}L(J_{T}Tag)ₘ V′
comprising one or more or different reactive groups Y_{T} forming a linking functionality J or J_{T} as hereinbefore defined
and optionally one or more linking species VI or VI′ or VI″
Y_{Lm}LY_{Lm} VI
wherein Lig, J, L, J_{T} and Tag and each m is independently as hereinbefore defined wherein the or each compound of formula IV or IV′ is capable of reaction with the or each compound of formula V or V′, optionally via the or each species VI or VI′ or VI″ to form a plurality of compounds of formula I as hereinbefore defined;
wherein linking is at same or different reactive sites in different compounds as hereinbefore defined, determining pharmacology for a plurality of or all compounds in the library and selecting a compound exhibiting desired pharmacology.

17. Method as claimed in claim 16 which comprises preparing a preliminary library of compounds, conducting screens to assess binding or inhibition, selecting a compound identified in the screen as having beneficial properties, and modifying or functionalising by nature of moieties or linking location of linking on the basis of the indications from the screen to prepare an optimised library, wherein the molecular pharmacology and photochemistry from the screen feedback into the design of the library.

18. A compound of formula I
(LigJ_{L})ₘL(J_{T}Tag)ₘ(J_{T}L(J_{L}Lig)ₘ)ₚ
or salt thereof as hereinbefore defined in claim 1 wherein JLₘ L T_{Tm} is of formula
JAq_{L}R_{L}J″
wherein each of J and J″ is amine or —O—; A is CH₂CH₂O, q_{L} is 1-30 or 31 to 300 and R_{L} is CH₂CH₂
or of formula
JAq_{L}R_{L}(A′J′)J″
wherein each of J, J′ and J″ independently is amine, —O or a single bond, q_{L} is 1, 2 or 3-30 or 31 to 300 and A is CH₂CH₂O or HNCH₂CO or q_{L} is 1 and A is C(O) or (CH₂)₁₋₈ or q_{L} is 0, R_{L} is CH or CH₂CH, q_{L′} is 0 or q_{L}′ is 1 and A′ is CH₂ q_{L″} is 0 preferably
O(CH₂CH₂O)q_{L}CH₂CH₂NH, O(CH₂CH₂O)q_{L}CH₂CH(CH₂NH)NH,
OCH(CH₂NH)NH, —CH(CH₂NH)NH, —C(O)NH—, —(CH₂)₁₋₈— or (—HNCH₂CO—)₁₋₃ (=-gly₁₋₃-)- and wherein any optically active fluorescent ligand is present as a racemate or as one of its optically active isomers.

19. A compound of formula II or III as hereinbefore defined in claim 4
(LigJ_{L})ₘLJ_{T}TagJ_{T}L(J_{L}Lig)ₘ II
where each m is as hereinbefore defined and is preferably 1 or 2, more preferably 1
(LigJ_{L})ₘL(J_{T}Tag)ₘ III
wherein each m is as hereinbefore defined and is preferably 1 and/or 2, more preferably 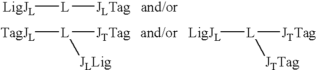
as hereinbefore defined in claim 4 and wherein any optically active fluorescent ligand is present as a racemate or as one of its optically active isomers.

20. A compound according to claim 18, wherein Lig comprises a GPCR ligand, an inhibitor of an intracellular enzyme or a substrate or inhibitor of a drug transporter or Fl is a fluorophore entity, with the proviso that when Lig is CGP12177 and L is 1,1,4,4-tetramethyl butylamine C(CH₃)₂(CH₂)₂—C(CH₃)NH—, Fl is not BODIPY® FL, or when L is C(CH₃)₂(CH₂)₂C(CH₃)₂NHCSNH— then Fl is not FITC, eosin or erythrosin
characterised in that the or each Fl is selected from a red, near ir or blue absorbing dye or from BODIPY® 630/650 or BODIPY® 630/650 X.

21. A compound of the formula I or I′ as hereinbefore defined in claim 10 selected from formulae Lig.aₘ L.a-Fl.aₙ to Lig.eₘ L.eFl.eₙ as hereinbefore defined
with the proviso that:
a) when Lig is XAC ie in Lig.a when each of R.a¹ and R.a² is propyl, R.a³ is H and R.a⁴ is —Ph—OCH₂CONH(CH₂)₂NH—, and L is a single bond or L is gly and n=3 or L is NCS, Fl is not fluorescein; or
when Lig is XAC and L is a single bond or NCS, Fl is not fluorescein or NBD;
b) when Lig is adenosine Fl is not Fmoc (CA 134:204756); or
when Lig is ADAC, ie R.b¹ is CH₂OH, R.b² and R.b³ are H and L is —(Ph—CH₂CONH)₂(CH₂)₂— or L is a single bond, Fl is not fluorescein, NBD or Rhodamine; or
when Lig is NECA (incorporating the moiety —(CH₂)m) ie R.b² and R.b³ are H and L is a single bond, or is —(CH₂)m when m is 2,4,6,8 or 10 then Fl is not NBD, or when m is 3,4,6,8,10 or 12 then Fl is not dansyl; or
when Lig is N⁶-[2-(4-aminophenyl)ethyl]adenosine and L is (CH₂)₂PhNH, Fl is not FITC (CA 131:56155 (8))
d) when Lig is CGP12177 and L (R.d²) is mono amine menthane, Fl is not BODIPY® TMR; or
when Lig is CGP12177 and L is 1,1,4,4-tetramethyl butylamine, i.e C(CH₃)₂(CH₂)₂C(CH₃)₂NH-Fl is not BODIPY® FL, or when L is C(CH₃)₂(CH₂)₂C(CH₃)₂NHCSNH— then Fl is not FITC, eosin or erythosin; or when L is monoamine menthane, Fl is not FITC (CA 131:56155 (4)); or
when Lig is CGP12177 and L is a single bond, Fl is not NBD; or
when Lig is alprenolol i.e o-prop-2-enyl phenyl and L is —C(CH₃)₂— or a single bond, Fl is not NBD;
and a)-e) when L is a single bond, Fl is not BODIPY FL;
optionally additionally
a) when Lig is XAC ie in Lig.a when each of R.a¹ and R.a² is propyl, R.a³ is H and R.a⁴ is —Ph—OCH₂CONH(CH₂)₂NH—, and L is a single bond Fl is not BODIPY™ 630/650 X; or
b) when Lig is ABEA, ie m is 4 and L is a single bond Fl is not BODIPY™ 630/650 X.

22. A compound of the formula
Lig J_{L} L J_{T} Fl as defined in claim 1
wherein any optically active fluorescent ligand is present as a racemate or as one of its optically active isomers
wherein Fl is a fluorophore as hereinbefore defined and is selected from dyes in particular including fluorescein, fluorescein derivatives including FITC, and fluorescein-like molecules including Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dyomics (DY dyes and ATTO dyes) and fluorescent derivatives thereof, the Alexafluor dyes and derivatives, BDI dyes including the commercially available Bodipy™ dyes, erythosin, eosin, pyrenes, anthracenes, acridines, fluorescent phycobiliproteins and their conjugates and fluoresceinated microbeads, Rhodamine and fluorescent derivatives thereof including Rhodamine Green™ including the tetramethylrhodamines. X-rhodamines and Texas Red derivatives, and Rhodol Green™, coupled to amine groups using the isocyanate, succinimidyl ester or dichlorotriazinyl-reactive groups, and
wherein Lig J_{L} L J_{T} is selected from:
xanthine like structures
adenosine like structures;
ethanolamine like structures; and
oxypropanolamine like structures; wherein
linking functionality J_{T} is amine; and
wherein linker L is selected from branched and straight chain C₁₋₅₀ alkyl, C₆₋₅₀ cycloalkyl or aryl and combinations thereof optionally comprising one or more heteroatoms O and optionally substituted by C₁₋₁₂ aliphatic, or for xanthine like structures L is also selected from a single bond,
with the proviso that when Lig is XAC ie in Lig.a when each of R.a¹ and R.a² is propyl, R.a³ is H and R.a⁴ is —Ph—OCH₂CONH(CH₂)NH—, and L is a single bond Fl is not BODIPY™ 630/650 X; or
b) when Lig is ABEA, ie m is 4 and L is a single bond Fl is not BODIPY™ 630/650 X.

23. A kit comprising a Compound of formula I or I′ as hereinbefore defined in claim 1 associated with information relating to its pharmacological properties in the form of Spectral Properties given as Excitation Max and Emission Max, Fluorescence Lifetime and Emission quantum yield and Pharmacology defined in terms of cells expressing a GPCR receptor as hereinbefore defined or expressing an intracellular cyclic nucleotide phosphodiesterase, or a drug transporter as hereinbefore defined and given as the Inhibition or Antagonism of receptor binding or of receptor functionality together with a value for the Inhibition (pK_{B}) or Antagonism (pK_{I}) binding constants, and optionally together with fluorescent images of the pharmacological binding in single living cells illustrating the defined inhibition or antagonism, preferably the pharmacological properties are given as EC₅₀ values for agonist stimulated—or pKᵢ values for antagonism of agonist stimulated second messenger generation, or substrate Kₘ values or antagonist Kᵢ values for stimulation or inhibition of intracellular enzymes or drug transporters.

24. Compound of formula IV or IV′ or library thereof as hereinbefore defined in claim 13 useful for linking to any suitable tag of formula V or V′ as hereinbefore defined in claim 13,
wherein the linker moiety J_{Lm} L J_{Tm} is of formula
JAq_{L}R_{L}J″
wherein each of J and J″ is amine or —O— A is CH₂CH₂O, q_{L} is 1-30 or 31 to 300 and R_{L} is CH₂CH₂
or of formula
JAq_{L}R_{L}(A′J′)J″
wherein each of J, J′ and J″ independently is amine, —O or a single bond, q_{L} is 1, 2 or 3-30 or 31 to 300 and A is CH₂CH₂O or HNCH₂CO or q_{L} is 1 and A is C(O) or (CH₂)₁₋₈ or q_{L} is 0, R_{L} is CH or CH₂CH, q_{L′} is 0 or q_{L}′ is 1 and A′ is CH₂ and q_{L″} is 0 preferably
O(CH₂CH₂O)q_{L}CH₂CH₂NH, O(CH₂CH₂O)q_{L}CH₂CH(CH₂NH)NH,
OCH(CH₂NH)NH, —CH(CH₂NH)NH, —C(O)NH—, —(CH₂)₁₋₈- or (—HNCH₂CO—)₁₋₃(=-gly₁₋₃-)-.

25. Fluorophore linker of formula V′ or library thereof as hereinbefore defined in claim 13 wherein the linker moiety J_{Lm} L J_{Tm} is of formula
JAq_{L}R_{L}J″
wherein each of J and J″ is amine or —O—, A is CH₂CH₂O, q_{L} is 1-30 or 31 to 300 and R_{L} is CH₂CH₂
or of formula
JAq_{L}R_{L}(A′J′) J″
wherein each of J, J′ and J″ independently is amine —O or a single bond, q_{L} is 1, 2 or 3-30 or 31 to 300 and A is CH₂CH₂O or HNCH₂CO or q_{L} is 1 and A is C(O) or (CH₂)₁₋₈ or q_{L} is 0, R_{L} is CH or CH₂CH, q_{L′} is 0 or q_{L}′ is 1 and A′ is CH₂ and q_{L″} is 0 preferably
O(CH₂CH₂O)q_{L}CH₂CH₂NH, O(CH₂CH₂O)q_{L}CH₂CH(CH₂NH)NH,
OCH(CH₂NH)NH, —CH(CH₂NH)NH, —C(O)NH—, —(CH₂)₁₋₈- or (—HNCH₂CO—)₁₋₃ (=-gly₁₋₃-)-.

26. Kit comprising ligand precursors, linker precursors and tag precursors of formulae IV, IV′, V, V′ and/or VI as hereinbefore defined in claim 13 for preparing a library of compounds of formula I L (J_{L} Lig)ₘ)ₚ and salts thereof wherein any optically active fluorescent ligand is present as a racemate or as one of its optically active isomers
comprising one or a plurality of same or different ligand moieties Lig each linked to one or a plurality of same or different tag moieties Tag via same or different linker moieties L and same or different linking site or linking functionality J_{T} and J_{L}
wherein Lig comprises a GPCR ligand, an inhibitor of an intracellular enzyme or a substrate or inhibitor of a drug transporter:
L is selected from a double bond, —O—, —S—, amine, COO—, amide, —NN-hydrazine; and saturated or unsaturated, substituted or unsubstituted C₁₋₆₀₀ branched or straight chain aliphatic, aromatic, alicyclic and combinations thereof, any of which may comprise one or more heteroatoms selected from N, O, S, P, wherein optional substituents are selected from any C₁₋₂₀ aliphatic, aromatic or alicyclic substituents any of which may comprise one or more heteroatoms as hereinbefore defined, hydroxy, thiol, halo, amine, hydrazine, oxo, cyano and carbonyl and combinations thereof, and L may be monomeric, oligomeric having oligomeric repeat of 2 to 30 or polymeric having polymeric repeat in excess of 30 up to 300:
Tag is any tagging substrate;
m are each independently selected from a whole number integer from 1 to 3;
p is 0 to 3
wherein one or more of each -Tag in one or more or each library compound is a fluorophore entity -Fl, whereby the library comprises compounds of which one or more or all of which are of formula I′
(LigJ_{L})ₘL(J_{T}Fl)ₘ(J_{T}L(J_{L}Lig)ₘ)ₚ
characterised in that linking is at same or different linking sites in compounds comprising different Lig J_{L}, L J_{T} and/or -Tag and is at different linking sites in compounds comprising same Lig, J_{L}, J_{T} and/or -Tag
with the proviso that when Lig is CGP12177 and L is 1,1,4,4-tetramethyl butylamine C(CH₃)₂(CH₂)₂C(CH₃)₂NH—, Fl is not BODIPY® FL, or when L is C(CH₃)₂(CH₂)₂—C(CH₃)₂NHCSNH— then Fl is not FITC, eosin or erythrosin.

27. A library of fluorescent ligands of formula I or I′ or a kit comprising a compound thereof as hereinbefore defined in claim 1 for visualising receptors or receptor binding, assessing pharmacological properties of the fluorescent ligand, in high throughput screening of novel chemical entities that bind to the target receptor, in inhibiting an intracellular enzyme or inhibiting a drug transporter or a substrate of a drug transporter, in studying drug transport or drugs suitable for transport or in distinguishing healthy or diseased tissue.

28. A library of fluorescent ligands of formula I or I′ or a kit comprising a compound thereof thereof as hereinbefore defined in claim for use in a method for receptor binding or inhibition, intracellular enzyme inhibition or drug transport or inhibition and visualisation comprising contacting a library or a compound thereof as defined in claim 1 with a sample comprising live cell material comprising GPCRs, intracellular enzymes or drug transporters in manner to facilitate binding or inhibition thereof or transport thereby, and detecting changes in fluorescence or location thereof.

29. A library of fluorescent ligands of formula I or I′ or a kit comprising a compound thereof for use as claimed in claim 28 wherein the library or compound thereof is a fluorescent ligand(s) which has affinity such that it binds permanently, semi-permanently or transiently and remains bound when unbound ligand is washed away.

30. A library of fluorescent ligands of formula I or I′ or a kit comprising a compound thereof for use as claimed in claim 28 wherein detecting a change in fluorescence is by means of confocal microscopy or fluorescence correlation spectroscopy.

31. A library of fluorescent ligands of formula I or I′ or a kit comprising a compound thereof for use as claimed in any of claim 28 wherein the library or compound thereof comprises fluorescent ligand agonist(s) which maintain binding affinity and functional activity.

32. A kit comprising a library or a compound of formula I or I′ as claimed in claim 1 and a target therefor provided as cell derived material selected from a cell line, expressing a GPCR, intracellular enzyme or drug transporter, membrane containing these proteins derived from such a cell line, solubilised receptor, enzyme or drug transporter or GPCR array from that cell line.

33. Kit as claimed in claim 32 wherein the cell derived material is provided in one of three forms: (1) from cells expressing a green fluorescent protein tagged receptor, intracellular enzyme or drug transporter; (2) from cells expressing an epitope tag for a commercially available fluorescent antibody or (3) a wild-type protein for which a specific fluorescent antibody is also provided.

34. A library as hereinbefore defined in claim 33 comprising a plurality of defined and characterised ligands having verified properties corresponding to those of the non-tagged ligand.

35. A library as hereinbefore defined in claim 34 comprising tagged ligands designed from reaction of reactive precursor ligands and reactive fluorophores having reactive site chemical functionality suited for reaction with associated reagents, for site specific reaction and linking, wherein the library design is the result of extensive pharmacological investigation of all or many of the possible linking sites and the resulting pharmacological characteristics and selection of one or more linking combinations which provide favorable binding, inhibition or transport characteristics.

36. A library or compound as hereinbefore defined in claim 35 wherein the or each Fl is selected from any red, near ir or blue absorbing dye or from BODIPY® 630/650 or BODIPY® 630/650 X.

37. Library as claimed in claim 12 comprising a plurality of compounds of the formula
LigJ_{L}LJ_{T}Fl
wherein any optically active fluorescent ligand is present as a racemate or as one of its optically active isomers
wherein Fl is selected from dyes in particular including fluorescein, fluorescein derivatives including FITC, and fluorescein-like molecules including Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dyomics (DY dyes and ATTO dyes) and fluorescent derivatives thereof, the Alexafluor dyes and derivatives, BDI dyes including the commercially available Bodipy™ dyes, erythosin, eosin, pyrenes, anthracenes, acridines, fluorescent phycobiliproteins and their conjugates and fluoresceinated microbeads, Rhodamine and fluorescent derivatives thereof including Rhodamine Green™ including the tetramethylrhodamines, X-rhodamines and Texas Red derivatives, and Rhodol Green™, coupled to amine groups using the isocyanate, succinimidyl ester or dichlorotriazinyl-reactive groups,
and
wherein Lig J_{L} L J_{T} is selected from the formulae Lig.a, Lig.b, Lig.c and Lig.d wherein:
Lig.a comprises linking functionality J_{L} which is amine, and is of the formula, in either of the following forms given: 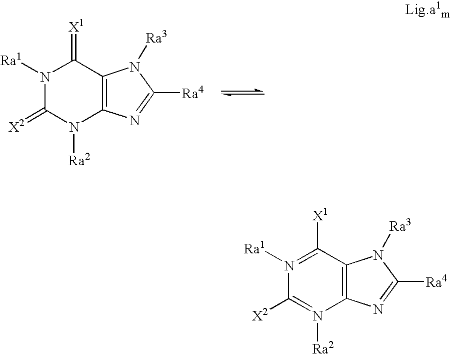
wherein
Ra⁴ comprises linking functionality J_{L} and J_{T} which is amine;
X¹ and X² are each O;
R.a is H;
each of R.a¹ and R.a² is n-propyl;
R.a⁴ is p-substituted phenyl wherein the substituent is heteroalkyl amide amine; and includes L which is a single bond or is C₁₋₅₀ alkyl optionally substituted by C₁ alkyl and including the formula ——(CH₂)ₙ where n is 3 to 8, optionally including one or more heteroatoms —O;
Lig.b comprises linking functionality J_{L} which is amine, and is 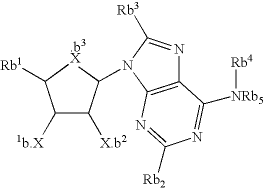
wherein
ring substituents X.b¹ and X.b² are each OH;
ring heteroatom X.b³ is —O—;
Rb¹ is CONHEt or CH₂OH;
and each of R.b² and R.b³ is H;
Rb⁴ is H;
Rb⁵ comprises linking functionality J_{T} which is amino, and linker L.b selected from saturated C₁₋₁₂ aliphatic and C₆₋₂₄ aromatic, optionally substituted by one or more C₁ alkyl and optionally including one or more heteroatoms O or cyclic groups;
Lig.c comprises linking functionality J_{L} which is amine and is 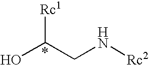
as a racemate or as one of its optically active isomers wherein * indicates an optically active centre,
Rc¹ is m-, p-dihydroxyphenyl; and
Rc² comprises linking functionality J_{T} which is amine, and linker L.c which is selected from C₁₋₁₂ straight chain alkyl, C₆₋₁₂ cycloalkyl or aryl and combinations thereof optionally comprising one or more heteroatoms O and optionally substituted by C₁ aliphatic;
or Lig.d comprises a linking functionality J_{L} which is amine and is 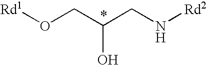
as a racemate or as one of its optically active isomers wherein * indicates an optically active centre,
Rd¹ is selected from the structures 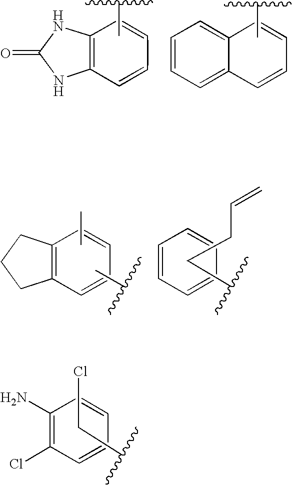
and a substituted C₁₋₂₀ spiro aromatic ring system comprising a single aromatic ring and a heteroaryl and optionally halo substituted; and
Rd² comprises linking functionality J_{T} which is amine, and linker L.d which is selected from C₁₋₁₂ straight chain alkyl, C₆₋₁₂ cycloalkyl or aryl and combinations thereof optionally comprising one or more heteroatoms O and optionally substituted by C₁ aliphatic; or Rd² is C₁₋₆ straight chain alkyl including ether O and substituted by C₆₋₁₀ aryl which is OH and oxo substituted and comprises linker L.d as hereinbefore defined.

38. Library as claimed in claim 37 wherein
R.a⁴, R.b⁵ or R.c² or R.d² comprises linking functionality J_{T} which is amino, and linker L.a, L.b, L.c or L.d selected from (CH₂)m wherein m is 3, 4, 6 or 8 or is in the range 3 to 8 or 2 to 12 optionally including one or more substituents C₁, or J_{L} L J_{T} is mono or polyethylene glycol diamine, or L.a is a single bond; or
R.c² or R.d² comprises linking functionality J_{T} which is amino, and linker L.c or L.d selected from C(CH₃)₂CH₂Ph and mono amino menthane or the structure 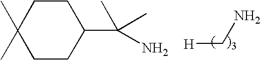
or Rd² comprises the following OH substituted aryl structure wherein linking functionality J_{L} is shown as amine, Ld is as hereinabove defined and includes J_{T} which is amine:

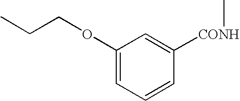

39. Library as claimed in claim 37 wherein Fl is selected from any red, near ir or blue dye.

40. Library as claimed in claim 37 wherein Fl is selected from BODIPY 630/650 X and BODIPY 630/650.

41. Library as claimed in claim 40 comprising a compound selected from the following structures wherein any optically active fluorescent ligand is present as a racemate or as one of its optically active isomers:

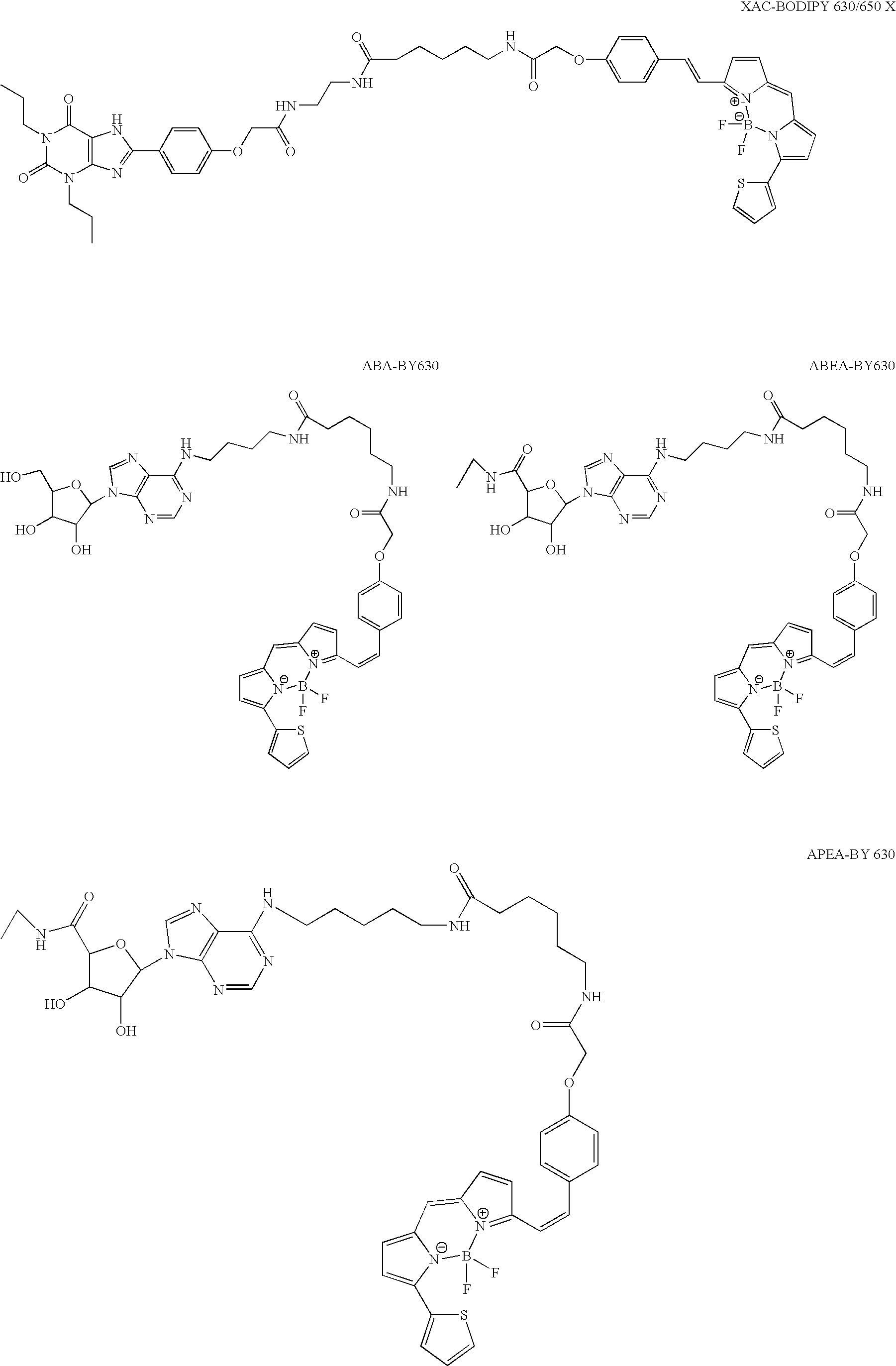

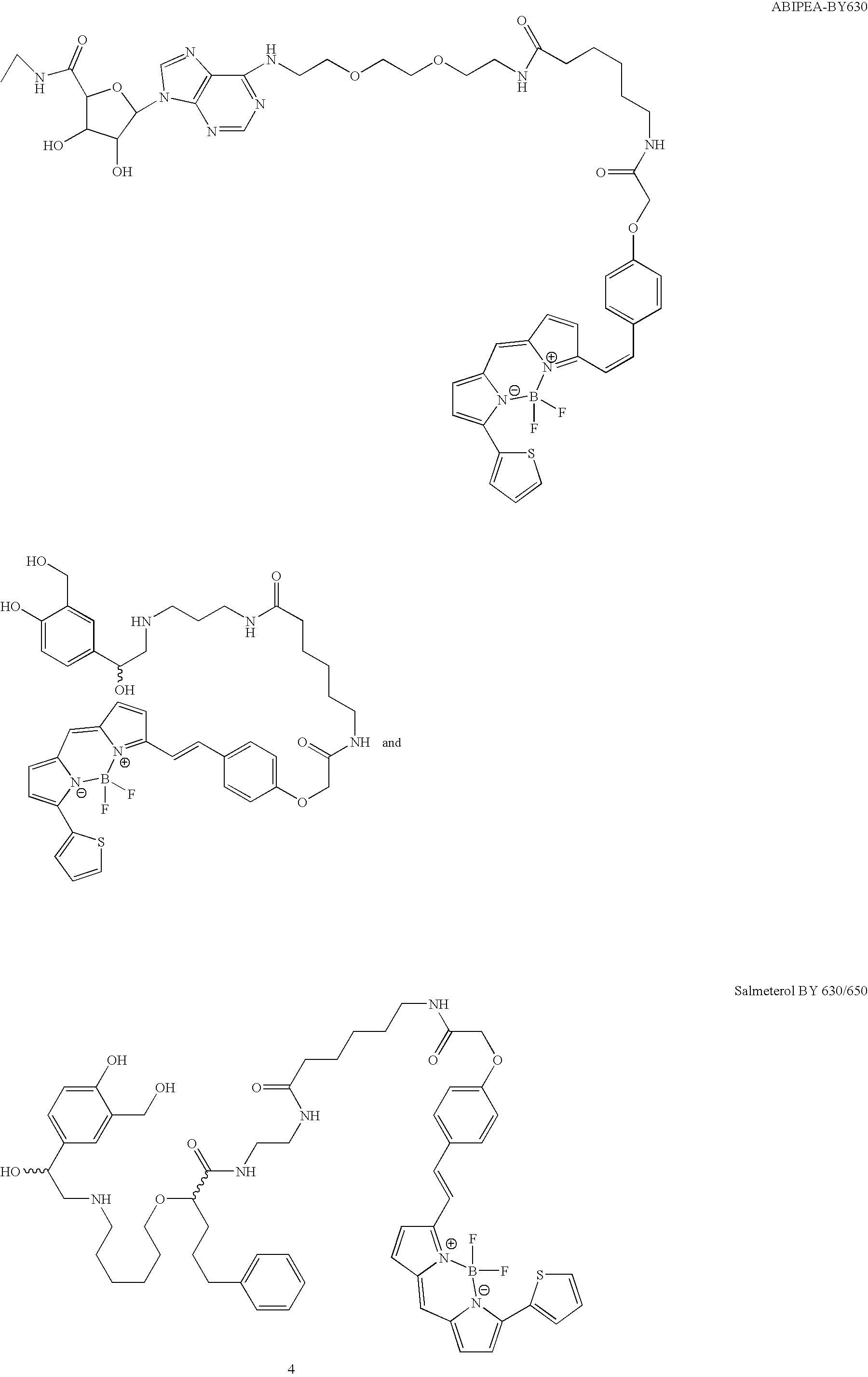

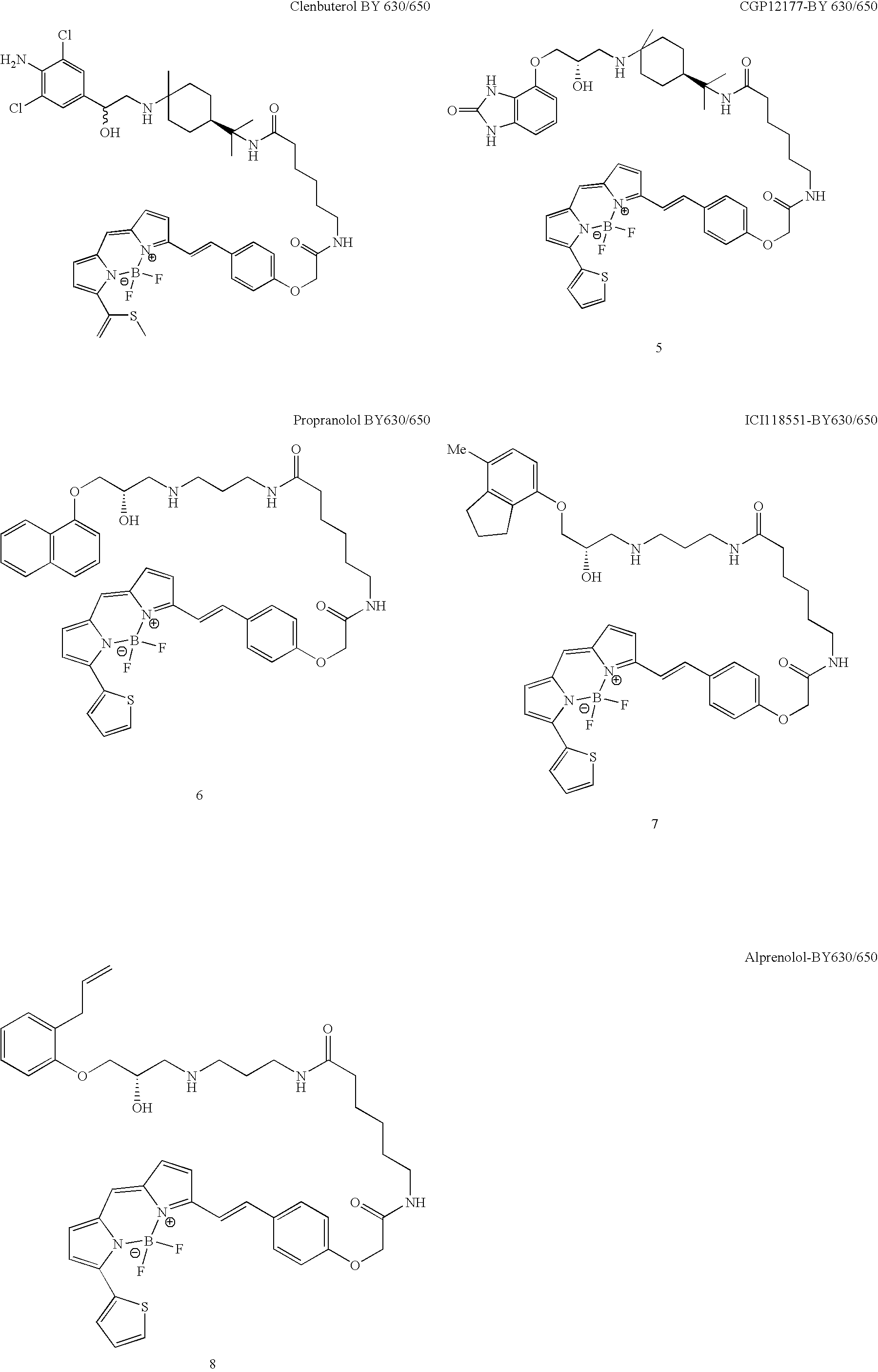

42. Compound as claimed in claim 21 of the formula
LigJ_{L}LJ_{T}Fl
wherein any optically active fluorescent ligand is present as a racemate or as one of its optically active isomers
wherein Fl is selected from dyes in particular including fluorescein, fluorescein derivatives including FITC, and fluorescein-like molecules including Oregon Green™ and its derivatives, Texas red™, 7-nitrobenz-2-oxa-1,3-diazole (NBD) and derivatives thereof, coumarin and derivatives, naphthalene including derivatives of dansyl chloride or its analogues or derivatives, Cascade Blue™, EvoBlue and fluorescent derivatives thereof, pyrenes and pyridyloxazole derivatives, the cyanine dyes, the dyomics (DY dyes and ATTO dyes) and fluorescent derivatives thereof, the Alexafluor dyes and derivatives, BDI dyes including the commercially available Bodipy™ dyes, erythosin, eosin, pyrenes, anthracenes, acridines, fluorescent phycobiliproteins and their conjugates and fluoresceinated microbeads, Rhodamine and fluorescent derivatives thereof including Rhodamine Green™ including the tetramethylrhodamines, X-rhodamines and Texas Red derivatives, and Rhodol Green™, coupled to amine groups using the isocyanate, succinimidyl ester or dichlorotriazinyl-reactive groups;
and
wherein Lig J_{L} L J_{T} is selected from the formulae Lig.a, Lig.b, Lig.c and Lig.d wherein:
Lig.a comprises linking functionality J_{L} which is amine, and is of the formula, in either of the following forms given: 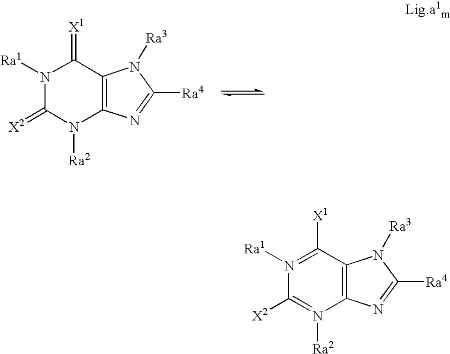
wherein
Ra⁴ comprises linking functionality J_{L} and J_{T} which is amine;
X¹ and x² are each O;
R.a³ is H;
each of R.a¹ and R.a² is n-propyl;
R.a⁴ is p-substituted phenyl wherein the substituent is heteroalkyl amide amine; and includes L which is a single bond or is C₁₋₅₀ alkyl optionally substituted by C₁ alkyl and including the formula (CH₂)ₙ where n is 3 to 8, optionally including one or more heteroatoms —O;
Lig.b comprises linking functionality J_{L} which is amine, and is 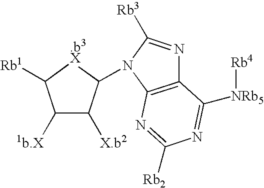
wherein
ring substituents X.b¹ and X.b² are each OH;
ring heteroatom X.b³ is —O—;
Rb¹ is CONHEt or CH₂OH;
and each of R.b² and R.b³ is H;
Rb⁴ is H;
Rb⁵ comprises linking functionality J_{T} which is amino, and linker L.b selected from saturated C₁₋₁₂ aliphatic and C₆₋₂₄ aromatic, optionally substituted by one or more C₁ alkyl and optionally including one or more heteroatoms O or cyclic groups;
Lig.c comprises linking functionality J_{L} which is amine and is 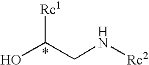
as a racemate or as one of its optically active isomers wherein * indicates an optically active centre,
Rc¹ is m-, p-dihydroxyphenyl; and
Rc² comprises linking functionality J_{T} which is amine, and linker L.c which is selected from C₁₋₁₂ straight chain alkyl, C₆₋₁₂ cycloalkyl or aryl and combinations thereof optionally comprising one or more heteroatoms O and optionally substituted by C₁ aliphatic;
or Lig.d comprises a linking functionality J_{L} which is amine and is 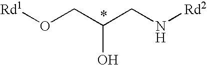
as a racemate or as one of its optically active isomers wherein * indicates an optically active centre,
Rd¹ is selected from the structures 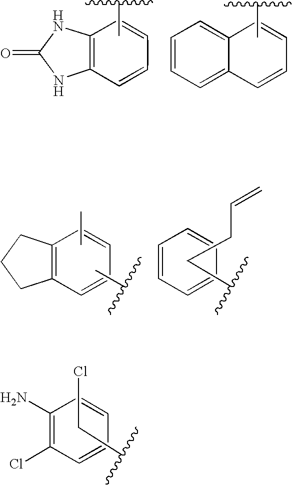
and a substituted C₁₋₂₀ spiro aromatic ring system comprising a single aromatic ring and a heteroaryl and optionally halo substituted; and
Rd² comprises linking functionality J_{T} which is amine, and linker L.d which is selected from C₁₋₁₂ straight chain alkyl, C₆₋₁₂ cycloalkyl or aryl and combinations thereof optionally comprising one or more heteroatoms O and optionally substituted by C₁ aliphatic; or Rd² is C₁₋₆ straight chain alkyl including ether O and substituted by C₆₋₁₀ aryl which is OH and oxo substituted and comprises linker L.d as hereinbefore defined,
with the proviso that the compound J_{Lm} LT_{Tm} is is of formula
JAq_{L}R_{L}J″
wherein each of J and J″ is amine or —O—, A is CH₂CH₂O, q_{L} is 1-30 or 31 to 300 and R_{L} is CH₂CH₂
or of formula
JAq_{L}R_{L}(A′J′)J″
wherein each of J, J′ and J″ independently is amine, O or a single bond, q_{L} is 1, 2 or 3-30 or 31 to 300 and A is CH₂CH₂O or HNCH₂CO or q_{L} is 1 and A is C(O) or (CH₂)₁₋₈ or q_{L} is 0, R_{L} is CH or CH₂CH, q_{L∝0} is 0 or q_{L}′ is 1 and A′ is CH₂ and q_{L″} is 0 preferably
O(CH₂CH₂O)q_{L}CH₂CH₂NH, O(CH₂CH₂O)q_{L}CH₂CH(CH₂NH)NH,
OCH(CH₂NH)NH, —CH(CH₂NH)NH, —C(O)NH—, —(CH₂)₁₋₈- or (—HNCH₂CO—)₁₋₃ (=-gly₁₋₃-)- and wherein any optically active fluorescent ligand is present as a racemate or as one of its optically active isomers.

43. Compound as claimed in claim 42 wherein R.a⁴, R.b⁵ or R.c² or R.d² comprises linking functionality J_{T} which is amino, and linker L.a, L.b, L.c or L.d selected from (CH₂)m wherein m is 3, 4, 6 or 8 or is in the range 3 to 8 or 2 to 12 optionally including one or more substituents C₁, or J_{L} L J_{T} is mono or polyethylene glycol diamine, or L.a is a single bond; or
R.c² or R.d² comprises linking functionality J_{T} which is amino, and linker L.c or L.d selected from C(CH₃)₂CH₂Ph and mono amino menthane or the structure 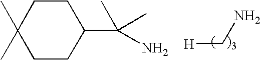
or Rd² comprises the following OH substituted aryl structure wherein linking functionality J_{L} is shown as amine, Ld is as hereinabove defined and includes J_{T} which is amine: 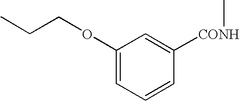
with the proviso that when Liz is XAC ie in Lig.a when each of R.a¹ and R.a² is propyl, R.a³ is H and R.a⁴ is —Ph—OCH₂CONH(CH₂)₂NH—, and L is a single bond Fl is not BODIPY™ 630/650 X; or
b) when Lig is ABEA, ie m is 4 and L is a single bond Fl is not BODIPY™ 630/650 X.

44. Compound as claimed in claim 42 wherein Fl is selected from any red, near ir or blue dye.

45. Compound as claimed in claim 42 wherein Fl is selected from BODIPY 630/650 X and BODIPY 630/650.

46. Compound selected from the structures wherein any optically active fluorescent ligand is present as a racemate or as one of its optically active isomers: 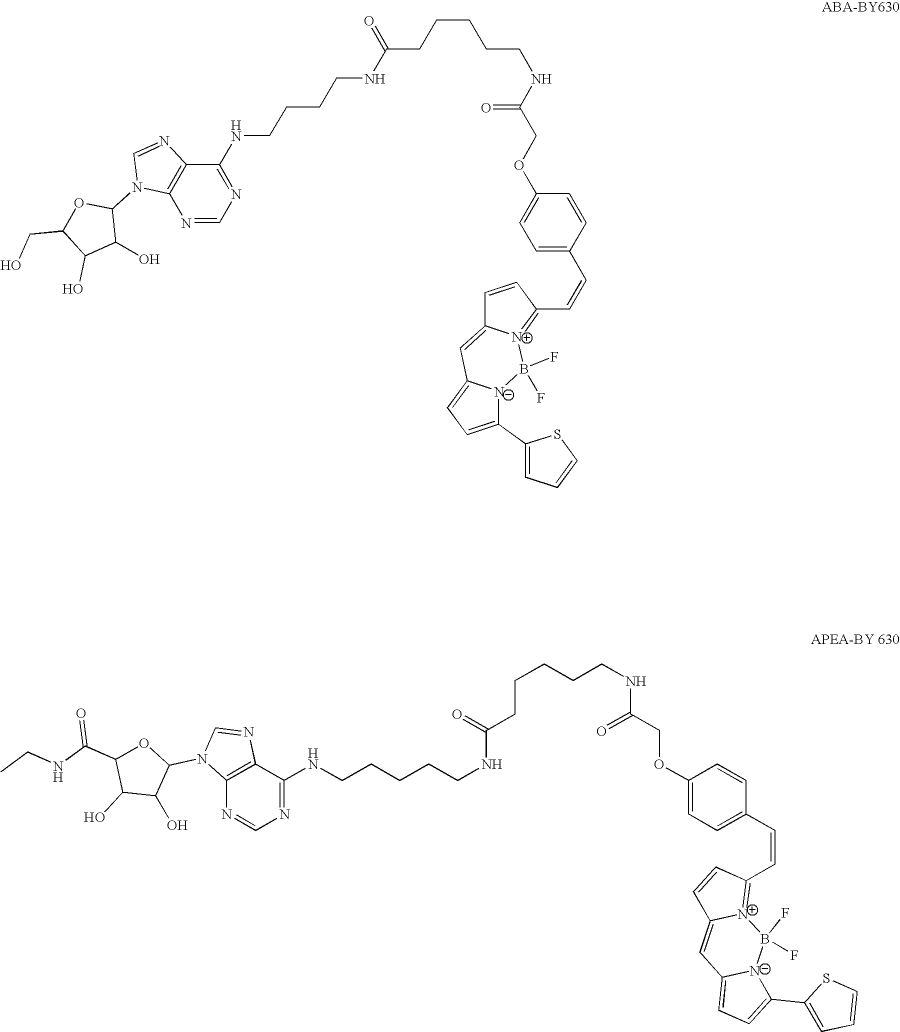 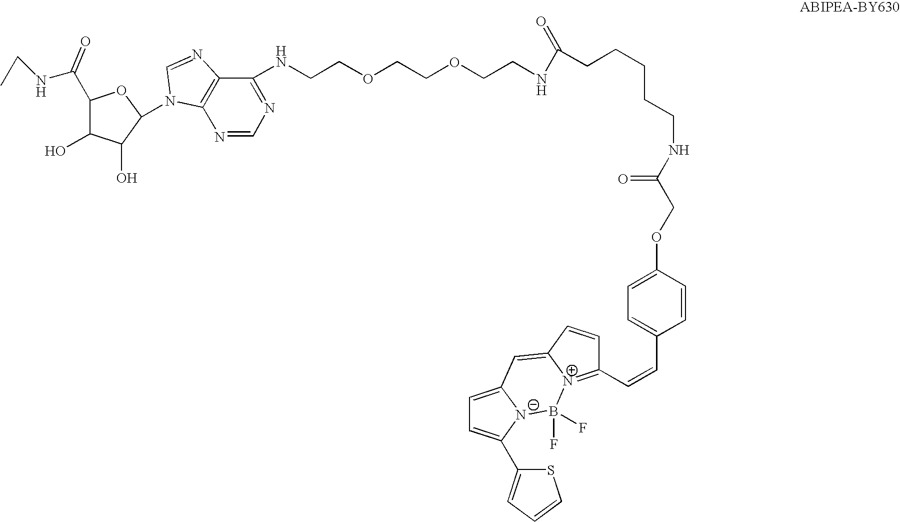 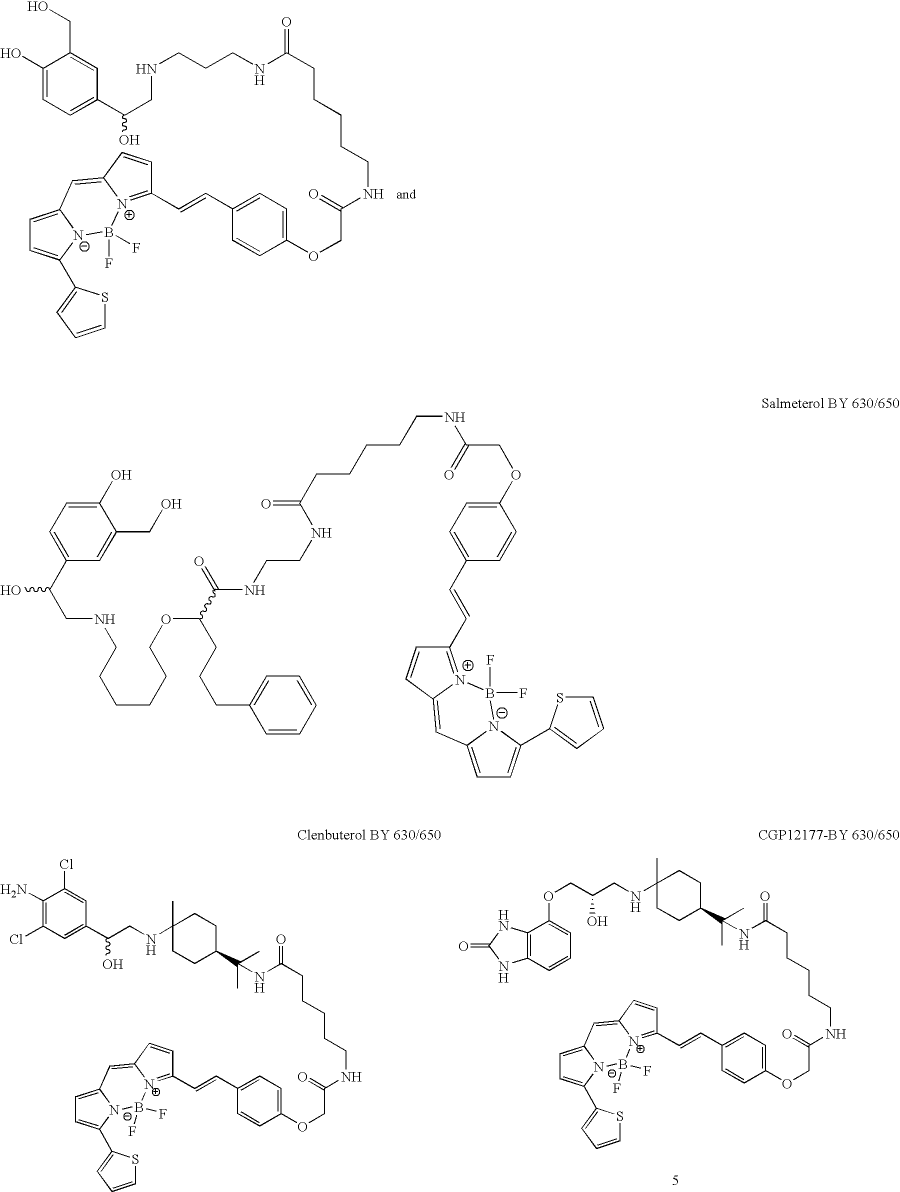 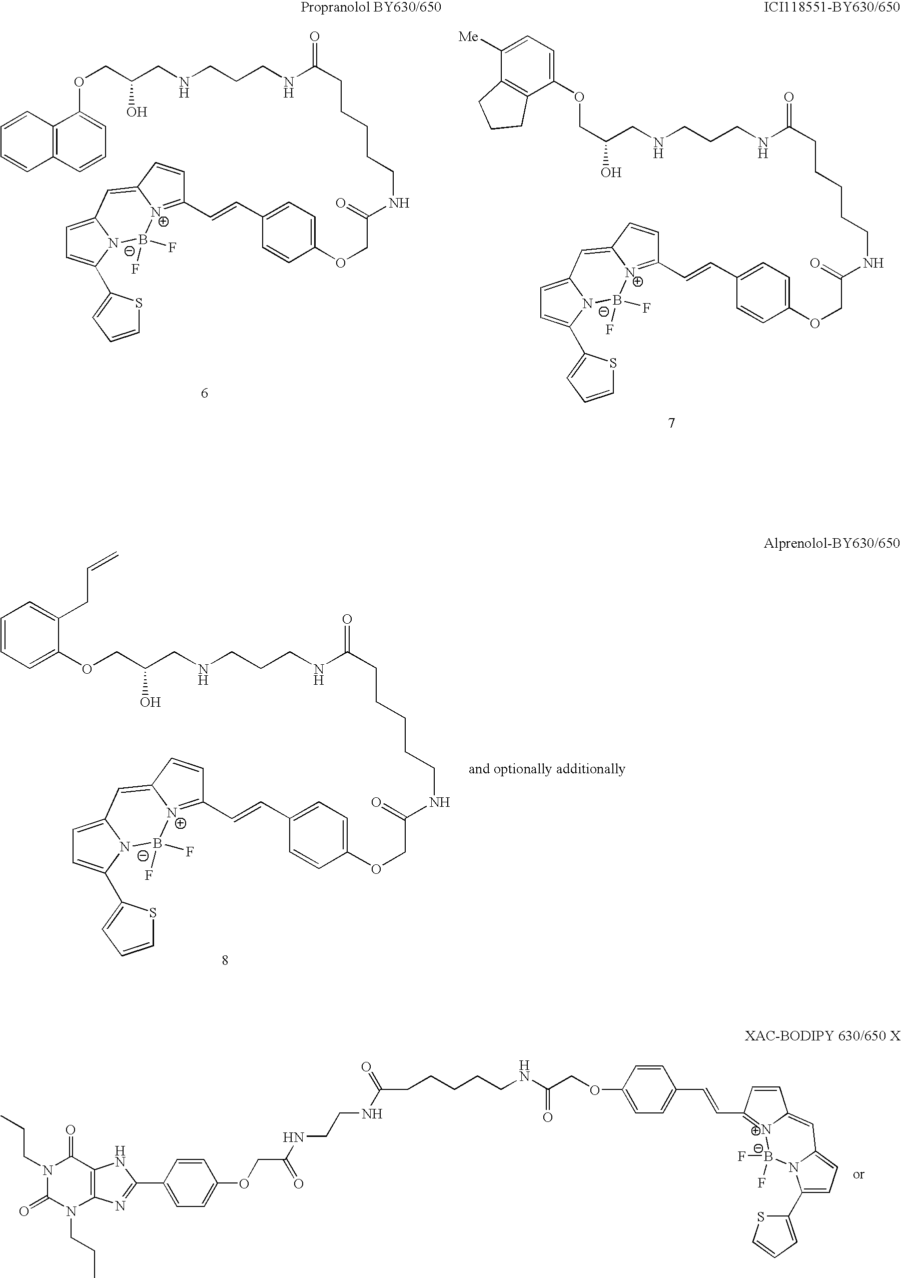 [chemical structure]
